(19) United States
(12) Patent Application Publication
(10) Pub. No.: US 2024/0422775 A1
(43) Pub. Date: Dec. 19, 2024

(54) METHOD AND DEVICE FOR POWER CONTROL IN WIRELESS COMMUNICATION SYSTEM

(71) Applicant: Samsung Electronics Co., Ltd., Suwon-si, Gyeonggi-do (KR)

(72) Inventors: Youngrok JANG, Suwon-si (KR); Junyung YI, Suwon-si (KR); Seongmok LIM, Suwon-si (KR); Hyunseok RYU, Suwon-si (KR); Hyoungju JI, Suwon-si (KR); Kyungjun CHOI, Suwon-si (KR)

(21) Appl. No.: 18/703,167

(22) PCT Filed: Nov. 10, 2022
(86) PCT No.: PCT/KR2022/017596

§ 371 Date: Apr. 19, 2024

(30) Foreign Application Priority Data
Nov. 12, 2021 (KR) 10-2021-0155940

(51) Int. Cl. H04W 72/1268; H04L 1/08; H04W 52/14

(52) U.S. Cl. CPC H04W 72/1268; H04L 1/08; H04W 52/146

(57) ABSTRACT

The present disclosure relates to a 5G or 6G communication system for supporting higher data transmission rates. The present disclosure relates to a method performed by a terminal in a wireless communication system, wherein the method may comprise the steps of: receiving scheduling information, for the repeated transmission of a physical uplink shared channel (PUSCH), from a base station through a first signal; setting a time period, in which a signal for transmit power control (TPC) can be received and applied, for each of one or more PUSCHs scheduled through the first signal; and performing power control for the PUSCH transmissions corresponding to the set time periods on the basis of second signals received from a base station within the set time periods.

### TECHNICAL FIELD

The disclosure relates to a method and apparatus for power control in a wireless communication system.

### BACKGROUND ART

5G mobile communication technology defines a wide frequency band to enable fast transmission speed and new services, and can be implemented not only in a sub-6 GHz frequency band (“sub 6 GHz”) such as 3.5 GHz but also in an ultra-high frequency band (“above 6 GHz”) called mmWave such as 28 GHz or 39 GHz. In addition, 6G mobile communication technology called “beyond 5G system” is being considered for implementation in a terahertz (THz) band (e.g., band of 95 GHz to 3 THz) to achieve transmission speed that is 50 times faster and ultra-low latency that is reduced to 1/10 compared with 5G mobile communication technology.

In the early days of 5G mobile communication technology, to meet service support and performance requirements for enhanced mobile broadband (eMBB), ultra-reliable and low-latency communication (URLLC), and massive machine-type communications (nmMTC), standardization has been carried out regarding beamforming for mitigating the pathloss of radio waves and increasing the propagation distance thereof in the mmWave band, massive MIMO, support of various numerology for efficient use of ultra-high frequency resources (e.g., operating multiple subcarrier spacings), dynamic operations on slot formats, initial access schemes to support multi-beam transmission and broadband, definition and operation of bandwidth parts (BWP), new channel coding schemes such as low density parity check (LDPC) codes for large-capacity data transmission and polar codes for reliable transmission of control information, L2 pre-processing, and network slicing for providing a dedicated network specialized for a specific service.

Currently, discussions are underway to improve 5G mobile communication technology and enhance performance thereof in consideration of the services that the 5G mobile communication technology has initially intended to support, and physical layer standardization is in progress for technologies such as V2X (Vehicle-to-Everything) that aims to help a self-driving vehicle to make driving decisions based on its own location and status information transmitted by vehicles and to increase user convenience, new radio unlicensed (NR-U) for the purpose of system operation that meets various regulatory requirements in unlicensed bands, low power consumption scheme for NR terminals (UE power saving), non-terrestrial network (NTN) as direct terminal-satellite communication to secure coverage in an area where communication with a terrestrial network is not possible, and positioning.

In addition, standardization in radio interface architecture/protocol is in progress for technologies such as intelligent factories (industrial Internet of things, IIoT) for new service support through linkage and convergence with other industries, integrated access and backhaul (IAB) that provides nodes for network service area extension by integrating and supporting wireless backhaul links and access links, mobility enhancement including conditional handover and dual active protocol stack (DAPS) handover, 2-step random access (2-step RACH for NR) that simplifies the random access procedure; and standardization in system architecture/service is also in progress for the 5G baseline architecture (e.g., service based architecture, service based interface) for integrating network functions virtualization (NFV) and software defined networking (SDN) technologies, and mobile edge computing (MEC) where the terminal receives a service based on its location.

When such a 5G mobile communication system is commercialized, connected devices whose number is explosively increasing will be connected to the communication networks; accordingly, it is expected that enhancement in function and performance of the 5G mobile communication system and the integrated operation of the connected devices will be required. To this end, new research will be conducted regarding 5G performance improvement and complexity reduction, AI service support, metaverse service support, and drone communication by utilizing extended reality (XR) for efficiently supporting augmented reality (AR), virtual reality (VR), and mixed reality (MR), artificial intelligence (AI), and machine learning (ML).

Further, such advancement of 5G mobile communication systems will be the basis for the development of technologies such as new waveforms for ensuring coverage in the terahertz band of 6G mobile communication technology, full dimensional MIMO (FD-MIMO), multi-antenna transmission such as array antenna or large scale antenna, metamaterial-based lenses and antennas for improved coverage of terahertz band signals, high-dimensional spatial multiplexing using orbital angular momentum (OAM), reconfigurable intelligent surface (RIS) technique, full duplex technique to improve frequency efficiency and system network of 6G mobile communication technology, satellites, AI-based communication that utilizes artificial intelligence (AI) from the design stage and internalizes end-to-end AI support functions to realize system optimization, and next-generation distributed computing that realizes services whose complexity exceeds the limit of terminal computing capabilities by utilizing ultra-high-performance communication and computing resources.

### DISCLOSURE OF INVENTION

### Technical Problem

Based on discussions described above, the disclosure provides a method and apparatus for power control in a wireless communication system.

### Solution to Problem

A method performed by a terminal in a wireless communication system according to the disclosure may include: receiving scheduling information for repetitive transmission of a physical uplink shared channel (PUSCH) through a first signal from a base station; setting a time period in which a signal for controlling transmit power control (TPC) can be received and applied for each of at least one PUSCH scheduled by the first signal; and performing power control for PUSCH transmission corresponding to the set time period based on a second signal received within the set time period from the base station.

### Advantageous Effects of Invention

According to the apparatus and method in accordance with embodiments of the disclosure, transmit power control (TPC) of a terminal can be effectively performed in a wireless communication system.

### BRIEF DESCRIPTION OF DRAWINGS

FIG. 1 is a diagram illustrating the basic structure of a time-frequency domain being a radio resource region where data or control channels are transmitted in a 5G wireless communication system.

FIG. 2 is a diagram showing an example of a slot structure used in a 5G wireless communication system.

FIG. 3 is a diagram illustrating an example of configuring a bandwidth part (BWP) in a 5G wireless communication system.

FIG. 4 is a diagram illustrating an example of a control resource set through which a downlink control channel is transmitted in a 5G wireless communication system.

FIG. 5 is a diagram showing the structure of a downlink control channel in a 5G wireless communication system.

FIG. 6 is a diagram illustrating an example of a scheme for configuring uplink and downlink resources in a 5G wireless communication system.

FIG. 7 is a diagram illustrating a method for determining an available slot in a 5G system according to an embodiment of the disclosure.

FIG. 8 is a flowchart for describing operations of a UE for physical uplink shared channel (PUSCH) repetition type A transmission in a 5G system according to an embodiment of the disclosure.

FIG. 9 is a flowchart for describing operations of a base station for PUSCH repetition type A transmission in a 5G system according to an embodiment of the disclosure.

FIG. 10 shows an example of PUSCH repetition type B according to an embodiment of the present disclosure.

FIG. 11 is a diagram illustrating a calculation for the PUSCH power control adjustment state according to an embodiment of the disclosure.

FIG. 12 is another diagram illustrating a calculation for the PUSCH power control adjustment state according to an embodiment of the disclosure.

FIG. 13 is another diagram illustrating a calculation for the PUSCH power control adjustment state according to an embodiment of the disclosure.

FIG. 14 is a block diagram showing the internal structure of a UE according to an embodiment of the disclosure.

FIG. 15 is a block diagram showing the internal structure of a base station according to an embodiment of the disclosure.

### MODE FOR THE INVENTION

Hereinafter, embodiments of the disclosure will be described in detail with reference to the accompanying drawings.

In the description of embodiments of the disclosure, descriptions of technical details well known in the art and not directly related to the disclosure may be omitted. This is to more clearly convey the gist of the disclosure without obscurities by omitting unnecessary descriptions.

Likewise, in the drawings, some elements are exaggerated, omitted, or only outlined in brief. Also, the size of each element does not necessarily reflect the actual size. The same reference symbols are used throughout the drawings to refer to the same or corresponding parts.

Advantages and features of the disclosure and methods for achieving them will be apparent from the following detailed description of embodiments taken in conjunction with the accompanying drawings. However, the disclosure is not limited to the embodiments disclosed below but may be implemented in various different ways, the embodiments are provided only to complete the disclosure and to fully inform the scope of the disclosure to those skilled in the art to which the disclosure pertains, and the disclosure is defined only by the scope of the claims. The same reference symbols are used throughout the specification to refer to the same parts. Additionally, in describing the disclosure, if it is determined that a detailed description of a related function or configuration may unnecessarily obscure the gist of the disclosure, the detailed description will be omitted. Further, the terms described below are defined in consideration of their functions in the disclosure, and these may vary depending on the intention of the user, the operator, or the custom. Hence, their meanings should be determined based on the overall contents of this specification.

In the following description, the term “base station” refers to a main agent allocating resources to terminals and may be at least one of gNode B, eNode B, Node B, radio access unit, base station controller, or network node. The term “terminal” may refer to at least one of user equipment (IE), mobile station (MS), cellular phone, smartphone, computer, or multimedia system with a communication function. In the description, the term “downlink (DL)” refers to a wireless transmission path through which the base station sends a signal to the terminal, and the term “uplink (UL)” refers to a wireless transmission path through which the terminal sends a signal to the base station. In addition, although an LTE, LTE-A or 5G system may be described below as an example, embodiments of the disclosure can also be applied to other communication systems with similar technical backgrounds or channel configurations. For example, this may include the 5th generation mobile communication technology (5G, new radio, NR) developed after LTE-A, and the term 5G hereinafter may be a concept that includes existing LTE, LTE-A, and other similar services. Further, it should be understood by those skilled in the art that the disclosure is applicable to other communication systems without significant modifications departing from the scope of the disclosure.

Meanwhile, it is known to those skilled in the art that blocks of a flowchart (or sequence diagram) and a combination of flowcharts may be represented and executed by computer program instructions. These computer program instructions may be loaded on a processor of a general purpose computer, special purpose computer or programmable data processing equipment. When the loaded program instructions are executed by the processor, they create a means for carrying out functions described in the flowchart. As the computer program instructions may be stored in a computer readable memory that is usable in a specialized computer or a programmable data processing equipment, it is also possible to create articles of manufacture that carry out functions described in the flowchart. As the computer program instructions may be loaded on a computer or a programmable data processing equipment, when executed as processes, they may carry out steps of functions described in the flowchart.

A block of a flowchart may correspond to a module, a segment or a code containing one or more executable instructions implementing one or more logical functions, or to a part thereof. In some cases, functions described by blocks may be executed in an order different from the listed order. For example, two blocks listed in sequence may be executed at the same time or executed in reverse order.

In the description, the word “unit”, “module” or the like may refer to a software component or hardware component such as an FPGA or ASIC capable of carrying out a function or an operation. However, “unit” or the like is not limited to hardware or software. A unit or the like may be configured so as to reside in an addressable storage medium or to drive one or more processors. Units or the like may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose large components and units. Components and units may be configured to drive a device or one or more processors in a secure multimedia card. Also, in an embodiment, a unit or the like may include one or more processors.

Wireless communication systems are evolving from early systems that provided voice-oriented services only to broadband wireless communication systems that provide high-speed and high-quality packet data services, such as systems based on communication standards including 3GPP high speed packet access (HSPA), long term evolution (LTE) or evolved universal terrestrial radio access (E-UTRA), LTE-advanced (LTE-A), LTE-Pro, 3GPP2 high rate packet data (HRPD), ultra mobile broadband (UMB), and IEEE 802.16e.

As a representative example of the broadband wireless communication system, the LTE system employs orthogonal frequency division multiplexing (OFDM) in the downlink (DL) and single carrier frequency division multiple access (SC-FDMA) in the uplink (UL). The uplink refers to a radio link through which a terminal (user equipment (UE) or mobile station (MS)) sends a data or control signal to a base station (BS or eNode B), and the downlink refers to a radio link through which a base station sends a data or control signal to a terminal. In such a multiple access scheme, time-frequency resources used to carry user data or control information are allocated so as not to overlap each other (i.e., maintain orthogonality) to thereby identify the data or control information of a specific user.

As a post-LTE communication system, namely, the 5G communication system must be able to freely reflect various requirements of users and service providers and need to support services satisfying various requirements. Services considered for the 5G communication system include enhanced mobile broadband (eMBB), massive machine type communication (mMTC), and ultra-reliable and low-latency communication (URLLC).

eMBB aims to provide a data transmission rate that is more improved in comparison to the data transmission rate supported by existing LTE, LTE-A, or LTE-Pro. For example, in the 5G communication system, eMBB must be able to provide a peak data rate of 20 Gbps in the downlink and a peak data rate of 10 Gbps in the uplink from the viewpoint of one base station. In addition, the 5G communication system has to provide not only the peak transmission rate but also an increased user perceived data rate for the terminal. To meet such requirements in the 5G communication system, it may be required to improve the transmission and reception technology including more advanced multi-antenna or multi-input multi-output (MIMO) technology. In addition, it is possible to satisfy the data transmission rate required by the 5G communication system by using a frequency bandwidth wider than 20 MHz in a frequency band of 3 to 6 GHz or 6 GHz or higher instead of a transmission bandwidth of up to 20 MHz in a band of 2 GHz currently used by LTE.

At the same time, in the 5G communication system, mMTC is considered to support application services such as the Internet of Things (IoT). For efficient support of IoT services, mMTC is required to support access of a massive number of terminals in a cell, extend the coverage for the terminal, lengthen the battery time, and reduce the cost of the terminal. The Internet of Things must be able to support a massive number of terminals (e.g., 1,000,000 terminals/km2) in a cell to provide a communication service to sensors and components attached to various devices. In addition, since a terminal supporting mMTC is highly likely to be located in a shadow area not covered by a cell, such as the basement of a building, due to the nature of the service, it may require wider coverage compared to other services provided by the 5G communication system. A terminal supporting mMTC should be configured as a low-cost terminal, and since it is difficult to frequently replace the battery of a terminal, a very long battery life time such as 10 to 15 years may be required.

Finally, URLLC is a cellular-based wireless communication service for mission-critical purposes. For example, URLLC may be considered for services such as remote control of robots or machinery, industrial automation, unmanned aerial vehicles, remote health care, and emergency alert. Hence, URLLC should provide ultra-reliable and low-latency communication. For example, a URLLC service has to support both an air interface latency of less than 0.5 ms and a packet error rate of 10-5 or less as a requirement. Hence, for a service supporting URLLC, the 5G system must provide a transmission time interval (TTI) shorter than that of other services, and at the same time, a design requirement for allocating a wide resource in a frequency band may be required.

The above three services considered in the 5G communication system (i.e., eMBB, URLLC, and mMTC) can be multiplexed and transmitted in one system. Here, to satisfy different requirements of the services, different transmission and reception techniques and parameters can be used. However, 5G is not limited to the three services mentioned above.

Next, the frame structure of a 5G system will be described in more detail with reference to the drawing.

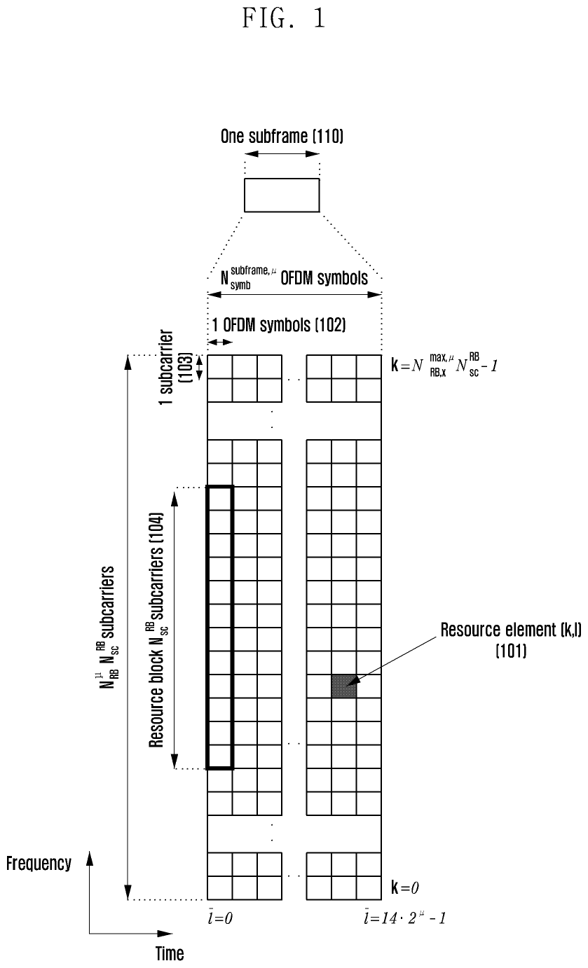

FIG. 1 is a diagram illustrating the basic structure of a time-frequency domain being a radio resource region where data or control channels are transmitted in a 5G wireless communication system.

In FIG. 1, the horizontal axis represents the time domain and the vertical axis represents the frequency domain. The basic unit of resources in the time-frequency domain is a resource element (RE) 101, which may be defined as 1 OFDM (orthogonal frequency division multiplexing) symbol 102 in the time domain and 1 subcarrier 103 in the frequency domain. In the frequency domain, N (e.g., 12) consecutive REs may constitute one resource block (RB) 104.

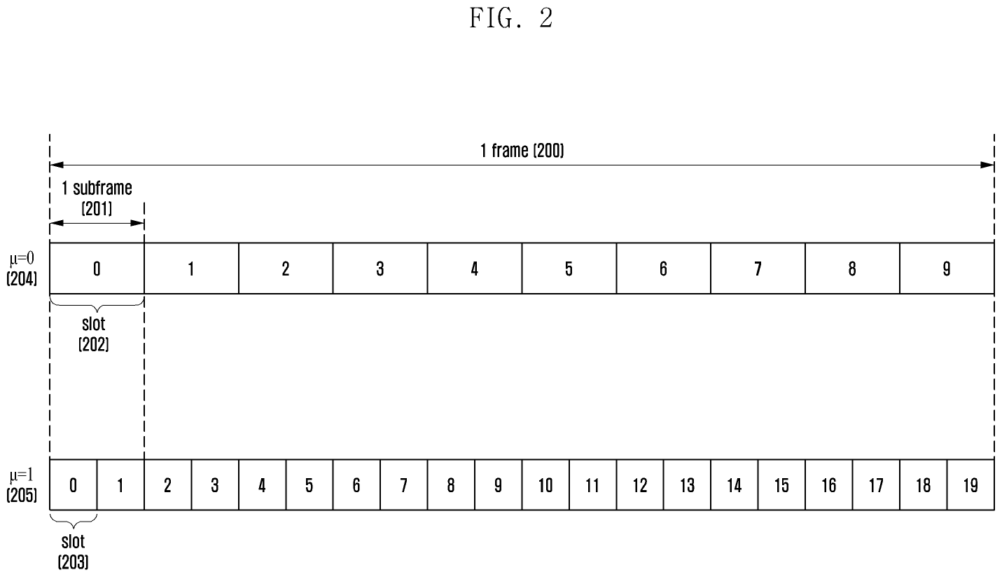

FIG. 2 is a diagram showing an example of a slot structure used in a 5G wireless communication system.

In FIG. 2, an example structure of a frame 200, a subframe 201, and a slot 202 is shown. One frame 200 may be defined to be 10 ms. One subframe 201 may be defined to be 1 ms, and thus one frame 200 may be composed of a total of 10 subframes 201. One slot 202 or 203 may be defined to be 14 OFDM symbols (i.e., the number of symbols per slot (N_{symb}^{slot})=14). One subframe 201 may be composed of one or multiple slots 202 or 203, and the number of slots 202 or 203 per subframe 201 may vary according to a setting value μ(204 or 205) for the subcarrier spacing. In an example of FIG. 2, a case where μ=0 (204) and a case where μ=1 (205) are shown as a subcarrier spacing setting value. When μ=0 (204), 1 subframe 201 may be composed of 1 slot 202, and when μ=1 (205), 1 subframe 201 may be composed of 2 slots 203. That is, according to the setting value for the subcarrier spacing, the number of slots per subframe (Nₛₗₒₜ^{subframe,μ}) may vary, and the number of slots per frame (Nₛₗₒₜ^{frameμ}) may vary accordingly. According to each setting value μ for the subcarrier spacing, Nₛₗₒₜ^{subframeμ} and Nₛₗₒₜ^{frameμ} may be defined as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

Next, bandwidth part (BWP) settings in the 5G communication system will be described in detail with reference to the diagram

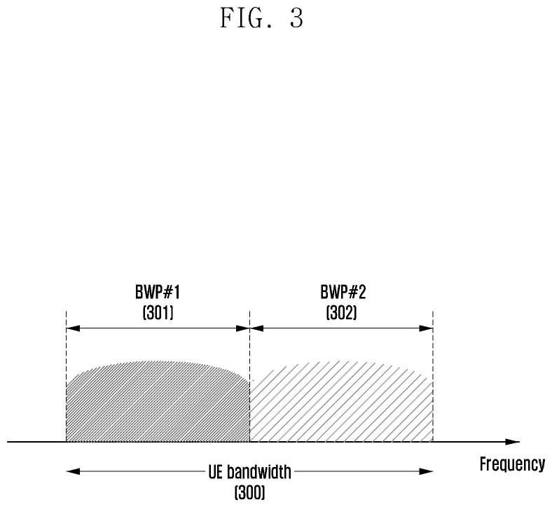

FIG. 3 is a diagram illustrating an example of configuring a bandwidth part (BWP) in a 5G wireless communication system.

In FIG. 3, an example is shown in which the UE bandwidth 300 is configured as two bandwidth parts, that is, bandwidth part #1 (BWP #1) 301 and bandwidth part #2 (BWP #2) 302. The base station may configure one or more bandwidth parts to the UE, and the following information may be set for each bandwidth part.

TABLE 2

| | |
|---|---|
| BWP ::= | SEQUENCE { |
| bwp-Id | BWP-Id, |
| locationAndBandwidth | INTEGER (1..65536), |
| subcarrierSpacing | ENUMERATED {n0, n1, n2, n3, n4, n5}, |
| cyclicPrefix | ENUMERATED { extended } |
| } | |

Settings for the bandwidth part are not limited to the above example, and various parameters related to the bandwidth part can be configured to the UE in addition to the above configuration information. Configuration information may be transmitted from the base station to the UE through higher layer signaling, for example, radio resource control (RRC) signaling. Among one or more configured bandwidth parts, at least one bandwidth part may be activated. Whether a configured bandwidth part is activated may be transmitted from the base station to the UE semi-statically through RRC signaling or dynamically through downlink control information (DCI).

According to an embodiment, before being radio resource control (RRC) connected, a UE may be configured by the base station with an initial bandwidth part (initial BWP) for initial connection through a master information block (MIB). To be more specific, in the initial connection stage, the UE may receive, through the MIB, configuration information about a control resource set (CORESET) and search space through which a physical downlink control channel (PDCCH) for receiving system information required for initial connection (remaining system information (RMSI) or system information block 1 (SIB1) can be transmitted. The control resource set and search space configured through the MIB can each be regarded as having an identity (ID) of 0. The base station may notify the UE of configuration information such as frequency assignment information, time assignment information, and numerology for control resource set #0 through the MIB. Additionally, the base station may notify the UE of configuration information about the monitoring periodicity and occasion for control resource set #0, that is, configuration information about search space #0, through the MIB. The UE may regard the frequency domain set as control resource set #0 obtained from the MIB as the initial bandwidth part for initial connection. At this time, the identity (ID) of the initial bandwidth part may be regarded as 0.

Configuration for the bandwidth part supported by the 5G wireless communication system may be used for various purposes.

According to an embodiment, the configuration for the bandwidth part may be used when the bandwidth supported by the UE is smaller than the system bandwidth. For example, the base station may configure the frequency location of a bandwidth part (configuration information 2) to the UE, allowing the UE to transmit and receive data at a specific frequency location within the system bandwidth.

Additionally, according to an embodiment, the base station may configure a plurality of bandwidth parts to the UE for the purpose of supporting different numerologies. For example, to support data transmission and reception using both a subcarrier spacing of 15 kHz and a subcarrier spacing of 30 kHz for a UE, the base station may configure two bandwidth parts with subcarrier spacings of 15 kHz and 30 kHz, respectively. Different bandwidth parts may be frequency division multiplexed, and when the base station intends to transmit and receive data at a specific subcarrier spacing, the bandwidth part configured with the corresponding subcarrier spacing may be activated.

Additionally, according to an embodiment, for the purpose of reducing power consumption of a UE, the base station may configure bandwidth parts with different bandwidth sizes to the UE. For example, if a UE supports a very large bandwidth, for example, a bandwidth of 100 MHz, and always transmits and receives data through that bandwidth, very large power consumption may occur. In particular, monitoring unnecessarily a downlink control channel with a large bandwidth of 100 MHz in a situation where there is no traffic can be very inefficient in terms of power consumption. For the purpose of reducing the power consumption of the UE, the base station may configure a relatively small bandwidth part, for example, a bandwidth part of 20 MHz, to the UE. The UE may perform monitoring operations on the 20 MHz bandwidth part in a situation where there is no traffic, and may, when data is generated, transmit and receive data in the 100 MHz bandwidth part according to the instruction of the base station.

In a method of configuring the bandwidth part, a terminal before being RRC connected may receive configuration information for an initial bandwidth part through a master information block (MIB) in the initial connection stage. To be more specific, through the MIB of the physical broadcast channel (PBCH), the UE may be configured with a control resource set (CORESET) for the downlink control channel through which downlink control information (DCI) scheduling the system information block (SIB) can be transmitted. The bandwidth of the control resource set configured through the MIB may be considered as the initial bandwidth part, and through the configured initial bandwidth part, the UE may receive the physical downlink shared channel (PDSCH) on which the SIB is transmitted. In addition to receiving the SIB, the initial bandwidth part may also be used for other system information (OSI), paging, and random access.

When one or more bandwidth parts are configured to the UE, the base station may instruct the UE to switch the bandwidth part by using a bandwidth part indicator field in the DCI. As an example, in FIG. 3, if the currently activated bandwidth part of the UE is bandwidth part #1 (301), the base station may indicate bandwidth part #2 (302) to the UE by using a bandwidth part indicator in the DCI, and the UE can switch the bandwidth part to bandwidth part #2 (302) indicated by the bandwidth part indicator in the received DCI.

As described above, since DCI-based bandwidth part switching can be indicated by the DCI scheduling the PDSCH or PUSCH, when a UE receives a bandwidth part switch request, it must be able to receive or transmit the PDSCH or PUSCH scheduled by the corresponding DCI without difficulty in the switched bandwidth part. To this end, the standard stipulates requirements for the delay time (TBWP) required when switching the bandwidth part, and may be defined as follows, for example.

TABLE 3

| | |
|---|---|
| NR Slot length | BWP switch delay T_{BWP} (slots) |

| μ | (ms) | Type 1^{Note 1} | Type 2^{Note 1} |
|---|---|---|---|
| 0 | 1 | [1] | [3] |
| 1 | 0.5 | [2] | [5] |
| 2 | 0.25 | [3] | [9] |
| 3 | 0.125 | [6] | [17] |

^{Note 1}:
Depends on UE capability.
Note 2:
If the BWP switch involves changing of SCS, the BWP switch delay is determined by the larger one between the SCS before BWP switch and the SCS after BWP switch.

Requirements for the bandwidth part switch delay time may support type 1 or type 2 depending on the UE's capability. The UE may report the supported bandwidth part delay time type to the base station.

According to the requirements for the bandwidth part switch delay time described above, when the UE receives a DCI including a bandwidth part switch indicator in slot n, the UE may complete switching to the new bandwidth part indicated by the bandwidth part switch indicator no later than slot n+TBWP, and may perform transmission and reception on the data channel scheduled by the corresponding DCI in the newly switched bandwidth part. When the base station intends to schedule a data channel with a new bandwidth part, it may determine time domain resource assignment for the data channel by taking into consideration the bandwidth part switch delay time (TBWP) of the UE. That is, when scheduling a data channel with a new bandwidth part, the base station can schedule the data channel after the bandwidth part switch delay time in determining time domain resource assignment for the data channel. Accordingly, the UE may not expect that the DCI indicating bandwidth part switching indicates a slot offset (K0 or K2) value that is smaller than the bandwidth part switch delay time (TBWP).

If the UE receives a DCI (e.g., DCI format 1_1 or 01) indicating bandwidth part switching, the UE may not perform any transmission or reception during a time interval ranging from the third symbol of the slot in which the PDCCH containing the corresponding DCI is received to the start point of the slot indicated by a slot offset (K0 or K2) value indicated by the time domain resource assignment indicator field in the corresponding DCI. For example, if the UE receives a DCI indicating bandwidth part switching in slot n, and the slot offset value indicated by the DCI is K, the UE may not perform any transmission or reception during a time interval ranging from the third symbol of slot n to the symbol before slot n+K (i.e., last symbol of slot n+K−1).

Next, a description will be given of the synchronization signal (SS)/PBCH block in a 5G wireless communication system.

The SS/PBCH block may indicate a physical layer channel block including a primary SS (PSS), a secondary SS (SSS), and a physical broadcast channel (PBCH). The details are as follows.
PSS: PSS is a signal that serves as a reference for downlink time/frequency synchronization and provides some information of cell ID.
SSS: SSS serves as a reference for downlink time/frequency synchronization and provides remaining cell ID information not provided by PSS. Additionally, it may serve as a reference signal (RS) for demodulation of the PBCH.
PBCH: PBCH provides essential system information required for transmission and reception of a data channel and control channel of the UE. The essential system information may include search space-related control information indicating radio resource mapping information of a control channel, scheduling control information of a separate data channel for transmitting system information, and the like.
SS/PBCH block: the SS/PBCH block is composed of a combination of PSS, SSS, and PBCH. One or multiple SS/PBCH blocks may be transmitted within 5 ms, and individual SS/PBCH blocks being transmitted may be distinguished by an index.

The UE may detect the PSS and SSS in the initial connection stage, and may decode the PBCH. The UE may obtain the MIB from the PBCH, and may be configured with control resource set (CORESET) #0 (which may correspond to a control resource set having a control resource set index of 0) therefrom. The UE may assume that a selected SS/PBCH block and a demodulation reference signal (DMRS) transmitted in control resource set #0 are in a quasi-colocated (QCL) relationship, and may perform monitoring of control resource set #0. The UE may obtain system information through downlink control information transmitted in control resource set #0. The UE may obtain random access channel (RACH)-related configuration information required for initial connection from the received system information. The UE may transmit a physical RACH (PRACH) to the base station in consideration of the selected SS/PBCH block index, and the base station having received the PRACH may obtain information about the SS/PBCH block index selected by the UE. The base station may know that the UE has selected a specific block among individual SS/PBCH blocks and monitors control resource set #0 related thereto.

Next, a detailed description is given of downlink control information (DCI) in a 5G wireless communication system.

In the 5G system, scheduling information regarding uplink data (or, physical uplink shared channel (PUSCH)) or downlink data (or, physical downlink shared channel (PDSCH)) may be delivered from the base station to the UE through DCI. The UE may monitor a fallback DCI format and a non-fallback DCI format for the PUSCH or PDSCH. A fallback DCI format may include fixed fields predefined between the base station and the UE, and a non-fallback DCI format may include fields that may be configurable.

DCI may be transmitted over a physical downlink control channel (PDCCH), which is a physical downlink control channel, through a channel coding and modulation process. A cyclic redundancy check (CRC) is attached to the payload of a DCI message, and the CRC may be scrambled with a radio network temporary identifier (RNTI) corresponding to the identity of the UE. Different RNTIs may be used according to the purpose of the DCI message, for example, UE-specific data transmission, power control command, or random access response. That is, the RNTI is not explicitly transmitted, but is transmitted by being included in the CRC calculation process. Upon receiving a DCI message transmitted over the PDCCH, the UE may perform a CRC check by using the assigned RNTI, and if the CRC check result is correct, the UE may know that the corresponding message has been transmitted to it.

For example, DCI for scheduling a PDSCH for system information (SI) may be scrambled with an SI-RNTI. DCI for scheduling a PDSCH for a random access response (RAR) message may be scrambled with an RA-RNTI. DCI for scheduling a PDSCH for a paging message may be scrambled with a P-RNTI. DCI for notifying a slot format indicator (SFI) may be scrambled with an SFI-RNTI. DCI for notifying transmit power control (TPC) may be scrambled with a TPC-RNTI. DCI for scheduling UE-specific PDSCH or PUSCH may be scrambled with C-RNTI (cell RNTI), MCS-C-RNTI (modulation coding scheme C-RNTI), or CS-RNTI (configured scheduling RNTI).

DCI format 0_0 may be used as fallback DCI for scheduling a PUSCH, where the CRC may be scrambled with a C-RNTI. DCI format 00 having a CRC scrambled with a C-RNTI may include, for example, the following information.

TABLE 4
Identifier for DCI formats - 1 bit
The value of this bit field is always set to 0, indicating an UL DCI format
Frequency domain resource assignment - ┌log₂(N_{RB}^{UL,BWP}(N_{RB}^{UL,BWP} +1)/ 2)┐ bits
where N_{RB}^{UL,BWP} is defined in subclause 7.3.1.0
For PUSCH hopping with resource allocation type 1:
- N_{UL}_{_{—}}ₕₒₚ MSB bits are used to indicate the frequency offset according to
Subclause 6.3 of [6, TS 38.214], where N_{UL}_{_{—}}ₕₒₚ = 1 if the higher layer
parameter frequencyHoppingOffsetLists contains two offset values and
N_{UL}_{_{—}}ₕₒₚ = 2 if the higher layer parameter frequencyHoppingOffsetLists
contains four offset values
- ┌log₂(N_{RB}^{UL,BWP}(N_{RB}^{UL,BWP} +1)/ 2)┐ − N_{UL}_{_{—}}ₕₒₚ bits provides the frequency domain
resource allocation according to Subclause 6.1.2.2.2 of [6, TS 38.214]
For non-PUSCH hopping with resource allocation type 1:
- ┌log₂(N_{RB}^{UL,BWP}(N_{RB}^{UL,BWP} +1)/ 2)┐ bits provides the frequency domain
resource allocation according to Subclause 6.1.2.2.2 of [6, TS 38.214]
Time domain resource assignment- 4 bits as defined in Subclause 6.1.2.1 of [6,
TS 38.214]
Frequency hopping flag - 1 bit according to Table 7.3.1.1.1-3, as defined in
Subclause 6.3 of [6, TS 38.214]
Modulation and coding scheme - 5 bits as defined in Subclause 6.1.4.1 of [6, TS
38.214]
New data indicator - 1 bit
Redundancy version - 2 bits as defined in Table 7.3.1.1.1-2
HARQ process number - 4 bits
TPC command for scheduled PUSCH - 2 bits as defined in Subclause 7.1.1 of
[5, TS 38.213]
Padding bits, if required.
UL/SUL indicator - 1 bit for UEs configured with supplementaryUplink in
ServingCellConfig in the cell as defined in Table 7.3.1.1.1-1 and the number of
bits for DCI format 1_0 before padding is larger than the number of bits for DCI
format 0 0 before padding; 0 bit otherwise. The UL/SUL indicator, if present,
locates in the last bit position of DCI format 0_0, after the padding bit(s).
If the UL/SUL indicator is present in DCI format 0_0 and the higher layer
parameter pusch-Config is not configured on both UL and SUL the UE ignores
the UL/SUL indicator field in DCI format 0_0, and the corresponding PUSCH
scheduled by the DCI format 0_0 is for the UL or SUL for which high layer
parameter pucch-Config is configured;
If the UL/SUL indicator is not present in DCI format 0_0 and pucch-Config is
configured, the corresponding PUSCH scheduled by the DCI format 0_0 is for
the UL or SUL for which high layer parameter pucch-Config is configured.
- If the UL/SUL indicator is not present in DCI format 0_0 and pucch-
Config is not configured, the corresponding PUSCH scheduled by the DCI
format 0_0 is for the uplink on which the latest PRACH is transmitted.

DCI format 0_1 may be used as non-fallback DCI for scheduling a PUSCH, where the CRC may be scrambled with a C-RNTI. DCI format 0_1 having a CRC scrambled with a C-RNTI may include, for example, the following information.

```
TABLE 5
Identifier for DCI formats - 1 bit
The value of this bit field is always set to 0, indicating an UL DCI format
Carrier indicator - 0 or 3 bits, as defined in Subclause 10.1 of [5, TS38.213].
UL/SUL indicator - 0 bit for UEs not configured with supplementaryUplink in
ServingCellConfig in the cell or UEs configured with supplementaryUplink in
ServingCellConfig in the cell but only PUCCH carrier in the cell is configured
for PUSCH transmission; otherwise, 1 bit as defined in Table 7.3.1.1.1-1.
Bandwidth part indicator - 0, 1 or 2 bits as determined by the number of UL
BWPs KBWPRRC configured by higher layers, excluding the initial UL bandwidth
part. The bitwidth for this field is determined as ┌log₂(n_{BWP})┐ bits, where
  n_{BWP} = n_{BWP,RRC} + 1 if n_{BWP,RRC} ≤ 3 , in which case the bandwidth part
indicator is equivalent to the ascending order of the higher layer parameter BWP-
Id;
otherwise n_{BWP} = n_{BWP,RRC}, in which case the bandwidth part indicator is defined
in Table 7.3.1.1.2-1;
If a UE does not support active BWP change via DCI, the UE ignores this bit
field.
Frequency domain resource assignment - number of bits determined by the
following, where N_{RB}^{UL,BWP} is the size of the active UL bandwidth part:
  N_{RBG} bits if only resource allocation type 0 is configured, where N_{RBG} is
defined in Subclause 6.1.2.2.1 of [6, TS 38.214],
  ┌log₂(N_{RB}^{UL,BWP}(N_{RB}^{UL,BWP} + 1)/2┐ bits if only resource allocation type 1 is
configured, or max(┌log₂(N_{RB}^{UL,BWP}(N_{RB}^{UL,BWP} + 1)/2┐, N_{RBG}) + 1 bits if both resource
allocation type 0 and 1 are configured.
If both resource allocation type 0 and 1 are configured, the MSB bit is used to
indicate resource allocation type 0 or resource allocation type 1, where the bit
value of 0 indicates resource allocation type 0 and the bit value of 1 indicates
resource allocation type 1.
For resource allocation type 0, the N_{RBG} LSBs provide the resource allocation as
defined in Subclause 6.1.2.2.1 of [6, TS 38.214].
For resource allocation type 1, the ┌log₂(N_{RB}^{UL,BWP}(N_{RB}^{UL,BWP} + 1)/2)┐ LSBs
provide the resource allocation as follows:
For PUSCH hopping with resource allocation type 1:
  N_{UL}_hop MSB bits are used to indicate the frequency offset according to
Subclause 6.3 of [6, TS 38.214], where N_{UL}_hop = 1 if the higher layer parameter
frequencyHoppingOffsetLists contains two offset values and N_{UL}_hop = 2 if the
higher layer parameter frequencyHoppingOffsetLists contains four offset values
  ┌log₂(N_{RB}^{UL,BWP}(N_{RB}^{UL,BWP} + 1)/2)┐ − N_{UL}_hop bits provides the frequency
domain resource allocation according to Subclause 6.1.2.2.2 of [6, TS 38.214]
For non-PUSCH hopping with resource allocation type 1:
  ┌log₂(N_{RB}^{UL,BWP}(N_{RB}^{UL,BWP} + 1)/2┐ bits provides the frequency domain
resource allocation according to Subclause 6.1.2.2.2 of [6, TS 38.214]
If “Bandwidth part indicator” field indicates a bandwidth part other than the
active bandwidth part and if both resource allocation type 0 and 1 are configured
for the indicated bandwidth part, the UE assumes resource allocation type 0 for
the indicated bandwidth part if the bitwidth of the “Frequency domain resource
assignment” field of the active bandwidth part is smaller than the bitwidth of the
“Frequency domain resource assignment” field of the indicated bandwidth part.
Time domain resource assignment - 0, 1, 2, 3, or 4 bits as defined in Subclause
6.1.2.1 of [6, TS38.214]. The bitwidth for this field is determined as ┌log₂(I)┐
bits, where I is the number of entries in the higher layer parameter pusch-
TimeDomainAllocationList if the higher layer parameter is configured; otherwise
I is the number of entries in the default table.
Frequency hopping flag - 0 or 1 bit:
0 bit if only resource allocation type 0 is configured or if the higher layer
parameter frequencyHopping is not configured;
1 bit according to Table 7.3.1.1.1-3 otherwise, only applicable to resource
allocation type 1, as defined in Subclause 6.3 of [6, TS 38.214].
Modulation and coding scheme - 5 bits as defined in Subclause 6.1.4.1 of [6, TS
38.214]
New data indicator - 1 bit
Redundancy version - 2 bits as defined in Table 7.3.1.1.1-2
HARQ process number - 4 bits
1^{st} downlink assignment index - 1 or 2 bits:
1 bit for semi-static HARQ-ACK codebook;
2 bits for dynamic HARQ-ACK codebook.
2^{nd} downlink assignment index - 0 or 2 bits:
2 bits for dynamic HARQ-ACK codebook with two HARQ-ACK sub-
codebooks;
0 bit otherwise.
TPC command for scheduled PUSCH - 2 bits as defined in Subclause 7.1.1 of
[5, TS38.213]
$SRS resource indicator ‐ ⌈ {log}_{2} ( {\sum }_{k = 1}^{min \{ {L}_{max} , {N}_{S R S} \}} ( \begin{matrix}{N}_{S R S} \\ k\end{matrix} ) ) ⌉ or ⌈ {log}_{2} ( {N}_{S R S} ) ⌉$
bits, where N_{SRS} is the number of configured SRS resources in the SRS resource
set associated with the higher layer parameter usage of value ‘codeBook’ or
‘nonCode Book’,
  $⌈ {log}_{2} ( {\sum }_{k = 1}^{min \{ {L}_{max} , {N}_{S R S} \}} ( \begin{matrix}{N}_{S R S} \\ k\end{matrix} ) ) ⌉ bits according to Tables 7.3 \text{.1} \text{.1} \text{.2} ‐$
28/29/30/31 if the higher layer parameter txConfig = nonCodebook, where
N_{SRS} is the number of configured SRS resources in the SRS resource set
associated with the higher layer parameter usage of value ‘nonCodeBook’ and
if UE supports operation with maxMIMO-Layers and the higher layer parameter
maxMIMO-Layers of PUSCH-ServingCellConfig of the serving cell is
configured, Lₘₐₓ is given by that parameter
otherwise, Lₘₐₓ is given by the maximum number of layers for PUSCH
supported by the UE for the serving cell for non-codebook based operation.
  ┌log₂(N_{SRS})┐ bits according to Tables 7.3.1.1.2-32 if the higher layer
parameter txConfig = codebook, where N_{SRS} is the number of configured SRS
resources in the SRS resource set associated with the higher layer parameter
usage of value ‘codeBook’.
Precoding information and number of layers - number of bits determined by the
following:
0 bits if the higher layer parameter txConfig = nonCodeBook,
0 bits for 1 antenna port and if the higher layer parameter txConfig = codebook,
4, 5, or 6 bits according to Table 7.3.1.1.2-2 for 4 antenna ports, if txConfig =
codebook, and according to whether transform precoder is enabled or disabled,
and the values of higher layer parameters maxRank, and codebookSubset,
2, 4, or 5 bits according to Table 7.3.1.1.2-3 for 4 antenna ports, if txConfig =
codebook, and according to whether transform precoder is enabled or disabled,
and the values of higher layer parameters maxRank, and codebookSubset,
2 or 4 bits according to Table 7.3.1.1.2-4 for 2 antenna ports, if txConfig =
codebook, and according to whether transform precoder is enabled or disabled,
and the values of higher layer parameters maxRank and codebookSubset;
1 or 3 bits according to Table 7.3.1.1.2-5 for 2 antenna ports, if txConfig =
codebook, and according to whether transform precoder is enabled or disabled,
and the values of higher layer parameters maxRank and codebookSubset.
Antenna ports - number of bits determined by the following
2 bits as defined by Tables 7.3.1.1.2-6, if transform precoder is enabled, dmrs-
Type = 1, and maxLength = 1;
4 bits as defined by Tables 7.3.1.1.2-7, if transform precoder is enabled, dmrs-
Type = 1, and maxLength = 2;
3 bits as defined by Tables 7.3.1.1.2-8/9/10/11, if transform precoder is disabled,
dmrs-Type = 1, and maxLength = 1, and the value of rank is determined according
to the SRS resource indicator field if the higher layer parameter txConfig =
nonCodebook and according to the Precoding information and number of layers
field if the higher layer parameter txConfig = codebook,
4 bits as defined by Tables 7.3.1.1.2-12/13/14/15, if transform precoder is
disabled, dmrs-Type = 1, and maxLength = 2, and the value of rank is determined
according to the SRS resource indicator field if the higher layer parameter
txConfig = nonCodebook and according to the Precoding information and
number of layers field if the higher layer parameter txConfig = codebook,
4 bits as defined by Tables 7.3.1.1.2-16/17/18/19, if transform precoder is
disabled, dmrs-Type = 2, and maxLength = 1, and the value of rank is determined
according to the SRS resource indicator field if the higher layer parameter
txConfig = nonCodebook and according to the Precoding information and
number of layers field if the higher layer parameter txConfig = codebook;
5 bits as defined by Tables 7.3.1.1.2-20/21/22/23, if transform precoder is
disabled, dmrs-Type = 2, and maxLength = 2, and the value of rank is determined
according to the SRS resource indicator field if the higher layer parameter
txConfig = nonCodebook and according to the Precoding information and
number of layers field if the higher layer parameter txConfig = codebook.
where the number of CDM groups without data of values 1, 2, and 3 in Tables
7.3.1.1.2-6 to 7.3.1.1.2-23 refers to CDM groups {0}, {0, 1}, and {0, 1, 2}
respectively.
If a UE is configured with both dmrs-UplinkForPUSCH-MappingTypeA and
dmrs-UplinkForPUSCH-MappingTypeB, the bitwidth of this field equals
max{x_{A}, x_{B}} , where x_{A} is the “Antenna ports” bitwidth derived according to dmrs-
UplinkForPUSCH-MappingTypeA and x_{B} is the “Antenna ports” bitwidth
derived according to dmrs-UplinkForPUSCH-MappingTypeB. A number of
|x_{A} − x_{B}| zeros are padded in the MSB of this field, if the mapping type of the
PUSCH corresponds to the smaller value of x_{A} and x_{B}.
SRS request - 2 bits as defined by Table 7.3.1.1.2-24 for UEs not configured
with supplementaryUplink in ServingCellConfig in the cell; 3 bits for UEs
configured with supplementaryUplink in ServingCellConfig in the cell where the
first bit is the non-SUL/SUL indicator as defined in Table 7.3.1.1.1-1 and the
second and third bits are defined by Table 7.3.1.1.2-24. This bit field may also
indicate the associated CSI-RS according to Subclause 6.1.1.2 of [6, TS 38.214].
CSI request - 0, 1, 2, 3, 4, 5, or 6 bits determined by higher layer parameter
reportTriggerSize.
CBG transmission information (CBGTI) - 0 bit if higher layer parameter
codeBlockGroupTransmission for PDSCH is not configured, otherwise, 2, 4, 6,
or 8 bits determined by higher layer parameter
maxCode BlockGroupsPerTransportBlock for PUSCH.
PTRS-DMRS association - number of bits determined as follows
0 bit if PTRS-UplinkConfig is not configured and transform precoder is disabled,
or if transform precoder is enabled, or if maxRank = 1;
2 bits otherwise, where Table 7.3.1.1.2-25 and 7.3.1.1.2-26 are used to indicate
the association between PTRS port(s) and DMRS port(s) for transmission of one
PT-RS port and two PT-RS ports respectively, and the DMRS ports are indicated
by the Antenna ports field.
If “Bandwidth part indicator” field indicates a bandwidth part other than the
active bandwidth part and the “PTRS-DMRS association” field is present for the
indicated bandwidth part but not present for the active bandwidth part, the UE
assumes the “PTRS-DMRS association” field is not present for the indicated
bandwidth part.
beta offset indicator - 0 if the higher layer parameter betaOffsets = semiStatic;
otherwise 2 bits as defined by Table 9.3-3 in [5, TS 38.213].
DMRS sequence initialization - 0 bit if transform precoder is enabled; 1 bit if
transform precoder is disabled.
  UL-SCH indicator - 1 bit. A value of “1” indicates UL-SCH shall be
transmitted on the PUSCH and a value of “0” indicates UL-SCH shall not be
transmitted on the PUSCH. Except for DCI format 0_1 with CRC scrambled by
SP-CSI-RNTI, a UE is not expected to receive a DCI format 0 1 with UL-SCH
indicator of “0” and CSI request of all zero(s).
```

DCI format 1_0 may be used as fallback DCI for scheduling a PDSCH, where the CRC may be scrambled with a C-RNTI. DCI format 10 having a CRC scrambled with a C-RNTI may include, for example, the following information.

TABLE 6
Identifier for DCI formats - 1 bits
The value of this bit field is always set to 1, indicating a DL DCI format
Frequency domain resource assignment - ┌log₂(N_{RB}^{DL,BWP}(N_{RB}^{DL,BWP} +1)/ 2)┐ bits where
N_{RB}^{DL,BWP} is given by subclause 7.3.1.0
If the CRC of the DCI format 1_0 is scrambled by C-RNTI and the “Frequency
domain resource assignment” field are of all ones, the DCI format 1_0 is for
random access procedure initiated by a PDCCH order, with all remaining fields
set as follows:
Random Access Preamble index - 6 bits according to ra-PreambleIndex in
Subclause 5.1.2 of [8, TS38.321]
UL/SUL indicator - 1 bit. If the value of the “Random Access Preamble index”
is not all zeros and if the UE is configured with supplementaryUplink in
ServingCellConfig in the cell, this field indicates which UL carrier in the cell to
transmit the PRACH according to Table 7.3.1.1.1-1; otherwise, this field is
reserved
SS/PBCH index - 6 bits. If the value of the “Random Access Preamble index” is
not all zeros, this field indicates the SS/PBCH that shall be used to determine the
RACH occasion for the PRACH transmission; otherwise, this field is reserved.
PRACH Mask index - 4 bits. If the value of the “Random Access Preamble
index” is not all zeros, this field indicates the RACH occasion associated with
the SS/PBCH indicated by “SS/PBCH index” for the PRACH transmission,
according to Subclause 5.1.1 of [8, TS38.321]; otherwise, this field is reserved
Reserved bits - 10 bits
Otherwise, all remaining fields are set as follows:
Time domain resource assignment - 4 bits as defined in Subclause 5.1.2.1 of [6,
TS 38.214]
VRB-to-PRB mapping - 1 bit according to Table 7.3.1.2.2-5
Modulation and coding scheme - 5 bits as defined in Subclause 5.1.3 of [6, TS
38.214]
New data indicator - 1 bit
Redundancy version - 2 bits as defined in Table 7.3.1.1.1-2
HARQ process number - 4 bits
Downlink assignment index - 2 bits as defined in Subclause 9.1.3 of [5, TS
38.213], as counter DAI
TPC command for scheduled PUCCH - 2 bits as defined in Subclause 7.2.1 of
[5, TS 38.213]
PUCCH resource indicator - 3 bits as defined in Subclause 9.2.3 of [5, TS
38.213]
- PDSCH-to-HARQ_feedback timing indicator - 3 bits as defined in
Subclause 9.2.3 of [5, TS38.213]

DCI format 1_1 may be used as non-fallback DCI for scheduling a PDSCH, where the CRC may be scrambled with a C-RNTI. DCI format 1_1 having a CRC scrambled with a C-RNTI may include, for example, the following information.

TABLE 7
Identifier for DCI formats - 1 bits
The value of this bit field is always set to 1, indicating a DL DCI format
Carrier indicator - 0 or 3 bits as defined in Subclause 10.1 of [5, TS 38.213].
Bandwidth part indicator - 0, 1 or 2 bits as determined by the number of DL
BWPs n_{BWP,RRC} configured by higher layers, excluding the initial DL bandwidth
part. The bitwidth for this field is determined as ┌log₂ (n_{BWP})┐ bits, where
- n_{BWP} = n_{BWP,RRC} + 1 if n_{BWP,RRC} ≤3, in which case the bandwidth part
indicator is equivalent to the ascending order of the higher layer parameter BWP-
Id;
otherwise n_{BWP} = n_{BWP,RRC}, in which case the bandwidth part indicator is defined
in Table 7.3.1.1.2-1;
If a UE does not support active BWP change via DCI, the UE ignores this bit
field.
Frequency domain resource assignment - number of bits determined by the
following, where N_{RB}^{DL,BWP} is the size of the active DL bandwidth part:
- N_{RBG} bits if only resource allocation type 0 is configured, where N_{RBG} is
defined in Subclause 5.1.2.2.1 of [6, TS38.214],
- ┌log₂(N_{RB}^{DL,BWP}(N_{RB}^{DL,BWP} +1)/ 2)┐ bits if only resource allocation type 1 is
configured, or
- max(┌log₂(N_{RB}^{DL,BWP}(N_{RB}^{DL,BWP} +1)/ 2)┐ , N_{RBG})+1 bits if both resource
allocation type 0 and 1 are configured.
If both resource allocation type 0 and 1 are configured, the MSB bit is used to
indicate resource allocation type 0 or resource allocation type 1, where the bit
value of 0 indicates resource allocation type 0 and the bit value of 1 indicates
resource allocation type 1.
For resource allocation type 0, the N_{RBG} LSBs provide the resource allocation as
defined in Subclause 5.1.2.2.1 of [6, TS 38.214].
For resource allocation type 1, the ┌log₂(N_{RB}^{DL,BWP}(N_{RB}^{DL,BWP} +1)/ 2)┐ LSBs provide
the resource allocation as defined in Subclause 5.1.2.2.2 of [6, TS 38.214]
If “Bandwidth part indicator” field indicates a bandwidth part other than the
active bandwidth part and if both resource allocation type 0 and 1 are configured
for the indicated bandwidth part, the UE assumes resource allocation type 0 for
the indicated bandwidth part if the bitwidth of the “Frequency domain resource
assignment” field of the active bandwidth part is smaller than the bitwidth of the
“Frequency domain resource assignment” field of the indicated bandwidth part.
Time domain resource assignment - 0, 1, 2, 3, or 4 bits as defined in Subclause
5.1.2.1 of [6, TS 38.214]. The bitwidth for this field is determined as ┌log₂ (I)┐
bits, where I is the number of entries in the higher layer parameter pdsch-
TimeDomainAllocationList if the higher layer parameter is configured; otherwise
I is the number of entries in the default table.
VRB-to-PRB mapping - 0 or 1 bit:
0 bit if only resource allocation type 0 is configured or if interleaved VRB-to-
PRB mapping is not configured by high layers;
1 bit according to Table 7.3.1.2.2-5 otherwise, only applicable to resource
allocation type 1, as defined in Subclause 7.3.1.6 of [4, TS 38.211].
PRB bundling size indicator - 0 bit if the higher layer parameter prb-
BundlingType is not configured or is set to ‘static’, or 1 bit if the higher layer
parameter prb-BundlingType is set to ‘dynamic’ according to Subclause 5.1.2.3 of
[6, TS 38.214].
Rate matching indicator - 0, 1, or 2 bits according to higher layer parameters
rateMatchPatternGroup1 and rateMatchPatternGroup2, where the MSB is used
to indicate rateMatchPatternGroup1 and the LSB is used to indicate
rateMatchPatternGroup2 when there are two groups.
ZP CSI-RS trigger - 0, 1, or 2 bits as defined in Subclause 5.1.4.2 of [6, TS
38.214]. The bitwidth for this field is determined as ┌log₂ (n_{ZP} + 1)┐ bits, where
n_{ZP} is the number of aperiodic ZP CSI-RS resource sets configured by higher
layer.
For transport block 1 :
Modulation and coding scheme - 5 bits as defined in Subclause 5.1.3.1 of [6, TS
38.214]
New data indicator - 1 bit
Redundancy version - 2 bits as defined in Table 7.3.1.1.1-2
For transport block 2 (only present if maxNrofCodeWordsScheduledByDCI
equals 2) :
Modulation and coding scheme - 5 bits as defined in Subclause 5.1.3.1 of [6, TS
38.214]
New data indicator - 1 bit
Redundancy version - 2 bits as defined in Table 7.3.1.1.1-2
If “Bandwidth part indicator” field indicates a bandwidth part other than the
active bandwidth part and the value of maxNrofCodeWordsScheduledByDCI for
the indicated bandwidth part equals 2 and the value of
maxNrofCodeWordsScheduledByDCI for the active bandwidth part equals 1, the
UE assumes zeros are padded when interpreting the “Modulation and coding
scheme”, “New data indicator”, and “Redundancy version” fields of transport
block 2 according to Subclause 12 of [5, TS38.213], and the UE ignores the
“Modulation and coding scheme”, “New data indicator”, and “Redundancy
version” fields of transport block 2 for the indicated bandwidth part.
HARQ process number - 4 bits
Downlink assignment index - number of bits as defined in the following
4 bits if more than one serving cell are configured in the DL and the higher layer
parameter pdsch-HARQ-ACK-Codebook=dynamic, where the 2 MSB bits are the
counter DAI and the 2 LSB bits are the total DAI;
2 bits if only one serving cell is configured in the DL and the higher layer
parameter pdsch-HARQ-ACK-Codebook=dynamic, where the 2 bits are the
counter DAI;
0 bits otherwise.
TPC command for scheduled PUCCH - 2 bits as defined in Subclause 7.2.1 of
[5, TS 38.213]
PUCCH resource indicator - 3 bits as defined in Subclause 9.2.3 of [5, TS
38.213]
PDSCH-to-HARQ_feedback timing indicator - 0, 1, 2, or 3 bits as defined in
Subclause 9.2.3 of [5, TS 38.213]. The bitwidth for this field is determined as
┌log₂ (I)┐ bits, where I is the number of entries in the higher layer parameter dl-
DataToUL-ACK.
Antenna port(s) - 4, 5, or 6 bits as defined by Tables 7.3.1.2.2-1/2/3/4, where the
number of CDM groups without data of values 1, 2, and 3 refers to CDM groups
{0}, {0,1}, and {0, 1, 2} respectively. The antenna ports {P₀,...,Pᵥ₋₁} shall be
determined according to the ordering of DMRS port(s) given by Tables
7.3.1.2.2-1/2/3/4.
If a UE is configured with both dmrs-DownlinkForPDSCH-MappingTypeA and
dmrs-DownlinkForPDSCH-MappingTypeB, the bitwidth of this field equals
max {x_{A}, x_{B}} , where x_{A} is the “Antenna ports” bitwidth derived according to
dmrs-DownlinkForPDSCH-MappingTypeA and x_{B} is the “Antenna ports”
bitwidth derived according to dmrs-DownlinkForPDSCH-MappingTypeB. A
number of |x_{A} − x_{B}| zeros are padded in the MSB of this field, if the mapping
type of the PDSCH corresponds to the smaller value of x_{A} and x_{B}.
Transmission configuration indication - 0 bit if higher layer parameter tci-
PresentInDCI is not enabled; otherwise 3 bits as defined in Subclause 5.1.5 of
[6, TS38.214].
If “Bandwidth part indicator” field indicates a bandwidth part other than the
active bandwidth part,
if the higher layer parameter tci-PresentInDCI is not enabled for the CORESET
used for the PDCCH carrying the DCI format 1_1,
the UE assumes tci-PresentInDCI is not enabled for all CORESETs in the
indicated bandwidth part;
otherwise,
the UE assumes tci-PresentInDCI is enabled for all CORESETs in the indicated
bandwidth part.
SRS request - 2 bits as defined by Table 7.3.1.1.2-24 for UEs not configured
with supplementaryUplink in ServingCellConfig in the cell; 3 bits for UEs
configured with supplementaryUplink in ServingCellConfig in the cell where the
first bit is the non-SUL/SUL indicator as defined in Table 7.3.1.1.1-1 and the
second and third bits are defined by Table 7.3.1.1.2-24. This bit field may also
indicate the associated CSI-RS according to Subclause 6.1.1.2 of [6, TS 38.214].
CBG transmission information (CBGTI) - 0 bit if higher layer parameter
codeBlockGroupTransmission for PDSCH is not configured, otherwise, 2, 4, 6,
or 8 bits as defined in Subclause 5.1.7 of [6, TS38.214], determined by the
higher layer parameters maxCodeBlockGroupsPerTransportBlock and
maxNrofCodeWordsScheduledByDCI for the PDSCH.
CBG flushing out information (CBGFI) - 1 bit if higher layer parameter
codeBlockGroupFlushIndicator is configured as “TRUE”, 0 bit otherwise.
- DMRS sequence initialization - 1 bit.

Next, a description is given of time domain resource allocation for a data channel in a 5G wireless communication system.

The base station may configure a UE with a table regarding time domain resource allocation for a downlink data channel (physical downlink shared channel, PDSCH) and an uplink data channel (physical uplink shared channel, PUSCH) via higher layer signaling (e.g., RRC signaling). For the PDSCH, a table composed of maxNrofDL-Allocations=16 entries can be configured, and for the PUSCH, a table composed of maxNrofUL-Allocations=16 entries can be configured. Time domain resource allocation information may include, for example, PDCCH-to-PDSCH slot timing (corresponding to the time interval in units of slots between the time when the PDCCH is received and the time when the PDSCH scheduled by the received PDCCH is transmitted, denoted as K0), PDCCH-to-PUSCH slot timing (corresponding to the time interval in units of slots between the time when the PDCCH is received and the time when the PUSCH scheduled by the received PDCCH is transmitted, denoted as K2), information on the start symbol position and length for which the PDSCH or PUSCH is scheduled within the slot, mapping type of the PDSCH or PUSCH, or the like. For example, information as shown in Table 8 and Table 9 below may be notified from the base station to the UE.

TABLE 8
PDSCH-TimeDomainResourceAllocationList information element

PDSCH-TimeDomainResourceAllocationList ::= SEQUENCE
(SIZE(1..maxNrofDL-Allocations)) OF PDSCH-
TimeDomainResourceAllocation
PDSCH-TimeDomainResourceAllocation ::= SEQUENCE {
k0 INTEGER(0..32) OPTIONAL,
-- Need S
mappingType ENUMERATED {typeA, typeB},
startSymbolAndLength INTEGER (0..127)
}

TABLE 9
PUSCH-TimeDomainResourceAllocation information element

PUSCH-TimeDomainResourceAllocationList ::= SEQUENCE
(SIZE(1..maxNrofUL-Allocations)) OF PUSCH-
TimeDomainResourceAllocation
PUSCH-TimeDomainResourceAllocation ::= SEQUENCE {
k2 INTEGER(0..32) OPTIONAL, -- Need S
mappingType ENUMERATED {typeA, typeB},
startSymbolAndLength INTEGER (0..127)
}

The base station may notify one of the entries of the table for the time domain resource allocation information to the UE through L1 signaling (e.g., DCI) (e.g., it can be indicated by ‘time domain resource allocation’ field in DCI). The UE may obtain time domain resource allocation information for the PDSCH or PUSCH based on the DCI received from the base station.

Next, a description will be given of a method for frequency domain resource allocation for a data channel in a 5G wireless communication system.

In a 5G wireless communication system, there are two types of schemes for indicating frequency domain resource allocation information for a downlink data channel (physical downlink shared channel, PDSCH) and uplink data channel (physical uplink shared channel, PUSCH): resource allocation type 0 and resource allocation type 1.

### Resource Allocation Type 0

RB allocation information may be notified from the base station to the UE in the form of a bitmap for a resource block group (RBG). Here, the RBG may be composed of a set of consecutive virtual RBs (VRBs), and the size P of the RBG may be determined on the basis of a value set by a higher layer parameter (rbg-Size) and the BWP size as defined in table below.

TABLE 10
Nominal RBG size P

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

A total number (NRBG) of RBGs of BWP i having a size of N_{BWP,i}^{size} may be defined as follows.

$${N}_{R B G} = ⌈ ( {N}_{BWP , i}^{size} + ( {N}_{BWP , i}^{start} mod P ) ) / P ⌉ ,$$

where

♦ the size of the first RBG is RBG₀^{size}=P−N_{BWP,i}^{start} mod P
♦ the size of last RBG is RBGₗₐₛₜ^{size}=(N_{BWP,i}^{start}+N_{BWP,i}^{size})mod P if (N_{BWP,i}^{start}+N_{BWP,i}^{size})mod P>0 and P otherwise,
♦ the size of all other RBGs is P.
Each bit of a bitmap having a size of NRBG bits may correspond to one RBG. RBGs may be assigned indexes according to a sequence in which the frequency increases from the lowest frequency position of a BWP. For NRBG RBGs in a BWP, RBG #0 to RBG #(N_{RBG}−1) may be mapped from the MSB to the LSB of an RBG bitmap. When a particular bit value in a bitmap is 1, the UE may determine that an RBG corresponding to the bit value has been allocated, and when a particular bit value in a bitmap is 0, the UE may determine that an RBG corresponding to the bit value has not been allocated.

### Resource Allocation Type 1

RB allocation information may be notified from the base station to the UE as information relating to the start position and length of consecutively allocated VRBs. Here, interleaving or non-interleaving may be additionally applied to the consecutively allocated VRBs. A resource allocation field of resource allocation type 1 may be composed of a resource indication value (RIV), and the RIV may be composed of the start point (RBstart) of a VRB and the length (LRBs) of consecutively allocated RBs. More specifically, the RIV of a BWP having a size of N may be defined as follows.

[symbol]

if (L_{RBs} −1)≤└N_{BWP}^{size}/2┘ then [symbol]
RIV = N_{BWP}^{size} (L_{RBs} −1) + RBₛₜₐᵣₜ [symbol]
else [symbol]
RIV = N_{BWP}^{size} (N_{BWP}^{size} − L_{RBs} +1)+(N_{BWP}^{size}−1−RBₛₜₐᵣₜ) [symbol]
where L_{RBs} ≥ 1 and shall not exceed N_{BWP}^{size} − RBₛₜₐᵣₜ.

The base station may configure the UE with a resource allocation type through higher layer signaling (e.g., a higher layer parameter resourceAllocation may be set to one value among resourceAllocationType0, resourceAllocationType1, or dynamicSwitch). If both resource allocation types 0 and 1 are configured to for the UE (or in the same way, the higher layer parameter resourceAllocation is set to dynamicSwitch), a bit corresponding to the most significant bit (MSB) in a resource allocation indication field in the DCI format indicating scheduling may indicate resource allocation type 0 or 1. Additionally, resource allocation information may be indicated through the remaining bits except for the bit corresponding to the MSB on the basis of the indicated resource allocation type, and the UE may interpret resource allocation field information of the DCI field based thereon. If one of resource allocation type 0 or 1 is configured to the UE (or in the same way, the higher layer parameter resourceAllocation is set to resourceAllocationType0 or resourceAllocationType1), a resource allocation indication field in the DCI format indicating scheduling may indicate resource allocation information, based on the configured resource allocation type, and the UE may interpret resource allocation field information of the DCI field based thereon.

Next, a detailed description will be given of the modulation and coding scheme (MCS) used in a 5G wireless communication system.

In 5G, multiple MCS index tables are defined for PDSCH and PUSCH scheduling. Which MCS table the UE assumes among plural MCS tables may be set or indicated through higher layer signaling from the base station to the UE, L1 signaling, or an RNTI value that the UE assumes when decoding the PDCCH.

MCS index table 1 for PDSCH and CP-OFDM-based PUSCH (or, PUSCH without transform precoding) may be as follows.

TABLE 5.1.3.1-1
MCS index table 1 for PDSCH

| MCS | Modulation | Target code | |
|---|---|---|---|
| Index | Order | Rate | Spectral |
| I_{MCS} | Qₘ | R × [1024] | efficiency |
| 0 | 2 | 120 | 0.2344 |
| 1 | 2 | 157 | 0.3066 |
| 2 | 2 | 193 | 0.3770 |
| 3 | 2 | 251 | 0.4902 |
| 4 | 2 | 308 | 0.8016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 438 | 2.5664 |
| 18 | 6 | 468 | 2.7305 |
| 19 | 6 | 517 | 3.0293 |
| 20 | 6 | 567 | 3.3223 |
| 23 | 6 | 616 | 3.6094 |
| 22 | 6 | 666 | 3.9023 |
| 23 | 6 | 719 | 4.2129 |
| 24 | 6 | 772 | 4.5234 |
| 25 | 6 | 822 | 4.8164 |
| 26 | 6 | 873 | 5.1152 |
| 27 | 6 | 910 | 5.3320 |
| 28 | 6 | 948 | 5.5547 |

| | | |
|---|---|---|
| 29 | 2 | reserved |
| 30 | 4 | reserved |
| 31 | 6 | reserved |

MCS index table 2 for PDSCH and CP-OFDM-based PUSCH (or, PUSCH without transform precoding) may be as follows.

TABLE 5.1.3.1-2
MCS index table 2 for PDSCH

| MCS | Modulation | Target code | |
|---|---|---|---|
| Index | Order | Rate | Spectral |
| I_{MCS} | Qₘ | R × [1024] | efficiency |
| 0 | 2 | 120 | 0.2344 |
| 1 | 2 | 193 | 0.3770 |
| 2 | 2 | 308 | 0.6016 |
| 3 | 2 | 449 | 0.8770 |
| 4 | 2 | 602 | 1.1758 |
| 5 | 4 | 378 | 1.4766 |
| 6 | 4 | 434 | 1.8953 |
| 7 | 4 | 480 | 1.9141 |
| 8 | 4 | 553 | 2.1602 |
| 9 | 4 | 616 | 2.4063 |
| 10 | 4 | 658 | 2.5703 |
| 11 | 6 | 466 | 2.7305 |
| 12 | 6 | 517 | 3.0293 |
| 13 | 6 | 587 | 3.3223 |
| 14 | 6 | 616 | 3.6094 |
| 15 | 6 | 666 | 3.9023 |
| 16 | 6 | 719 | 4.2129 |
| 17 | 6 | 772 | 4.5234 |
| 18 | 6 | 822 | 4.8164 |
| 19 | 6 | 873 | 8.1182 |
| 20 | 8 | 682.5 | 5.3320 |
| 21 | 8 | 711 | 5.5647 |
| 22 | 8 | 754 | 5.8906 |
| 23 | 8 | 797 | 6.2266 |
| 24 | 8 | 841 | 6.5703 |
| 25 | 8 | 885 | 6.9141 |
| 26 | 8 | 916.5 | 7.1602 |
| 27 | 8 | 948 | 7.4063 |

| | | |
|---|---|---|
| 28 | 2 | reserved |
| 29 | 4 | reserved |
| 30 | 6 | reserved |
| 31 | 8 | reserved |

MCS index table 3 for PDSCH and CP-OFDM-based PUSCH (or, PUSCH without transform precoding) may be as follows.

TABLE 5.1.3.1-3
MCS index table 3 for PDSCH

| MCS | Modulation | Target code | |
|---|---|---|---|
| Index | Order | Rate | Spectral |
| I_{MCS} | Qₘ | R × [1024] | efficiency |
| 0 | 2 | 30 | 0.0586 |
| 1 | 2 | 40 | 0.0781 |
| 2 | 2 | 50 | 0.0977 |
| 3 | 2 | 64 | 0.1250 |
| 4 | 2 | 78 | 0.1523 |
| 5 | 2 | 99 | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 448 | 0.8770 |
| 13 | 2 | 526 | 1.0273 |
| 14 | 2 | 602 | 1.1758 |
| 15 | 4 | 340 | 1.3281 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 6 | 438 | 2.5664 |
| 22 | 6 | 466 | 2.7305 |
| 23 | 6 | 517 | 3.0293 |
| 24 | 6 | 567 | 3.3223 |
| 25 | 6 | 616 | 3.6094 |
| 26 | 6 | 666 | 3.9023 |
| 27 | 6 | 719 | 4.2129 |
| 28 | 6 | 772 | 4.5234 |

| | | |
|---|---|---|
| 29 | 2 | reserved |
| 30 | 4 | reserved |
| 31 | 6 | reserved |

MCS index table 1 for DFT-s-OFDM based PUSCH (or, PUSCH with transform precoding) may be as follows.

TABLE 6.1.4.1-1
MCS index table for PUSCH with
transform precoding and 64 QAM

| MCS | Modulation | Target code | |
|---|---|---|---|
| Index | Order | Rate | Spectral |
| I_{MCS} | Qₘ | R × [1024] | efficiency |
| 0 | q | 240/q | 0.2344 |
| 1 | q | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | reserved |
| 29 | 2 | reserved |
| 30 | 4 | reserved |
| 31 | 6 | reserved |

MCS index table 2 for DFT-s-OFDM based PUSCH (or, PUSCH with transform precoding) may be as follows.

TABLE 6.1.4.1-2
MCS index table 2 for PUSCH with
transform precoding and 64 QAM

| MCS | Modulation | Target code | |
|---|---|---|---|
| Index | Order | Rate | Spectral |
| I_{MCS} | Qₘ | R × [1024] | efficiency |
| 0 | q | 60/q | 0.0586 |
| 1 | q | 80/q | 0.0781 |
| 2 | q | 100/q | 0.0977 |
| 3 | q | 128/q | 0.1250 |
| 4 | q | 156/q | 0.1523 |
| 5 | q | 198/q | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 2 | 679 | 1.3262 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 4 | 658 | 2.5703 |
| 22 | 4 | 699 | 2.7303 |
| 23 | 4 | 772 | 3.0136 |
| 24 | 6 | 567 | 3.3223 |
| 25 | 6 | 616 | 3.6094 |
| 26 | 6 | 666 | 3.9023 |
| 27 | 6 | 772 | 4.5234 |

| | | |
|---|---|---|
| 28 | q | reserved |
| 29 | 2 | reserved |
| 30 | 4 | reserved |
| 31 | 6 | reserved |

An MCS index table for PUSCH with transform precoding (or discrete Fourier transform (DFT) precoding) and 64 QAM applied may be as follows.

| MCS | Modulation | Target code | |
|---|---|---|---|
| Index | Order | Rate | Spectral |
| I_{MCS} | Qₘ | R × [1024] | efficiency |
| 0 | q | 240/q | 0.2344 |
| 1 | q | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | reserved |
| 29 | 2 | reserved |
| 30 | 4 | reserved |
| 31 | 6 | reserved |

An MCS index table for PUSCH with transform precoding (or discrete Fourier transform (DFT) precoding) and 64 QAM applied may be as follows.

| MCS | Modulation | Target code | |
|---|---|---|---|
| Index | Order | Rate | Spectral |
| I_{MCS} | Qₘ | R × [1024] | efficiency |
| 0 | q | 60/q | 0.0586 |
| 1 | q | 80/q | 0.0781 |
| 2 | q | 100/q | 0.0977 |
| 3 | q | 128/q | 0.1250 |
| 4 | q | 156/q | 0.1523 |
| 5 | q | 198/q | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 2 | 679 | 1.3262 |
| 16 | 4 | 378 | 1.4766 |
| 17 | 4 | 434 | 1.6953 |
| 18 | 4 | 490 | 1.9141 |
| 19 | 4 | 553 | 2 1602 |
| 20 | 4 | 616 | 2.4063 |
| 21 | 4 | 658 | 2.5703 |
| 22 | 4 | 699 | 2.7305 |
| 23 | 4 | 772 | 3.0156 |
| 24 | 6 | 567 | 3.3223 |
| 25 | 6 | 616 | 3.6094 |
| 26 | 6 | 666 | 3.9023 |
| 27 | 6 | 772 | 4.5234 |

| | | |
|---|---|---|
| 28 | q | reserved |
| 29 | 2 | reserved |
| 30 | 4 | reserved |
| 31 | 6 | reserved |

Next, a detailed description will be given of a downlink control channel in a 5G wireless communication system with reference to the drawings.

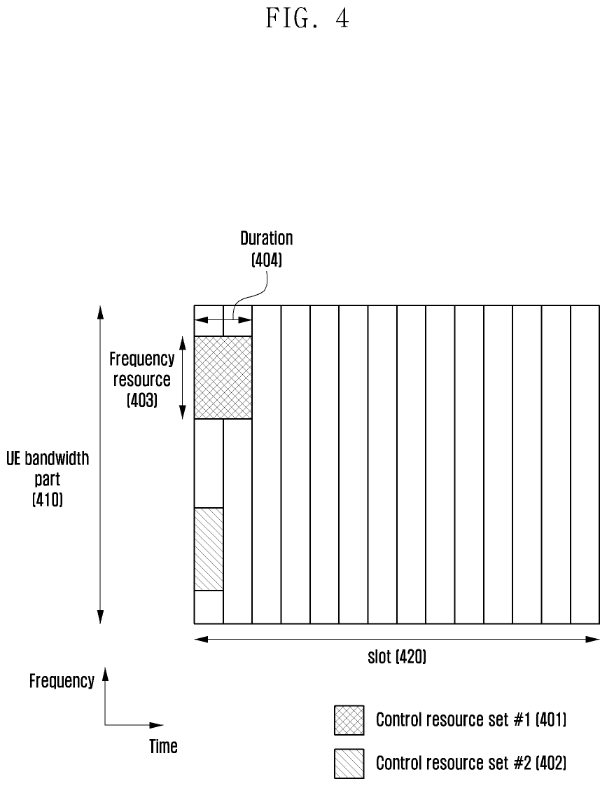

FIG. 4 is a diagram illustrating an example of a control resource set (CORESET) through which a downlink control channel is transmitted in a 5G wireless communication system.

Referring to FIG. 4, a UE bandwidth part 410 may be configured on the frequency domain, and two control resource sets (control resource set #1 (401) and control resource set #2 (402)) are configured in one slot 420 on the time domain. Control resource set #1 (401) and control resource set #2 (402) may be configured on a specific frequency resource 403 within the entire UE bandwidth part 410 in the frequency domain. Further, the control resource sets 401 and 402 may be configured to one or multiple OFDM symbols in the time domain, and this may be defined as a control resource set duration 404. In the example of FIG. 4, control resource set #1 (401) is configured with a control resource set duration of two symbols, and control resource set #2 (402) is configured with a control resource set duration of one symbol.

The control resource set in the above-described 5G wireless communication system may be configured to the UE by the base station through higher layer signaling (e.g., system information, master information block (MIB), and radio resource control (RRC) signaling). Configuring a control resource set to the UE may mean providing information such as a control resource set identity, a frequency location of the control resource set, a symbol duration of the control resource set, and the like. For example, the following information may be included.

TABLE 11

| | |
|---|---|
| ControlResourceSet ::= | SEQUENCE { |

Corresponds to L1 parameter ′CORESET-ID′

| | |
|---|---|
| controlResourceSetId | ControlResourceSetId, |

frequencyDomainResources BIT STRING (SIZE (45)),

| | |
|---|---|
| duration | INTEGER (1..maxCoReSetDuration), |
| cce-REG-MappingType | CHOICE { |
| interleaved | SEQUENCE { |
| reg-BundleSize | ENUMERATED {n2, n3, n6}, |
| precoderGranularity | ENUMERATED {sameAsREG- |

bundle, allContiguousRBs},

| | |
|---|---|
| interleaverSize | ENUMERATED {n2, n3, n6} |
| shiftIndex | INTEGER(0.. |
| | maxNrofPhysicalResourceBlocks-1) |
| | OPTIONAL |
| }, | |
| nonInterleaved | NULL |
| }, | |
| tci-StatesPDCCH | SEQUENCE(SIZE (1..maxNrofTCI- |

StatesPDCCH)) OF TCI-StateId OPTIONAL,

| | |
|---|---|
| tci-PresentInDCI | ENUMERATED {enabled} |

OPTIONAL, -- Need S

}

In Table 11, tci-StatesPDCCH (simply referred to as transmission configuration indication (TCI) state) configuration information may include information about one or more synchronization signal (SS)/physical broadcast channel (PBCH) block indexes or channel state information reference signal (CSI-RS) indexes in a quasi-co-located (QCLed) relationship with a demodulation reference signal (DMRS) transmitted in the corresponding control resource set.

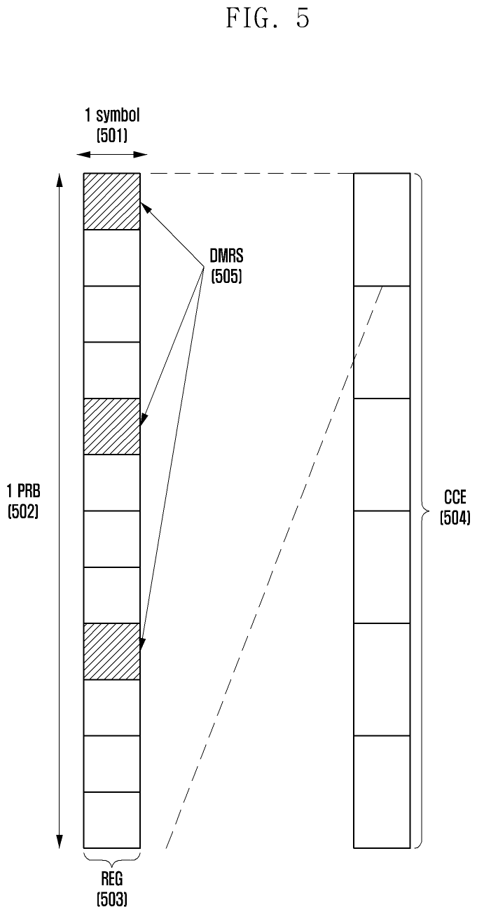

FIG. 5 is a diagram showing the structure of a downlink control channel in a 5G wireless communication system. That is, FIG. 5 is a diagram illustrating an example of a basic unit of time and frequency resources constituting a downlink control channel that is usable in a 5G wireless communication system.

With reference to FIG. 5, the basic unit of time and frequency resources constituting a control channel may be referred to as a resource element group (REG) 503, and the REG 503 may be defined as one OFDM symbol 501 in the time domain and one physical resource block (PRB) 502, that is, 12 subcarriers, in the frequency domain. The base station may concatenate REGs 503 to compose a downlink control channel allocation unit.

As illustrated in FIG. 5, when the basic unit to which the downlink control channel is assigned in a 5G wireless communication system is a control channel element (CCE) 504, one CCE 504 may be composed of plural REGs 503. Taking the REG 503 shown in FIG. 5 as an example, when the REG 503 includes 12 REs and one CCE 504 includes 6 REGs 503, one CCE 504 may include 72 REs. When a downlink control resource set is configured, the corresponding region may be composed of multiple CCEs (504), and a specific downlink control channel may be transmitted after being mapped to one or multiple CCEs 504 according to an aggregation level (AL) in the control resource set. The CCEs 504 in a control resource set may be identified by numbers, in which case the numbers may be assigned to the CCEs 504 according to a logical mapping scheme.

The basic unit of the downlink control channel illustrated in FIG. 5, that is, the REG 503, may include both REs to which the DCI is mapped and a region to which a DMRS 505 being a reference signal for decoding the DCI is mapped. As illustrated in FIG. 5, three DMRSs 505 may be transmitted in one REG 503. The number of CCEs required to transmit the PDCCH may be 1, 2, 4, 8, or 16 according to the aggregation level (AL), and different number of CCEs may be used to implement link adaptation of the downlink control channel. For example, when AL=L, one downlink control channel may be transmitted through L CCEs. The UE has to detect a signal without having information about the downlink control channel, and a search space representing a set of CCEs is defined for blind decoding. The search space may refer to a set of downlink control channel candidates composed of CCEs to which the UE has to attempt decoding on a given aggregation level. Because there are various aggregation levels that groups 1, 2, 4, 8, or 16 CCEs into one bundle, the UE may have plural search spaces. The search space set may be defined as a set of search spaces at all configured aggregation levels.

A search space may be classified as a common search space and a UE-specific search space. A group of UEs or all UEs may search for a common search space of the PDCCH to receive cell-common control information such as dynamic scheduling of system information or a paging message. For example, PDSCH scheduling allocation information for transmitting an SIB including cell operator information or the like may be received by searching for the common search space of the PDCCH. Since a group of UEs or all UEs need to receive the PDCCH, a common search space may be defined as a set of CCEs agreed upon in advance. Scheduling allocation information for a UE-specific PDSCH or PUSCH may be received by searching for a UE-specific search space of the PDCCH. A UE-specific search space may be defined in a UE-specific way as a function of UE identity and various system parameters.

In a 5G wireless communication system, parameters for a search space for the PDCCH may be configured by the base station to the UE via higher layer signaling (e.g., SIB, MIB, or RRC signaling). For example, the base station may configure, to the UE, the number of PDCCH candidates at each aggregation level L, a periodicity of monitoring the search space, a search space monitoring occasion in units of symbols within a slot, a search space type (common search space or UE-specific search space), a DCI format—RNTI combination to be monitored in a corresponding search space, a control resource set index at which a search space is to be monitored, and the like. For example, parameters for the search space for the PDCCH may include the following information.

TABLE 12

| | |
|---|---|
| SearchSpace ::= | SEQUENCE { |

Identity of the search space. SearchSpaceId = 0 identifies the SearchSpace configured via
PBCH (MIB) or ServingCellConfigCommon.

| | |
|---|---|
| searchSpaceId | SearchSpaceId, |
| controlResourceSetId | ControlResourceSetId, |
| monitoringSlotPeriodicityAndOffset | CHOICE { |
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |
| } | |

OPTIONAL,
duration INTEGER (2..2559)

| | |
|---|---|
| monitoringSymbolsWithinSlot | BIT STRING (SIZE (14)) |
| | OPTIONAL, |
| nrofCandidates | SEQUENCE { |
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |
| }, | |
| searchSpaceType | CHOICE { |

Configures this search space as common search space (CSS) and DCI formats to monitor.

| | |
|---|---|
| common | SEQUENCE { |
| } | |
| ue-Specific | SEQUENCE { |

Indicates whether the UE monitors in this USS for DCI formats 0-0 and 1-0 or for formats

| | |
|---|---|
| 0-1 and 1-1. | |
| formats | ENUMERATED {formats0-0-And-1-0, |
| formats0-1-And-1-1}, | |
| ... | |
| } | |

Based on the configuration information, the base station may configure one or multiple search space sets to the UB. According to an embodiment, the base station may configure the UE with search space set 1 and search space set 2 so as to monitor DCI format A scrambled with X-RNTJ in a common search space of search space set 1, and monitor DCI format B scrambled with Y-RNTJ in a UB-specific search space of search space set 2.

According to the configuration information, one or multiple search space sets may be present in a common search space or a UE-specific search space. For example, search space set #1 and search space set #2 may be configured as a common search space, and search space set #3 and search space set #4 may be configured as a UE-specific search space.

In a common search space, the following combination of a DCI format and an RNTI may be monitored. However, it is not limited to the examples below.
DCI format 0_0/1_0 with CRC scrambled by C-RNTI, CS-RNTI, MCS-C-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In a UE-specific search space, the following combination of a DCI format and an RNTI may be monitored. However, it is not limited to the examples below.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The above-described RNTIs may follow the definition and usage described below.
C-RNTI (cell RNTI): used for scheduling UE-specific PDSCH
MCS-C-RNTI (modulation coding scheme C-RNTI): used for scheduling UE-specific PDSCH
TC-RNTI (temporary cell RNTI): used for scheduling UE-specific PDSCH
CS-RNTI (configured scheduling RNTI): used for scheduling semi-statically configured UE-specific PDSCH
RA-RNTI (random access RNTI): used for scheduling PDSCH at random access stage
P-RNTI (paging RNTI): used for scheduling PDSCH in which paging is transferred
SI-RNTI (system information RNTI): used for scheduling PDSCH in which system information is transmitted
INT-RNTI (interruption RNTI): used for indicating whether to perform puncturing on PDSCH
TPC-PUSCH-RNTI (transmit power control for PUSCH RNTI): used for issuing a power control command for PUSCH
TPC-PUCCH-RNTI (transmit power control for PUCCH RNTI): used for issuing a power control command for PUCCH
TPC-SRS-RNTI (transmit power control for SRS RNTI): used for issuing a power control command for SRS

The DCI formats specified above may follow the definitions below.

TABLE 13

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

In a 5G wireless communication system, with control resource set p and search space set s, the search space at aggregation level L may be represented as in the following equation.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{p , s , max}^{( L )}} ⌋ + {n}_{C I} ) mod ⌊ {N}_{C C B , p} / L ⌋ \} + i \qquad Equation 1$$

L: aggregation level
nCI carrier index
NCCE,p: total number of CCEs present in control resource set p
nμs,f: slot index
M(L)p,s,max: number of PDCCH candidates at aggregation level L
msnCI=0, . . . , M(L)p,s,max−1: PDCCH candidate index at aggregation level L
i=0, . . . , L−1

$${Y}_{p , {n}_{s , f}^{μ}} = ( {A}_{p} \cdot {Y}_{p , {n}_{s , f}^{μ} - 1} ) mod D , {Y}_{p , - 1} = {n}_{R N T I} \neq 0 , {A}_{0} = 3 \; 9827 ,$$

$${A}_{1} = 3982 \text{?} , {A}_{2} = 39 \; 839 , D = 6553$$

$$\text{?} \text{indicates text missing or illegible when filed}$$

nRNTI: UE identity

The value of Y_(p,nμs,f) may correspond to 0 for the common search space.

For the UE-specific search space, the value of Y_(p,nμs,f) may correspond to a value that changes according to the UE identity (C-RNTI or ID configured by the BS to the UE) and the time index.

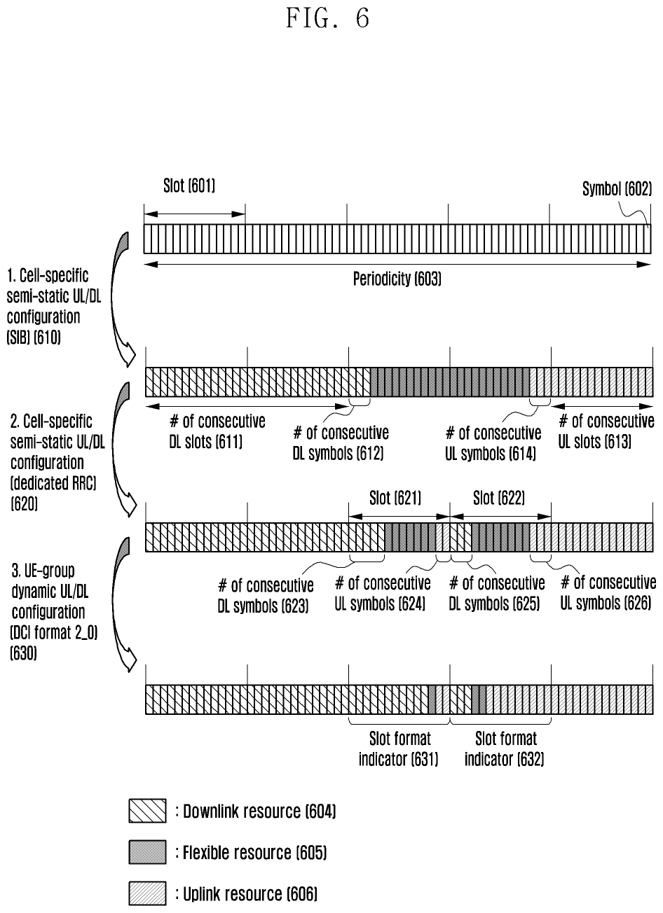

FIG. 6 is a diagram illustrating an example of uplink-downlink configurations considered in a 5G communication system according to an embodiment of the disclosure.

With reference to FIG. 6, one slot 601 may include 14 symbols 602. In a 5G communication system, uplink-downlink configurations of symbols/slots may be set in three stages. First, the uplink-downlink of symbols/slots may be set semi-statically in units of symbols through cell-specific configuration information 610 through system information. Specifically, cell-specific uplink-downlink configuration information through system information may include uplink-downlink pattern information and baseline subcarrier information. Uplink-downlink pattern information may indicate a periodicity 603 of a pattern, the number of consecutive downlink slots 611 from the start point of the pattern, the number of symbols in the next slot 612, the number of consecutive uplink slots 613 from the end of the pattern, and the number of symbols in the next slot 614. At this time, slots and symbols not indicated as uplink or downlink may be determined as flexible slots/symbols.

Second, through UE-specific configuration information via dedicated higher layer signaling, a flexible slot or slot containing flexible symbols (621 or 622) may be indicated by the number of consecutive downlink symbols (623 or 625) from the start symbol of the slot and the number of consecutive uplink symbols (624 or 626) from the end of the slot, or indicated as full downlink slot or full uplink slot.

In addition, lastly (third), to dynamically change the downlink and uplink signal transmission sections, those symbols indicated as a flexible symbol in each slot (i.e., symbols not indicated as downlink or uplink) may be indicated, via a slot format indicator (SFI) (631 or 632) included in the downlink control channel, whether they are a downlink symbol, an uplink symbol, or a flexible symbol. The slot format indicator may select one index from a table in which uplink-downlink configurations of 14 symbols in a slot are preset, as shown in the table below.

TABLE 14

| | Symbol number in a slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |
| 40 | D | F | F | F | U | U | U | U | U | U | U | U | U | U |
| 41 | D | D | F | F | F | U | U | U | U | U | U | U | U | U |
| 42 | D | D | D | D | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | U | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56- | Reserved |
| 254 | |
| 256 | UE determines the slot format for the slot based on TDD- |
| | UL-DL-ConfigurationCommon [symbol] TDD-UL-DL- |
| | ConfigDedicated and [symbol] if any, on detected DCI formats |

[symbol]

indicates data missing or illegible when filed

### [PUSCH: Transmission Scheme Related]

Next, a description is given of scheduling schemes of PUSCH transmission. PUSCH transmission may be dynamically scheduled by the UL grant in DCI or operated by configured grant type 1 or type 2. Dynamic scheduling for PUSCH transmission can be indicated in DCI format 0_0 or 0_1.

Configured grant type 1 PUSCH transmission may be semi-statically configured through reception of configuredGrantConfig including rrc-ConfiguredUplinkGrant of Table 15 via higher signaling, without receiving the UL grant in DCI. Configured grant type 2 PUSCH transmission may be semi-persistently scheduled by the UL grant in DCI after reception of configuredGrantConfig not including rrc-ConfiguredUplinkGrant of Table 15 through higher signaling. When PUSCH transmission is operated by a configured grant, parameters applied to PUSCH transmission are applied through configuredGrantConfig, which is higher signaling of Table 15, except for dataScramblingIdentityPUSCH, txConfig, codebookSubset, maxRank, and scaling of UCI-OnPUSCH provided by pusch-Config of Table 16, which is higher signaling. When the UE receives transformPrecoder in configuredGrantConfig, which is higher signaling of Table 15, the UE applies tp-pi2BPSK in pusch-Config of Table 16 to PUSCH transmission operated by a configured grant.

TABLE 15
ConfiguredGrantConfig ::= SEQUENCE {
frequencyHopping ENUMERATED {intraSlot, interSlot}
OPTIONAL, -- Need S,
cg-DMRS-Configuration DMRS-UplinkConfig,
mcs-Table ENUMERATED {qam256, qam64LowSE}
OPTIONAL, -- Need S
mcs-TableTransformPrecoder ENUMERATED {qam256,
qam64LowSE}
OPTIONAL, -- Need S
uci-OnPUSCH SetupRelease { CG-UCI-OnPUSCH }
OPTIONAL, -- Need M
resourceAllocation ENUMERATED { resourceAllocationType0,
resourceAllocationType1, dynamicSwitch },
rbg-Size ENUMERATED {config2} OPTIONAL,
-- Need S
powerControlLoopToUse ENUMERATED {n0, n1},
p0-PUSCH-Alpha P0-PUSCH-AlphaSetId,
transformPrecoder ENUMERATED {enabled, disabled}
OPTIONAL, -- Need S
nrofHARQ-Processes INTEGER(1..16),
repK ENUMERATED {n1, n2, n4, n8},
repK-RV ENUMERATED {s1-0231, s2-0303, s3-0000}
OPTIONAL, -- Need R
periodicity ENUMERATED {
sym2, sym7, sym1x14, sym2x14, sym4x14, sym5x14, sym8x14,
sym10x14, sym16x14, sym20x14,
sym32x14, sym40x14, sym64x14, sym80x14, sym128x14, sym160x14,
sym256x14, sym320x14, sym512x14,
sym640x14, sym1024x14, sym1280x14, sym2560x14, sym5120x14,
sym6, sym1x12, sym2x12, sym4x12, sym5x12, sym8x12, sym10x12,
sym16x12, sym20x12, sym32x12,
sym40x12, sym64x12, sym80x12, sym128x12, sym160x12, sym256x12,
sym320x12, sym512x12, sym640x12,
sym1280x12, sym2560x12
},
configuredGrantTimer INTEGER (1..64) OPTIONAL,
-- Need R
rrc-ConfiguredUplinkGrant SEQUENCE {
timeDomainOffset INTEGER (0..5119),
timeDomainAllocation INTEGER (0..15),
frequencyDomainAllocation BIT STRING (SIZE(18)),
antennaPort INTEGER (0..31),
dmrs-SeqInitialization INTEGER (0..1) OPTIONAL,
-- Need R
precodingAndNumberOfLayers INTEGER (0..63),
srs-ResourceIndicator INTEGER (0..15) OPTIONAL,
-- Need R
mcsAndTBS INTEGER (0..31),
frequencyHoppingOffset INTEGER (1..
maxNrofPhysicalResourceBlocks-1)
OPTIONAL, -- Need R
pathlossReferenceIndex INTEGER (0..maxNrofPUSCH-
PathlossReferenceRSs-1),
... OPTIONAL, --
}
Need R
...
}

Next, a description is given of PUSCH transmission schemes. A DMRS antenna port for PUSCH transmission is the same as an antenna port for SRS transmission. PUSCH transmission may follow codebook-based transmission and non-codebook-based transmission respectively according to whether the value of txConfig in pusch-Config of Table 16, which is higher signaling, is ‘codebook’ or ‘nonCodebook’.

As described above, PUSCH transmission may be dynamically scheduled through DCI format 0_0 or 0_1 and be semi-statically configured by a configured grant. When PUSCH transmission scheduling is indicated to the UE through DCI format 0_0, the UE performs beam configuration for PUSCH transmission by using pucch-spatialRelationInfoID corresponding to the UE-specific PUCCH resource corresponding to a minimum ID in the uplink BWP activated in the serving cell, in which case PUSCH transmission is based on a single antenna port. The UE does not expect scheduling of PUSCH transmission through DCI format 0_0 within the BWP in which a PUCCH resource including pucch-spatialRelationInfo is not configured. When the UE has not been configured with txConfig in pusch-Config of Table 16, the UE does not expect being scheduled in DCI format 0_1.

TABLE 16
PUSCH-Config ::= SEQUENCE {
dataScramblingIdentityPUSCH INTEGER (0..1023)
OPTIONAL, -- Need S
txConfig ENUMERATED {codebook, nonCodebook}
OPTIONAL, -- Need S
dmrs-UplinkForPUSCH-MappingTypeA SetupRelease
{ DMRS-UplinkConfig }
OPTIONAL, -- Need M
dmrs-UplinkForPUSCH-MappingTypeB SetupRelease
{ DMRS-UplinkConfig }
OPTIONAL, -- Need M
pusch-PowerControl PUSCH-PowerControl
OPTIONAL, -- Need M
frequencyHopping ENUMERATED {intraSlot, interSlot}
OPTIONAL, -- Need S
frequencyHoppingOffsetLists SEQUENCE (SIZE (1..4)) OF
INTEGER (1..maxNrofPhysicalResourceBlocks-1)
OPTIONAL, -- Need M
resourceAllocation ENUMERATED { resourceAllocationType0,
resourceAllocationType1, dynamicSwitch},
pusch-TimeDomainAllocationList SetupRelease { PUSCH-
TimeDomainResourceAllocationList } OPTIONAL, -- Need M
pusch-AggregationFactor ENUMERATED { n2, n4, n8 }
OPTIONAL, -- Need S
mcs-Table ENUMERATED {qam256, qam64LowSE}
OPTIONAL, -- Need S
mcs-TableTransformPrecoder ENUMERATED {qam256,
qam64LowSE}
OPTIONAL, -- Need S
transformPrecoder ENUMERATED {enabled, disabled}
OPTIONAL, -- Need S
codebookSubset ENUMERATED
{fullyAndPartialAndNonCoherent, partialAndNonCoherent,nonCoherent}
OPTIONAL, -- Cond codebookBased
maxRank INTEGER (1..4) OPTIONAL, --
Cond codebookBased
rbg-Size ENUMERATED { config2}
OPTIONAL, -- Need S
uci-OnPUSCH SetupRelease { UCI-OnPUSCH}
OPTIONAL, -- Need M
tp-pi2BPSK ENUMERATED {enabled}
OPTIONAL, -- Need S
...
}

Next, a description will be given of codebook-based PUSCH transmission. Codebook-based PUSCH transmission may be dynamically scheduled through DCI format 0_0 or 0_1, and be operated semi-statically according to a configured grant. When codebook-based PUSCH is dynamically scheduled by DCI format 0_1 or semi-statically configured by a configured grant, the UE determines a precoder for PUSCH transmission based on an SRS resource indicator (SRI), a transmission precoding matrix indicator (TPMI), and a transmission rank (number of PUSCH transmission layers).

In this case, the SRI may be given through a “SRS resource indicator” field in DCI or may be configured through srs-ResourceIndicator being higher signaling. For codebook-based PUSCH transmission, the UE may be configured with at least one SRS resource and up to two SRS resources. When the UE is provided with an SRI through DCI, the SRS resource indicated by the corresponding SRI means an SRS resource corresponding to the SRI among SRS resources transmitted before the PDCCH including the corresponding SRI. Further, the TPMI and transmission rank may be given through “precoding information and number of layers” field in DCI or may be configured through precodingAndNumberOfLayers being higher signaling. The TPMI is used for indicating a precoder to be applied to PUSCH transmission. When the UE is configured with one SRS resource, the TPMI is used for indicating a precoder to be applied in the configured one SRS resource. When the UE is configured with plural SRS resources, the TPMI is used for indicating a precoder to be applied in the SRS resource indicated by the SRI.

The precoder to be used for PUSCH transmission is selected from an uplink codebook having the same number of antenna ports as an nrofSRS-Ports value in SRS-Config, which is higher signaling. In codebook-based PUSCH transmission, the UE determines a codebook subset based on the TPMI and codebookSubset in pusch-Config being higher signaling. codebookSubset in pusch-Config being higher signaling may be set to one of ‘fullyAndPartialAndNonCoherent’, ‘partialAndNonCoherent’, or ‘nonCoherent’ based on the UE capability reported by the UE to the base station. When the UE has reported ‘partialAndNonCoherent’ for the UE capability, the UE does not expect that the value of codebookSubset, which is higher signaling, is set to ‘fullyAndPartialAndNonCoherent’. Further, when the UE has reported ‘nonCoherent’ for the UE capability, the UE does not expect that the value of codebookSubset, which is higher signaling, is set to ‘fullyAndPartialAndNonCoherent’ or ‘partialAndNonCoherent’. When nrofSRS-Ports in SRS-ResourceSet, which is higher signaling, indicates two SRS antenna ports, the UE does not expect that the value of codebookSubset, which is higher signaling, is set to ‘partialAndNonCoherent’.

The UE may be configured with one SRS resource set in which a value of usage in SRS-ResourceSet being higher signaling is set to ‘codebook’, and one SRS resource in the corresponding SRS resource set may be indicated through the SRI. When several SRS resources are configured in the SRS resource set in which a value of usage in SRS-ResourceSet, which is higher signaling, is set to ‘codebook’, the UE expects that the value of nrofSRS-Ports in SRS-Resource, which is higher signaling, is set to the same value for all SRS resources.

The UE transmits, to the base station, one or plural SRS resources included in an SRS resource set in which a value of usage is set to ‘codebook’ according to higher signaling, and the base station selects one of SRS resources transmitted by the UE and instructs the UE to perform PUSCH transmission by using transmission beam information of the corresponding SRS resource. Here, in codebook-based PUSCH transmission, the SRI is used as information for selecting an index of one SRS resource and is included in the DCI. Additionally, the base station includes information indicating the TPMI and rank to be used by the UE for PUSCH transmission in the DCI. The UE uses the SRS resource indicated by the SRI and performs PUSCH transmission by applying the rank indicated based on the transmission beam of the SRS resource and the precoder indicated by the TPMI.

Next, a description will be given of non-codebook-based PUSCH transmission. Non-codebook-based PUSCH transmission may be dynamically scheduled through DCI format 0_0 or 0_1, and be operated semi-statically according to a configured grant. When at least one SRS resource is configured in the SRS resource set in which a value of usage in SRS-ResourceSet, which is higher signaling, is set to ‘nonCodebook’, the UE can be scheduled with non-codebook based PUSCH transmission through DCI format 0_1.

For the SRS resource set in which a value of usage in SRS-ResourceSet, which is higher signaling, is set to ‘nonCodebook’, the UE may be configured with one connected non-zero power CSI-RS (NZP CSI-RS) resource. The UE may perform calculation on a precoder for SRS transmission by measuring the NZP CSI-RS resource connected to the SRS resource set. When the difference between a last reception symbol of an aperiodic NZP CSI-RS resource connected to the SRS resource set and a first symbol of aperiodic SRS transmission at the UE is less than 42 symbols, the UE does not expect that information on the precoder for SRS transmission is updated.

When the value of resourceType in SRS-ResourceSet, which is higher signaling, is set to ‘aperiodic’, the connected NZP CSI-RS is indicated by a SRS request, which is a field in DCI format 0_1 or 1_1. Here, when the connected NZP CSI-RS resource is an aperiodic NZP CSI-RS resource, it indicates that there is a connected NZP CSI-RS for a case where the value of the “SRS request” field in DCI format 0_1 or 1_1 is not ‘00’. In this case, the corresponding DCI should not indicate cross carrier or cross BWP scheduling. Further, when the value of the SRS request indicates presence of an NZP CSI-RS, the corresponding NZP CSI-RS is positioned in a slot in which the PDCCH including the SRS request field is transmitted. In this case, TCI states configured in the scheduled subcarrier are not set to QCL-TypeD.

When a periodic or semi-persistent SRS resource set is configured, the connected NZP CSI-RS may be indicated through associatedCSI-RS in SRS-ResourceSet, which is higher signaling. For non-codebook-based transmission, the UE does not expect that spatialRelationInfo, which is higher signaling for SRS resources, and associatedCSI-RS in SRS-ResourceSet, which is higher signaling, are configured together.

When plural SRS resources are configured, the UE may determine a precoder to be applied to PUSCH transmission and a transmission rank based on the SRI indicated by the base station. Here, the SRI may be indicated through a ‘SRS resource indication’ field in DCI or may be configured through srs-ResourceIndicator, which is higher signaling. As in above-described codebook-based PUSCH transmission, when the UE is provided with an SRI through DCI, the SRS resource indicated by the SRI means an SRS resource corresponding to the SRI among SRS resources transmitted before the PDCCH including the SRI. The UE may use one or plural SRS resources for SRS transmission, and the maximum number of SRS resources that may be simultaneously transmitted at the same symbol in one SRS resource set is determined based on the UE capability reported by the UE to the base station. In this case, SRS resources simultaneously transmitted by the UE occupy the same RB. The UE configures one SRS port for each SRS resource. Only one SRS resource set in which a value of usage in SRS-ResourceSet, which is higher signaling, is set to ‘nonCodebook’ may be configured, and up to four SRS resources may be configured for non-codebook-based PUSCH transmission.

The base station transmits one NZP-CSI-RS connected to the SRS resource set to the UE, and the UE calculates a precoder to be used for transmitting one or multiple SRS resources in the corresponding SRS resource set based on the measurement result at the time of receiving the corresponding NZP-CSI-RS. The UE applies the calculated precoder when transmitting one or multiple SRS resources in the SRS resource set in which usage is set to ‘nonCodebook’ to the base station, and the base station selects one or plural SRS resources among the received one or plural SRS resources. Here, in non-codebook-based PUSCH transmission, the SRI indicates an index capable of representing one or multiple combinations of SRS resources, and the SRI is included in the DCI. In this case, the number of SRS resources indicated by the SRI transmitted by the base station may be the number of transmission layers of the PUSCH, and the UE transmits the PUSCH by applying the precoder having been applied to SRS resource transmission to each layer.

### [PUSCH: Preparation Procedure Time]

Next, a description will be given of a PUSCH preparation procedure time. When the base station schedules the UE to transmit the PUSCH using DCI format 0_0 or DCI format 0_1, the UE may require a PUSCH preparation procedure time for transmitting the PUSCH by applying a transmission scheme indicated through DCI (transmission precoding scheme of SRS resource, number of transmission layers, spatial domain transmission filter). In NR, the PUSCH preparation procedure time is defined in consideration of this. The PUSCH preparation procedure time of the UE may follow Equation 2.

$$Tproc , 2 = \qquad Equation 2$$

$$max ( \text{} ( N 2 + d 2 , 1 + d 2 ) ( 2048 + 144 ) κ 2 - μ Tc + Text + Tswitch , d 2 , 2 )$$

In Tproc,2 described above, variables may have the following meanings.
N2: the number of symbols determined according to a UE processing capability 1 or 2 and numerology based on the UE capability. When reported as UE processing capability 1 according to the capability report of the UE, it has a value of Table 17, and when reported as UE processing capability 2 and configured through higher layer signaling that UE processing capability 2 may be used, it may have a value of Table 18.

TABLE 17

| | PUSCH preparation time N₂ |
|---|---|
| μ | [symbols] |
| 0 | 10 |
| 1 | 12 |
| 2 | 23 |
| 3 | 36 |

TABLE 18

| | PUSCH preparation time N₂ |
|---|---|
| μ | [symbols] |
| 0 | 5 |
| 1 | 5.5 |
| 2 | 11 for frequency range 1 |

d2,1: the number of symbols is determined to be 0 when the first OFDM symbol of PUSCH transmission is composed of DM-RS only, and 1 otherwise.
κ: 64
μ: it follows a value in which Tproc,2 becomes larger among μ_{DL} or μ_{UL}. μ_{DL} denotes numerology of downlink in which a PDCCH including DCI scheduling a PUSCH is transmitted, and M denotes numerology of uplink in which a PUSCH is transmitted.
Tc: it has “1(Δfₘₐₓ·N_{f}), where Δfₘₐₓ=480·10³ Hz, N_{f}=4096.
d2,2: when DCI scheduling the PUSCH indicates BWP switching, it follows a BWP switching time, it is set to 0 otherwise.
d2: when OFDM symbols of PUCCH, PUSCH with a high priority index, and PUCCH with a low priority index overlap in time, the d2 value of PUSCH with a high priority index is used. Otherwise d2 is 0.
Text: when the UE uses a shared spectrum channel access scheme, the UE may calculate Text and apply it to the PUSCH preparation procedure time. Otherwise, Text is assumed to be 0.
Tswitch: when the uplink switching gap is triggered, Tswitch is assumed to be the switching gap time. Otherwise, it is assumed to be 0.

When considering time domain resource mapping information of a PUSCH scheduled through DCI and the timing advance (TA) effect between uplink and downlink, the base station and the UE determine that the PUSCH preparation procedure time is not sufficient if the first symbol of the PUSCH starts earlier than the first uplink symbol at which the CP starts after Tproc,2 from the last symbol of the PDCCH including DCI having scheduled the PUSCH. If not, the base station and the UE determine that the PUSCH preparation procedure time is sufficient. Only when the PUSCH preparation procedure time is sufficient, the UE may transmit the PUSCH, and when the PUSCH preparation procedure time is not sufficient, the UE may ignore the DCI scheduling the PUSCH.

Next, a description will be given of repetitive PUSCH transmission. When the UE is scheduled with PUSCH transmission in DCI format 0_1 within the PDCCH including a CRC scrambled with C-RNTI, MCS-C-RNTI, or CS-RNTI, if the UE is configured with higher layer signaling pusch-AgreegationFactor, the same symbol allocation is applied in consecutive slots as many as pusch-AgreegationFactor, and PUSCH transmission is limited to single rank transmission. For example, the UE should repeat the same TB in consecutive slots as many as pusch-AgreegationFactor, and apply the same symbol allocation to individual slots. Table 19 represents a redundancy version (RV) applied to repetitive PUSCH transmission for each slot. When the UE is scheduled with repetitive PUSCH transmission in plural slots through DCI format 0_1 and at least one symbol of slots in which repetitive PUSCH transmission is performed according to information of tdd-UL-DL-ConfigurationCommon or tdd-UL-DL-ConfigurationDedicated being higher layer signaling is indicated as a downlink symbol, the UE does not perform PUSCH transmission in a slot in which the corresponding symbol is positioned.

TABLE 19

| rv_{id} indicated by the | rv_{id} to be applied to n^{th} transmission occasion | | | |
|---|---|---|---|---|
| DCI scheduling the | n mod | n mod | n mod | n mod |
| PUSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

### [PUSCH: Repetitive Transmission Related]

Next, a detailed description will be given of repetitive transmission of uplink data channel in a 5G system. The 5G system supports two types of uplink data channel repetitive transmission, i.e., PUSCH repetition type A and PUSCH repetition type B. The UE may be configured with either PUSCH repetition type A or B through higher layer signaling.

### PUSCH Repetition Type A

As described above, a symbol length and a start symbol of an uplink data channel may be determined within one slot in a time domain resource allocation scheme, and the base station may notify the UE of the number of repetitive transmissions via higher layer signaling (e.g., RRC signaling) or L1 signaling (e.g., DCI).

The UE may repetitively transmit, in consecutive slots, an uplink data channel having the same length and start symbol as those of the configured uplink data channel on the basis of the number of repetitive transmissions received from the base station. In this case, when at least one symbol, among symbols of a slot that is configured to the UE as downlink by the base station or an uplink data channel that is configured to the UE, is configured as downlink, the UE skips uplink data channel transmission, but counts the number of repetitive transmissions for the uplink data channel. That is, though it may be included in the number of repetitive transmissions of the uplink data channel, it may be not transmitted. On the other hand, the UE supporting Rel-17 repetitive uplink data transmission determines a slot being capable of repetitive uplink data transmission to be an available slot, and may count the number of transmissions when performing uplink data channel repetitive transmission in a slot determined to be an available slot. If uplink data channel repetitive transmission is skipped in a slot determined to be an available slot, repetitive transmission may be performed through a slot available for transmission after postponement.

In determining the available slot, if at least one symbol configured through time domain resource allocation (TDRA) for PUSCH in a slot for PUSCH transmission overlaps with a symbol for a purpose other than uplink transmission (e.g., downlink), the corresponding slot is determined to be an unavailable slot (e.g., a slot that is not an available slot and is determined to be unusable for PUSCH transmission). In addition, the available slot may be considered as an uplink resource for determining the resource for PUSCH transmission and transport block size (TBS) in multi-slot PUSCH transmission (TBoMS) composed of repetitive PUSCH transmission and one transport block (TB).

### PUSCH Repetition Type B

As described above, the length and start symbol of an uplink data channel may be determined within one slot through a time domain resource allocation scheme, and the base station may notify the UE of the number of repetitive transmissions, numberofrepetitions, via higher signaling (e.g., RRC signaling) or L1 signaling (e.g., DCI).
Based on the start symbol and length of the uplink data channel configured earlier, a nominal repetition of the uplink data channel is determined as follows. A slot in which the nth nominal repetition starts is given by

$${K}_{s} + ⌊ \frac{S + n \cdot L}{{N}_{symb}^{slot}} ⌋ ,$$

and a start symbol in the slot is given by mod(S+n·L, N_{symb}^{slot}). A slot in which the nth nominal repetition ends is given by

$${K}_{s} + ⌊ \frac{S + ( n + 1 ) \cdot L - 1}{{N}_{symb}^{slot}} ⌋ ,$$

and an end symbol in the slot is given by mod(S+(n+1)·L−1, N_{symb}^{slot}). Where, n=0, . . . , numberofrepetitions−1, S denotes a start symbol of the configured uplink data channel, and L denotes a symbol length of the configured uplink data channel. Kₛ indicates a slot in which PUSCH transmission starts, and N_{symb}^{slot} indicates the number of symbols per slot.
The UE may determine a specific OFDM symbol to be an invalid symbol for PUSCH repetition type B in the following cases.
A symbol configured as downlink by tdd-UL-DL-ConfigurationCommon or tdd-UL-DL-ConfigurationDedicated is determined to be an invalid symbol for PUSCH repetition type B.
For SSB reception in the unpaired spectrum (TDD spectrum), symbols indicated by ssb-PositionsInBurst in SIB1 or ssb-PositionsInBurst in ServingCellConfigCommon, which is upper layer signaling, may be determined to be invalid symbols for PUSCH repetition type B.
Symbols indicated through pdcch-ConfigSIB1 in the MIB to transmit the control resource set connected to the Type0-PDCCH CSS set in the unpaired spectrum (TDD spectrum) may be determined as invalid symbols for PUSCH repetition type B.
If numberOflnvalidSymbolsForDL-UL-Switching being higher layer signaling is set in the unpaired spectrum (TDD spectrum), those symbols including as many symbols as numberOflnvalidSymbolsForDL-UL-Switching from the symbol configured as downlink by tdd-UL-DL-ConfigurationCommon or tdd-UL-DL-ConfigurationDedicated may be determined to be invalid symbols.
Further, an invalid symbol may be configured by a higher layer parameter (e.g., InvalidSymbolPattern). A higher layer parameter (e.g., InvalidSymbolPattern) may provide a symbol-level bitmap spanning one or two slots to configure invalid symbols. In the bitmap, 1 represents an invalid symbol. In addition, a periodicity and pattern of the bitmap may be configured by a higher layer parameter (e.g., periodicityAndPattern). When the higher layer parameter (e.g., InvalidSymbolPattern) is set and parameter InvalidSymbolPatternlndicator-ForDCIFormat0_1 or InvalidSymbolPatternIndicator-ForDCIFormat0_2 indicates 1, the UE applies the invalid symbol pattern, and when the parameter indicates 0, the UE does not apply the invalid symbol pattern. When the higher layer parameter (e.g., InvalidSymbolPattern) is set and parameter InvalidSymbolPatternlndicator-ForDCIFormat0_1 or InvalidSymbolPatternIndicator-ForDCIFormat0_2 is not configured, the UE applies the invalid symbol pattern.

After an invalid symbol is determined in each nominal repetition, the UE may consider other remaining symbols as valid symbols. When one or more valid symbols are included in a nominal repetition, the nominal repetition may include one or more actual repetitions. Here, each actual repetition includes a set of consecutive valid symbols usable for PUSCH repetition type B within one slot. When the OFDM symbol length of a nominal repetition is not 1, if the length of an actual repetition is 1, the UE may ignore transmission for the actual repetition.

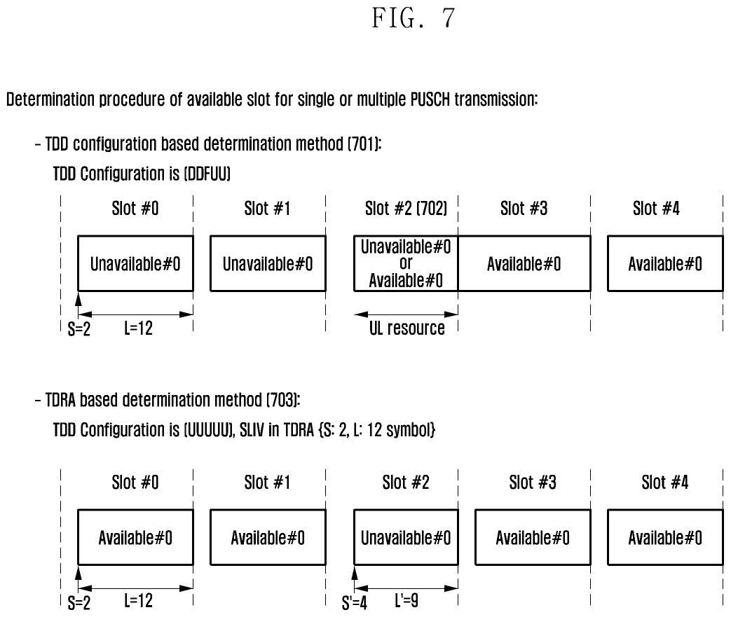

FIG. 7 is a diagram illustrating a method for determining an available slot in a 5G system according to an embodiment of the disclosure.

When the base station configures uplink resources through higher layer signaling (tdd-UL-DL-ConfigurationCommon or tdd-UL-DL-ConfigurationDedicated) or L1 signaling (dynamic slot format indicator), the base station and the UE may determine available slots for the configured uplink resources through (1) a method of determining available slots based on TDD configuration, or (2) a method of determining available slots by taking into consideration TDD configuration, time domain resource allocation (TDRA), CG configuration, or activation DCI.

As an example of a method for determining available slots based on TDD configuration, when the TDD configuration is set to ‘DDFUU’ through higher layer signaling in FIG. 7, the base station and the UE may determine slot #3 and slot #4, which are configured as uplink ‘U’, as available slots based on the TDD configuration (701). At this time, slot #2, which is configured as flexible ‘F’ based on the TDD configuration, may be determined to be an unavailable slot or an available slot and may be predefined through, for example, base station settings.

As an example of a method for determining available slots by considering TDD configuration, time domain resource allocation (TDRA), CG configuration, or activation DCI, when the TDD configuration is set to ‘UUUUU’ through higher layer signaling, and the start and length indicator value (SLIV) of PUSCH transmission is set to {S:2, L:12 symbol} through L1 signaling in FIG. 7, the base station and the UE may determine slot #0, slot #1, slot #3, and slot #4, which satisfy the SLIV of PUSCH for the configured uplink slot ‘U’, as available slots. At this time, the base station and the UE may determine slot #2 (‘L=9’<; SLIV ‘L=12’), which does not satisfy the SLIV being a TDRA condition for PUSCH transmission, as an unavailable slot (703). This is for illustration only and does not limit the scope to PUSCH transmission, and it can also be applied to PUCCH transmission, PUSCH/PUCCH repetitive transmission, nominal repetition of PUSCH repetition type B, and TBoMS.

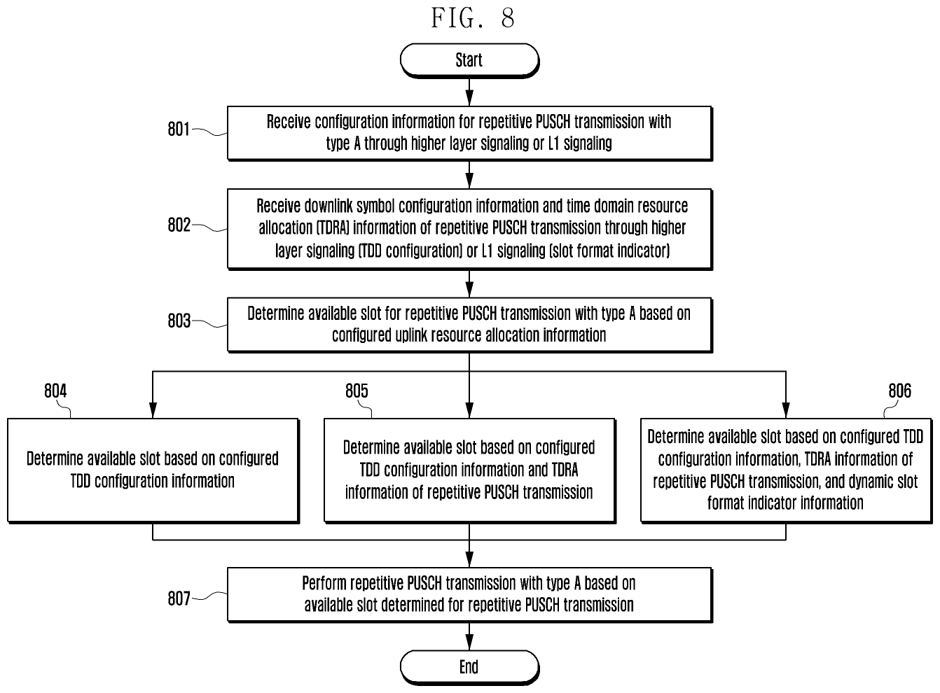

FIG. 8 is a flowchart for describing operations of a UE for PUSCH transmission with repetition type A in a 5G system according to an embodiment of the disclosure.

With reference to FIG. 8, the operation of the UE for PUSCH transmission with repetition type A is described. From the base station, the UE may receive configuration information for PUSCH repetition type A transmission through higher layer signaling or L1 signaling (801). Additionally, the UE may receive downlink symbol configuration information and time domain resource allocation (TDRA) information of PUSCH repetitive transmission through higher layer signaling (TDD configuration; tdd-UL-DL-ConfigurationCommon or tdd-UL-DL-ConfigurationDedicated) or L1 signaling (slot format indicator) (802). Thereafter, based on the uplink resource allocation information received from the base station, the UE may determine an available slot for PUSCH transmission with repetition type A (803). Here, the UE may determine the available slot by using one of the three methods 804, 805 and 806 or a combination thereof. In the first method, the UE can determine only slots configured as uplink to be an available slot based on the configured TDD configuration information (804). In the second method, the UE may determine an available slot by taking into consideration the configured TDD configuration information, TDRA information for PUSCH transmission, CG-configuration, and activation DCI (805). Finally, the UE may determine an available slot based on the configured TDD configuration information, TDRA information for PUSCH transmission, CG-configuration, activation DCI information, and dynamic slot format indicator (SFI) (806). Here, the method used to determine the available slot may be defined/promised in advance between the base station and the UE, or may be set and indicated semi-statically or dynamically through signaling between the base station and the UE. Thereafter, to the base station, the UE may perform transmission with repetition type A through the determined available slot (807).

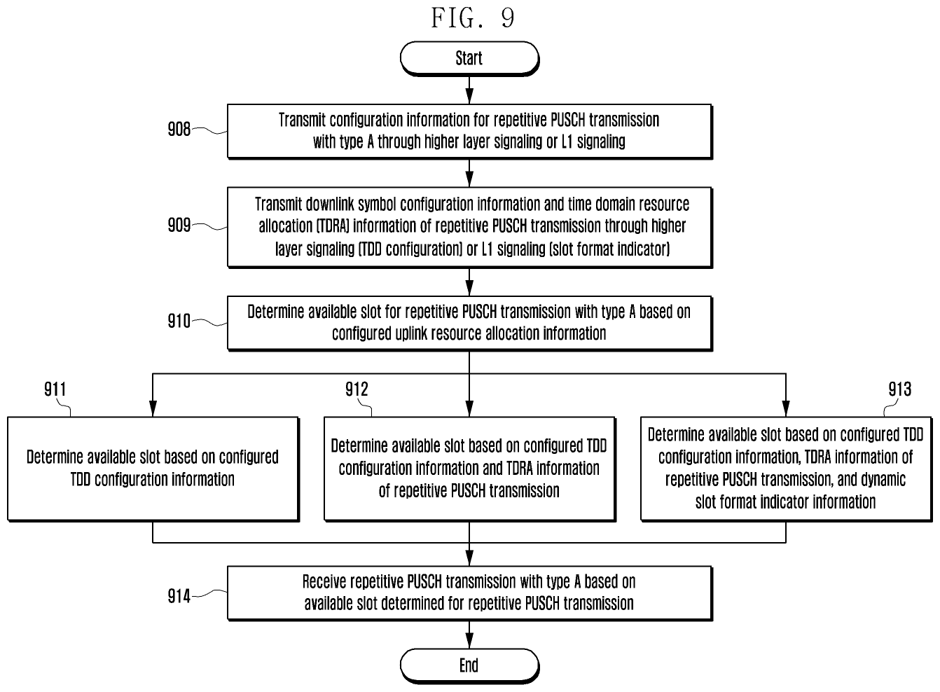

FIG. 9 is a flowchart for describing operations of a base station for PUSCH transmission with repetition type A in a 5G system according to an embodiment of the disclosure.

With reference to FIG. 9, the operation of the base station for PUSCH transmission with repetition type A is described. To the UE, the base station may transmit configuration information for PUSCH repetition type A transmission through higher layer signaling or L1 signaling (908). Additionally, the base station may configure and transmit downlink symbol configuration information and time domain resource allocation (TDRA) information of PUSCH repetitive transmission through higher layer signaling (TDD configuration; tdd-UL-DL-ConfigurationCommon or tdd-UL-DL-ConfigurationDedicated) or L1 signaling (slot format indicator) (909). Thereafter, based on the uplink resource allocation information configured to the UE, the base station may determine an available slot for PUSCH transmission with repetition type A (910). Here, the base station may determine the available slot by using one of the three methods 911, 912 and 913 or a combination thereof. In the first method, the base station may determine only slots configured as uplink to be an available slot based on the configured TDD configuration information (911). In the second method, the base station may determine an available slot by taking into consideration the configured TDD configuration information, TDRA information for PUSCH transmission, CG-configuration, and activation DCI (912). Finally, the base station may determine an available slot based on the configured TDD configuration information, TDRA information for PUSCH transmission, CG-configuration, activation DCI information, and dynamic slot format indicator (SFI) (913). Here, the method used to determine the available slot may be defined/promised in advance between the base station and the UE, or may be set and indicated semi-statically or dynamically through signaling between the base station and the UE. Thereafter, from the UE, the base station may receive transmission with repetitive type A through the determined available slot (914). This is for illustration only and does not limit the scope to PUSCH transmission, and it can also be applied to PUCCH transmission, PUSCH/PUCCH repetitive transmission, nominal repetition of PUSCH repetition type B, and TBoMS.

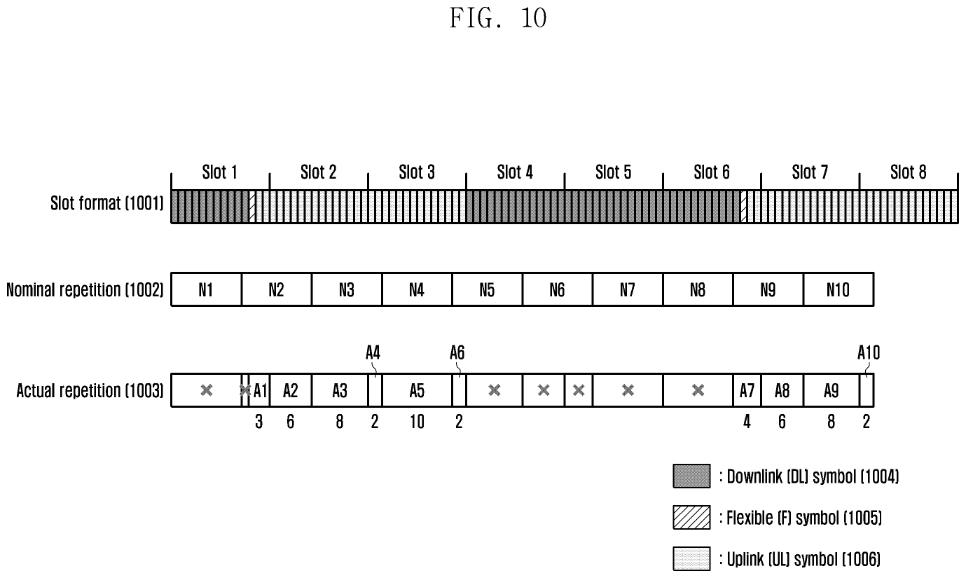

FIG. 10 shows an example of PUSCH repetition type B according to an embodiment of the present disclosure.

In FIG. 10, an example is shown where the transmission start symbol S is set to 0, the length of transmission symbols L is set to 10, and the number of repetitive transmissions is set to 10 for nominal repetitions, which may be represented by N1 to N10 in the figure (1002). At this time, the UE may determine the invalid symbol by considering the slot format (1001) to determine actual repetitions, which may be represented by A1 to A10 in the figure (1003). At this time, according to the method of determining the invalid symbol and actual repetition described above, PUSCH repetition type B is not performed at a symbol where the slot format is determined to be downlink (DL), and if a slot boundary is present within a nominal repetition, it can be divided into two actual repetitions based on the slot boundary for transmission. For example, A1 indicating the first actual repetition may be composed of 3 OFDM symbols, and A2, which can be transmitted next, may be composed of 6 OFDM symbols.

Further, with respect to repetitive PUSCH transmission, in NR Release 16, the following additional methods may be defined for UL grant-based PUSCH transmission and configured grant-based PUSCH transmission crossing a slot boundary.
Method 1 (mini-slot level repetition): through one UL grant, two or more PUSCH repetitive transmissions are scheduled within one slot or across the boundary of consecutive slots. Further, for method 1, time domain resource allocation information in the DCI indicates a resource of the first repetitive transmission. Further, time domain resource information of the remaining repetitive transmissions may be determined according to time domain resource information of the first repetitive transmission and an uplink or downlink direction determined for each symbol of a slot. Each repetitive transmission occupies consecutive symbols.
Method 2 (multi-segment transmission): two or more repetitive PUSCH transmissions are scheduled in consecutive slots through one UL grant. Here, one transmission is designated for each slot, and start points or repetition lengths may be different for individual transmissions. Further, in method 2, time domain resource allocation information in the DCI indicates a start point and repetition length of all repetitive transmissions. Further, in the case of performing repetitive transmission in a single slot through method 2, when several bundles of consecutive uplink symbols are present in the corresponding slot, repetitive transmission is performed for each bundle of uplink symbols. If a bundle of consecutive uplink symbols is uniquely present in the corresponding slot, repetitive PUSCH transmission is performed once according to a method of NR release 15.
Method 3: two or more repetitive PUSCH transmissions are scheduled in consecutive slots through two or more UL grants. In this case, one transmission is designated for each slot, and the nth UL grant may be received before PUSCH transmission scheduled by the n−1th UL grant ends.
Method 4: through one UL grant or one configured grant, one or several repetitive PUSCH transmissions in a single slot, or two or more repetitive PUSCH transmissions may be supported across the boundary of consecutive slots. The number of repetitions indicated by the base station to the UE is only a nominal value, and the number of repetitive PUSCH transmissions actually performed by the UE may be greater than the nominal number of repetitions. Time domain resource allocation information in the DCI or configured grant means a resource of the first repetitive transmission indicated by the base station. Time domain resource information of the remaining repetitive transmissions may be determined with reference to at least resource information of the first repetitive transmission and the uplink or downlink direction of the symbols. If time domain resource information of repetitive transmission indicated by the base station spans the slot boundary or includes an uplink/downlink switching point, the corresponding repetitive transmission may be divided into a plurality of repetitive transmissions. In this case, one repetitive transmission may be included for each uplink period in one slot.

When being based on a legacy TPC command-based power control method, if the UE receives scheduling of repetitive transmission of uplink data channel/control channel/reference signal from the base station, the same TPC command value may be applied between repetitive transmissions. However, when repeatedly transmitting uplink data channel/control channel/reference signal, the further away from the scheduling point, the more there may be a need for the base station to additionally notify the UE of a power control command with respect to the initially indicated power control command value, owing to changes in the distance between the base station and the UE due to movement of the UE, channel changes, changes in the scheduling situation for other UEs. Therefore, in the disclosure, when a UE receives scheduling of repetitive transmission of uplink data channel/control channel/reference signal from the base station, a detailed description will be given of a method to define/configure/indicate a time unit that enables different TPC command values to be applied to individual repetitive transmissions by taking into consideration TPC command accumulation or absolute TPC command application operation, repetitive transmission situation related to single or multiple TRP operation, or the other.

Hereinafter, higher layer signaling may be signaling corresponding to at least one of the following signalings or a combination thereof.
MIB (master information block)
SIB (system information block) or SIB X (X=1, 2, . . . )
RRC (radio resource control)
MAC (medium access control) CE (control element)
UE capability reporting
UE assistance information message

Additionally, L1 signaling may be signaling corresponding to at least one of the following physical layer channels or signaling methods or a combination thereof.
PDCCH (physical downlink control channel)
DCI (downlink control information)
UE-specific DCI
Group common DCI
Common DCI
Scheduling DCI (e.g., DCI used for scheduling downlink or uplink data)
Non-scheduling DCI (e.g., DCI not intended for scheduling downlink or uplink data)
PUCCH (physical uplink control channel)
UCI (uplink control information)

### First Embodiment: PUSCH Power Control Method

As an embodiment of the disclosure, a description will be given of a method where when uplink data is transmitted through an uplink data channel (physical uplink shared channel, PUSCH) in response to a power control command received from the base station, the UE sets the transmit power of the uplink data channel to perform transmission. With a PUSCH power control adjustment state corresponding to ith PUSCH transmission occasion, parameter set configuration index j, and closed-loop index 1, the uplink data channel transmit power of the UE can be determined as shown in Equation 3 below, expressed in dBm units. In Equation 3 below, when the UE supports multiple carrier frequencies in multiple cells, each parameter can be set for cell c, carrier frequency f, and bandwidth part b, and may be identified by indices b, f, and c.

$${P}_{PUSCH , b , f , c} ( i , j , {q}_{d} , l ) = min \qquad Equation 3$$

$$\{ \begin{matrix}{P}_{CMAX , f , c} ( i ) , \\ {P}_{0 \_PUSCH , b , f , c} ( j ) + 10 {log}_{10} ( {2}^{μ} * {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \}$$

$$[ dBm ]$$

P_{CMAX,f,c}(i): it is the maximum transmit power available to the UE in the ith transmission occasion and is determined by the power class of the UE, parameters activated by the base station, and various parameters embedded in the UE.
P_{0_PUSCH,b,f,c}(j) P_{0_PUSCH,b,f,c}(j) is given by the sum of P_{0_NOMINAL_PUSCH,f,c}(j) and P_{0_UE_PUSCH,b,f,c}(j). P_{0_NOMINAL_PUSCH,f,c}(j) is a value set in the UE through cell-specific higher layer signaling, and P_{0_UE_PUSCH,b,f,c} (j) is a value set through UE-specific higher layer signaling. Here, when j=0, it means PUSCH for transmitting msg3; when j=1, it means configured grant PUSCH; when j={2, . . . , J−1} it means grant PUSCH.
μ: subcarrier spacing configuration value
M_{RB,b,f,c}^{PUSCH}(i): it may mean the amount of resources used in the ith PUSCH transmission occasion (e.g., the number of resource blocks (RBs) used for PUSCH transmission in the frequency domain).
α_{b,f,c} (j): it is a value for compensating for pathloss and refers to a value that may be determined through higher layer settings and SRI (SRS resource indicator) (in the case of dynamic grant PUSCH).
PL_{b,f,c}(q_{d}): it is pathloss representing the path loss between the base station and the UE, and the UE calculates pathloss from the difference between the transmit power of a reference signal (RS) resource q_{d} signaled by the base station and the UE received signal level of the reference signal. It refers to the downlink path loss estimate estimated by the UE through the reference signal with reference signal index q_{d}, and reference signal index q_{d} can be determined by the UE through a higher layer configuration and SRI (in the case of dynamic grant PUSCH or configured grant PUSCH (type 2 configured grant PUSCH) based on ConfiguredGrantConfig that does not include higher layer configuration rrc-ConfiguredUplinkGrant) or through a higher layer configuration.
Δ_{TF,b,f,c}(i): it refers to a value determined depending on the modulation coding scheme (MCS) and the format of information transmitted on the PUSCH (TF: transport format, e.g., whether UL-SCH is included or CSI is included, etc.).
f_{b,f,c}(i, l): it is a closed-loop power control adjustment value, meaning the value for closed-loop index 1 that can be determined by a higher layer configuration and SRI for PUSCH. Here, support of closed-loop power adjustment for PUSCH transmission may be classified into an accumulation method that accumulates the values indicated by TPC commands for application and an absolute method that directly applies the value indicated by a TPC command, which can be determined depending on whether higher layer parameter tpc-Accumulation is set. If higher layer parameter tpc-Accumulation is set to disabled, closed-loop power adjustment for PUSCH transmission is performed with the absolute method; if tpc-Accumulation is not set, closed-loop power adjustment for PUSCH transmission is performed with the accumulation method.

PUSCH power control adjustment state f_{b,f,c}(i, l) can be determined based on bandwidth part b, carrier frequency f, cell c, ith transmission occasion, and closed-loop index 1.
δ_{PUSCH,b,f,c}(i, l): it may be a value indicated by a TPC command field included in DCI format 0_0, 0_1, or 0_2 that schedules the ith PUSCH transmission occasion corresponding to closed-loop index 1 with bandwidth part b, carrier frequency f, and cell c, or be a value indicated by a TPC command field included in DCI format 2_2 being transmitted along with a CRC scrambled with TPC-PUSCH-RNTI.
If the UE is configured with higher layer signaling twoPUSCH-PC-AdjustmentStates, closed-loop index 1 may have a value of 0 or 1.
If the UE is not configured with higher layer signaling twoPUSCH-PC-AdjustmentStates, or is scheduled with RAR UL grant-based PUSCH transmission, closed-loop index 1 may have a value of 0.
If the UE is configured with ConfiguredGrantConfig being higher layer signaling and performs PUSCH transmission or retransmission for this, closed loop index 1 may follow a powerControlLoopToUse value being higher layer signaling.
If the UE is configured with higher layer signaling SRI-PUSCH-PowerControl, the UE may obtain a connection relationship between the value indicated by the SRI (SRS resource indicator) field in the DCI format that schedules PUSCH transmission and closed-loop index 1 set through sri-PUSCH-ClosedLoopIndex being higher layer signaling, and determine closed-loop index 1 based on the value indicated by the SRI field in the DCI format according to the corresponding connection relationship.
If the UE is scheduled with PUSCH transmission based on a DCI format that does not include the SRI field or is not configured with SRI-PUSCH-PowerControl being higher layer signaling, the UE may regard closed-loop index 1 as 0.
If the UE is instructed to receive a TPC command value through a TPC command field included in DCI format 2_2, which is transmitted with a CRC scrambled with TPC-PUSCH-RNTI, closed-loop index 1 may be indicated through a closed-loop index field included in DCI format 2_2.
If the UE is not configured with tpc-Accumulation being higher layer signaling, that is, if TPC command accumulation operation is possible for the UE, PUSCH power control adjustment state f_{b,f,c}(i, l) for the ith PUSCH transmission occasion corresponding to closed-loop index 1 with bandwidth part b, carrier frequency f, and cell c may be calculated as in Equation 4.

$${f}_{b , f , c} ( i , l ) = {f}_{b , f , c} ( i - {i}_{0} , l ) + {\sum }_{m = 0}^{c ( {D}_{i} ) - 1} {δ}_{PUSCH , b , f , c} ( m , l ) \qquad Equation 4$$

δ_{PUSCH,b,f,c}(m, l) may be a value indicated by the TPC command field included in DCI format 0_0, 0_1, or 0_2 that schedules the mth PUSCH transmission occasion corresponding to closed-loop index 1 with bandwidth part b, carrier frequency f, and cell c, as described above, or may be a value indicated by the TPC command field included in DCI format 2_2, which is transmitted along a CRC scrambled with TPC-PUSCH-RNTI. If TPC command accumulation operation is possible, B_{PUSCH,b,f,c} may have a value in dB corresponding to the value indicated by the TPC command field included in DCI format 0_0, 0_1, 0_2, or 2_2 as shown in Table 20 below. For example, if the value of the TPC command field is 0, δ_{PUSCH,b,f,c} may have a value of −1 dB.

TABLE 20

| | Accumulated δ_{PUSCH,b,f,c} |
|---|---|
| TPC | or δ_{SRS,b,f,c} [dB] |
| Command | (in case that tpc-Accumulation |
| field value | is not configured) |
| 0 | −1 |
| 1 | 0 |
| 2 | 1 |
| 3 | 3 |

−Σₘ₌₀^{c(D}ᵢ)−1 δ_{PUSCH,b,f,c}(m, l) may mean the sum of above-mentioned TPC command value δ_{PUSCH,b,f,c} for all transmission occasions belonging to a specific set Dᵢ. Here, c(Dᵢ) may indicate the number of all elements belonging to set Dᵢ. Dᵢ may refer to a set of DCIs including all TPC command values on which TPC command accumulation operation is to be performed for the ith PUSCH transmission occasion. To determine Dᵢ, a start point and an end point may be defined on the time dimension, and all DCIs received by the UE between the two points can be included as elements of Dᵢ.
The end point for determining Dᵢ may be a point preceding K_{PUSCH} (i) symbols before the start symbol of the ith PUSCH transmission occasion.
The start point for determining Dᵢ may be a point preceding K_{PUSCH}(i−i₀)−1 symbols before the start symbol of the i−i₀ th PUSCH transmission occasion. Here, positive integer i₀ can be determined to be the smallest value that enables the time point preceding K_{PUSCH} (i−i₀)−1 symbols before the start symbol of the i−i₀th PUSCH transmission occasion to be earlier in time than the end point for determining Dᵢ (a point preceding K_{PUSCH} (i) symbols before the start symbol of the ith PUSCH transmission occasion).
For instance, when sym(i) refers to the end point for determining Dᵢ and sym(i−i₀) refers to the time point preceding K_{PUSCH}(i−i₀) symbols before the start symbol of the i−i₀ th PUSCH transmission occasion, if sym(i)=sym(i−1)>sym(i−2)>sym(i−3) holds, i0 may be determined to be 2.
If the UE is configured with tpc-Accumulation being higher layer signaling, that is, if TPC command accumulation operation is not possible for the UE, PUSCH power control adjustment state f_{b,f,c}(i, l) for the ith PUSCH transmission occasion corresponding to closed-loop index 1 with bandwidth part b, carrier frequency f, and cell c may be calculated as in Equation 5.

$${f}_{b , f , c} ( i , l ) = {δ}_{PUSCH , b , f , c} ( i , l ) \qquad Equation 5$$

δ_{PUSCH,b,f,c}(i, l) may be a value indicated by the TPC command field included in DCI format 00, 0_1, or 0_2 that schedules the ith PUSCH transmission occasion corresponding to closed-loop index 1 with bandwidth part b, carrier frequency f, and cell c, as described above, or may be a value indicated by the TPC command field included in DCI format 2_2, which is transmitted along a CRC scrambled with TPC-PUSCH-RNTI. If TPC command accumulation operation is not possible, B_{PUSCH,b,f,c} may have a value in dB corresponding to the value indicated by the TPC command field included in DCI format 0_0, 0_1, 0_2, or 2_2 as shown in Table 21 below. For example, if the value of the TPC command field is 0, δ_{PUSCH,b,f,c} may have a value of −4 dB.

TABLE 21

| | Accumulated δ_{PUSCH,b,f,c} |
|---|---|
| TPC | or δ_{SRS,b,f,c} [dB] |
| Command | (in case that tpc-Accumulation |
| field value | is configured) |
| 0 | −4 |
| 1 | −1 |
| 2 | 1 |
| 3 | 4 |

As described above, in cases where the UE can perform TPC command accumulation operation (i.e., if tpc-Accumulation being higher layer signaling is not set), it is possible to consider various methods for determining the definition of K_{PUSCH} (i) applicable to the i^{th} PUSCH transmission occasion corresponding to closed-loop index l with bandwidth part b, carrier frequency f, and cell c; or, in cases where the UE cannot perform TPC command accumulation operation and can operate with an absolute value (i.e., if tpc-Accumulation being higher layer signaling is set), it is possible to consider various methods for determining the definition of δ_{PUSCH,b,f,c}(i, l) applicable to the i^{th} PUSCH transmission occasion corresponding to closed-loop index l with bandwidth part b, carrier frequency f, and cell c.

### [Condition 1-1]

In a case where the UE is configured with one SRS-ResourceSet in which higher layer signaling usage is set to codebook or noncodebook and the i^{th} PUSCH transmission is scheduled through DCI format, or
In a case where the UE is configured with two SRS-ResourceSets in which higher layer signaling usage is set to codebook or noncodebook, and when the i^{th} PUSCH transmission is scheduled through DCI format, a field (or SRS resource set indicator field) for dynamic switching between single TRP-based PUSCH transmission and multiple TRP-based PUSCH transmission in the corresponding DCI format indicates single TRP-based PUSCH transmission (i.e., when value ‘00’ or ‘01’ is indicated through the corresponding dynamic switching field (or, SRS resource set indicator field))
Through PDCCH reception, the UE may receive scheduling for a single PUSCH transmission occasion, scheduling for multiple repetitive PUSCH transmission occasions, or scheduling for multiple independent PUSCH transmission occasions.
Cases in which multiple PUSCH transmission occasions can be obtained through PDCCH reception may be as follows.
If the UE is configured with pusch-aggregationfactor being higher layer signaling, the UE can receive scheduling for multiple PUSCH transmission occasions with a semi-statically fixed number of repetitive transmissions.
If the UE is configured with pusch-RepTypeA or pusch-RepTypeB for pusch-RepTypeIndicatorDCI-0-1-r16 or pusch-RepTypeIndicatorDCI-0-2-r16 being higher layer signaling, and the entry indicated by a TDRA (time domain resource assignment) field in DCI format 0_1 or 0_2 corresponds to higher layer signaling PUSCH-TimeDomainResourceAllocation-r16 that includes one PUSCH-Allocation-r16, being higher layer signaling, whose numberOfRepetitions-r16 value is set to a value greater than 1, the UE may receive scheduling for multiple PUSCH transmission occasions with a number of repetitive transmissions that can be dynamically indicated.
If the entry indicated by a TDRA field present in DCI format 0_1 or 0_2 corresponds to higher layer signaling PUSCH-TimeDomainResourceAllocation-r16 that includes more than one PUSCH-Allocation-r16, being higher layer signaling, the UE may receive scheduling for multiple independent PUSCH transmission occasions corresponding to the number that can be dynamically indicated.

### [Condition 1-1-1]

In addition to above-mentioned condition 1-1, if the UE is capable of performing TPC command accumulation operation (i.e., if tpc-Accumulation being higher layer signaling is not configured), the following methods can be considered.

[Method 1-1-1-1] K_{PUSCH}(i) applicable to the i^{th} PUSCH transmission occasion may refer to a symbol length from the end point of the last symbol at which the PDCCH having scheduled the i^{th} PUSCH transmission occasion is received to the start point of the i^{th} PUSCH transmission occasion.
If the UE receives scheduling for i, i+1, . . . , i+N−1^{th} PUSCH transmission occasions through reception of one PDCCH, the end point of the last symbol of the PDCCH, which determines K_{PUSCH}(i), K_{PUSCH}(i+1), . . . , K_{PUSCH}(i+N−1) applicable respectively to i, i+1, . . . , i+N−1^{th} PUSCH transmission occasions, may always be the same. Hence, since the end points for determining Dᵢ according to the above are all the same, TPC command accumulation values applied to individual PUSCH transmission occasions scheduled by the corresponding PDCCH may all be the same. In this case, there is an advantage of simplifying the operation of the UE without a complication by applying a power control value that can be determined at the time of PDCCH scheduling to all PUSCH transmission occasions. However, it can be said to be an inflexible method in that dynamic power control through L1 signaling (e.g., DCI format 2_2) is not possible for PUSCH transmission occasions transmitted relatively later in time.

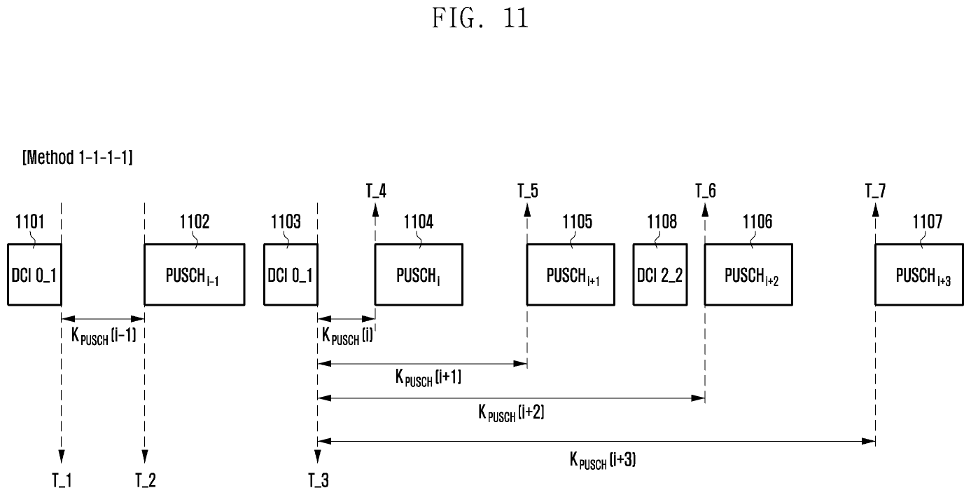

FIG. 11 is a diagram illustrating a calculation for the PUSCH power control adjustment state according to an embodiment of the disclosure.

In FIG. 11, DCI format 01 (1101) schedules one PUSCH transmission occasion PUSCHᵢ₋₁ (1102), and DCI format 01 (1103) schedules four PUSCH transmission occasions PUSCHᵢ(1104), PUSCHᵢ₊₁ (1105), PUSCHᵢ₊₂ (1106), PUSCHᵢ₊₃ (1107). For the i^{th} PUSCH transmission occasion, i₀ may be obtained to determine Dᵢ. As T_3 being a time point preceding K_{PUSCH} (i) from T_4 being a start point of the first symbol of PUSCHᵢ is later in time than T_1 being a time point preceding K_{PUSCH} (i−1) from T_2 being a start point of the first symbol of PUSCHᵢ₊₁, that is, T_1<T_3, i₀ can be 1. Hence, the TPC command value included in Dᵢ may be the value included in DCI 0_1 (1103). As described above, K_{PUSCH} (i) can be determined based on a symbol length from the end point of the last symbol at which the PDCCH having scheduled the i^{th} PUSCH transmission occasion is received to the start point of the i^{th} PUSCH transmission occasion, and thus K_{PUSCH} (i) to K_{PUSCH} (i+3) corresponding respectively to PUSCHᵢ, PUSCHᵢ₊₁, PUSCHᵢ₊₂, PUSCHᵢ₊₃ all start from T_3 being the end point of the last symbol at which the PDCCH is received. Therefore, although DCI format 2_2 (1106) is received between PUSCH transmission occasions, the TPC command value included in DCI format 2_2 (1106) cannot be used for accumulation.

For example, in method 1-1-1-1, referring to FIG. 11, since the end point for determining Dᵢ is the last symbol of the PDCCH having scheduled the corresponding PUSCH transmission occasion, the end points of PUSCHᵢ, PUSCHᵢ₊₁, PUSCHᵢ₊₂, PUSCHᵢ₊₃ scheduled by DCI format 0_1 (1103) are all the same as T_3. For the start point, i₀ of PUSCHᵢ is 1, i₀ of PUSCHᵢ₊₁ is 2, i₀ of PUSCHᵢ₊₂ is 3, and i₀ of PUSCHᵢ₊₃ is 4, and thus the start points of PUSCHᵢ, PUSCHᵢ₊₁, PUSCHᵢ₊₂, PUSCHᵢ₊₃ are also all the same as T_1+1. Therefore, the start point of Dᵢ, Dᵢ₊₁, Dᵢ₊₂, and Dᵢ₊₃ is T_1+1, and the end point is T_3. The TPC command value included in DCI format 0_1 (1103) between start point T_1+1 and end point T_3 can be used for accumulation. On the other hand, DCI format 2_2 (1106) is received before PUSCHᵢ₊₂ or PUSCHᵢ₊₃ but is not received between T_1+1 and T_3, so the TPC command value included in DCI format 2_2 (1106) cannot be used for accumulation.

[Method 1-1-1-2] K_{PUSCH}(i) applicable to the i^{th} PUSCH transmission occasion may refer to a symbol length from the end point of the last symbol at which the PDCCH having scheduled the i^{th} PUSCH transmission occasion is received to the start point of a PUSCH transmission occasion transmitted first in time among all PUSCH transmission occasions scheduled by the corresponding PDCCH.
When the UE receives scheduling for one PUSCH transmission occasion through reception of one corresponding PDCCH, method 1-1-1-2 may derive the same K_{PUSCH}(i) value as method 1-1-1-1.
When the UE receives scheduling for i, i+1, . . . , i+N−1^{th} PUSCH transmission occasions through reception of one corresponding PDCCH, K_{PUSCH} (i), K_{PUSCH}(i+1), . . . , K_{PUSCH}(i+N−1) applicable respectively to i, i+1, . . . , i+N−1^{th} PUSCH transmission occasions may have the same value as K_{PUSCH} (i) that is applicable to the i^{th} PUSCH transmission occasion transmitted first in time among all PUSCH transmission occasions scheduled by the corresponding PDCCH. Hence, since the end points for determining Dᵢ are different according to the above, the value for TPC command accumulation applied to all PUSCH transmission occasions scheduled by the corresponding PDCCH may vary for individual PUSCH transmission occasions. In this case, in addition to the power control value that can be determined at the time of PDCCH scheduling, dynamic power control through L1 signaling (e.g., DCI format 2_2) is also possible for PUSCH transmission occasions transmitted relatively later in time. Therefore, although UE operation may become relatively complicated, it can be said to be a flexible method from a power control perspective.

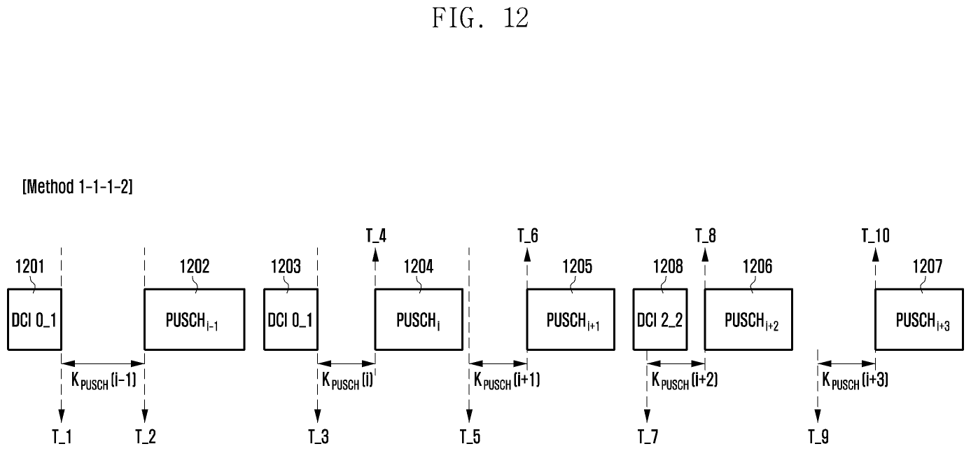

FIG. 12 is another diagram illustrating a calculation for the PUSCH power control adjustment state according to an embodiment of the disclosure.

In FIG. 12, DCI format 0_1 (1201) schedules a single PUSCH transmission occasion PUSCHᵢ₋₁ (1202), and DCI format 0_1 (1203) schedules four PUSCH transmission occasions PUSCHᵢ (1204), PUSCHᵢ₊₁ (1205), PUSCHᵢ₊₂ (1206), PUSCHᵢ₊₃ (1207). For the i^{th} PUSCH transmission occasion, i₀ may be obtained to determine Dᵢ. As T_3 being a time point preceding K_{PUSCH}(i) from T_4 being a start point of the first symbol of PUSCHᵢ is later in time than T_1 being a time point preceding K_{PUSCH} (i−1) from T_2 being a start point of the first symbol of PUSCHᵢ₊₁, that is, T_1<T_3, i₀ can be 1. Hence, the TPC command value included in Dᵢ may be the value included in DCI 0_1 (1203). As described above, K_{PUSCH}(i) may be determined based on a symbol length from the end point of the last symbol at which the PDCCH having scheduled the i^{th} PUSCH transmission occasion is received to the start point of a PUSCH transmission occasion transmitted first in time among all PUSCH transmission occasions scheduled by the corresponding PDCCH, and thus K_{PUSCH} (i) to K_{PUSCH} (i+3) corresponding respectively to PUSCHᵢ, PUSCHᵢ+1, PUSCHᵢ₊₂, PUSCHᵢ₊₃ may all have the same value as K_{PUSCH}(i). Hence, when i₀ is calculated to determine Dᵢ₊₁ for the i+1^{th} PUSCH transmission occasion, since T_3<T_5, i₀ can be 1, and there is no TPC command value included in Dᵢ₊₁; when i₀ is calculated to determine Dᵢ₊₂ for the i+2^{th} PUSCH transmission occasion, since T_5<T_7, i₀ can be 1, and the TPC command value included in Dᵢ₊₂ may be possible for DCI format 2_2 (1208) received between PUSCHᵢ₊₁ and PUSCHᵢ₊₂; and when i₀ is calculated to determine Dᵢ₊₃ for the i+3^{th} PUSCH transmission occasion, since T_7<T_9, i₀ can be 1, and the TPC command value included in Dᵢ₊₃ may be possible for DCI format 2_2 (1208) received between PUSCHᵢ₊₁ and PUSCHᵢ₊₂.

For example, in method 1-1-1-2, referring to FIG. 12, since the start point of Dᵢ is T_1+1 and the end point is T_3, the TPC command value included in Dᵢ may be included in DCI format 0_1 (1203). And, since the start point of Dᵢ₊₁ is T_3+1 and the end point is T_5, there is no TPC command value included in Dᵢ₊₁. And, since the start point of Dᵢ₊₂ is T_5+1 and the end point is T_7, the TPC command value included in Dᵢ₊₂ may be included in DCI format 2_2 (1208). Further, since the start point of Dᵢ₊₃ is T_7+1 and the end point is T_9, the TPC command value included in Dᵢ₊₃ may be included in DCI format 2_2 (1208).

[Method 1-1-1-3] K_{PUSCH}(i) applicable to the i^{th} PUSCH transmission occasion may refer to a symbol length set through higher layer signaling.
When the UE receives scheduling for one PUSCH transmission occasion through reception of one PDCCH, the UE may be configured with one symbol length through higher layer signaling.
When the UE receives scheduling for i, i+1, . . . , i+N−1^{th} PUSCH transmission occasions through reception of one corresponding PDCCH, K_{PUSCH}(i), K_{PUSCH}(i+1), . . . , K_{PUSCH}(i+N−1) applicable respectively to i, i+1, . . . , i+N−1^{th} PUSCH transmission occasions may all have the same value based on one higher layer signaling value, or may have separate values based on N different higher layer signalings. Hence, since the end points for determining Dᵢ are different according to the above, the value for TPC command accumulation applied to all PUSCH transmission occasions scheduled by the corresponding PDCCH may vary for individual PUSCH transmission occasions. Additionally, if method 1-1-1-2 is used, since the symbol interval from a specific PDCCH to the first scheduled PUSCH transmission occasion may be not always the same as the symbol interval from another PDCCH to the first scheduled PUSCH transmission occasion, K_{PUSCH}(i) to be considered from a specific PUSCH transmission occasion may vary depending on different PDCCH scheduling. On the other hand, if the corresponding value is set through higher layer signaling as in method 1-1-1-3, there may be an advantage in that the UE operation can be controlled relatively simply and consistently.
Cases where there is one higher layer signaling described above
For example, the corresponding signaling may have a value in units of symbols as independent higher layer signaling for TPC command accumulation, and this may be defined to be K_{PUSCH,min}.
As another example, the corresponding signaling may be the number of symbols obtained by multiplying the smallest value of scheduling slot offset k2 or k2-16, which is higher layer signaling set in every TDRA entry, by 14, and this may be defined to be K_{PUSCH,min}.
As another example, the corresponding signaling may be the number of symbols obtained by multiplying the smallest value of scheduling slot offset k2 set in PUSCH-ConfigCommon, which is higher layer signaling, by 14, and this may be defined to be K_{PUSCH,min}.
Cases where there are multiple higher layer signalings described above
For example, the corresponding signaling may be plural independent higher layer signalings for TPC command accumulation having a value in units of symbols, and if the number of repetitive transmissions is N, these may be defined respectively as K_{PUSCH,min,1}, K_{PUSCH,min,N}.
As another example, the corresponding signaling may be the number of symbols obtained by considering k2's or k2-16's as many as the number of PUSCH transmission occasions scheduled by the corresponding PDCCH from the smallest value among all scheduling slot offsets k2 or k2-16, which are higher layer signaling set in all TDRA entries, and multiplying this by 14, and if the number of repetitive transmissions is N, these may be defined respectively as K_{PUSCH,min,1}, . . . , K_{PUSCH,min,N}.
As another example, the corresponding signaling may be the number of symbols obtained by considering k2's as many as the number of PUSCH transmission occasions scheduled by the corresponding PDCCH from the smallest value among all scheduling slot offsets k2 set in PUSCH-ConfigCommon, which is higher layer signaling, and multiplying this by 14, and if the number of repetitive transmissions is N, these may be defined respectively as K_{PUSCH,min,1}, . . . , K_{PUSCH,min,N}.

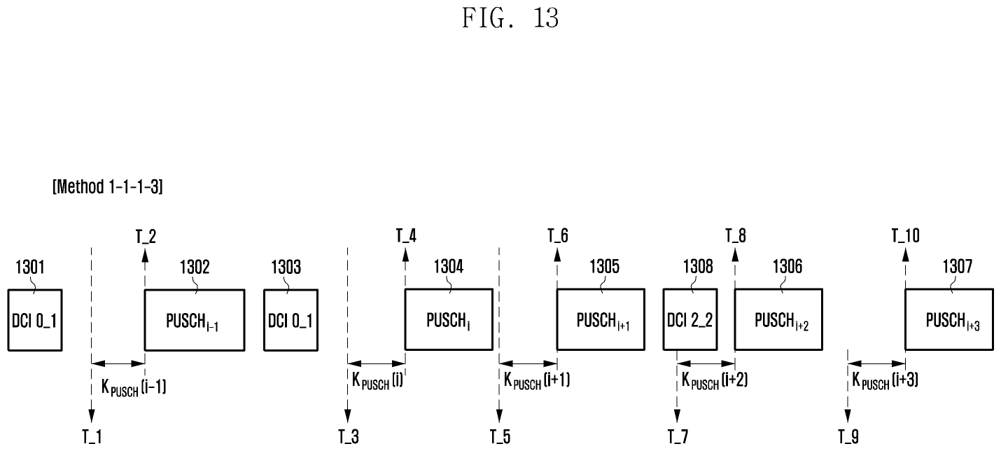

FIG. 13 is another diagram illustrating a calculation for the PUSCH power control adjustment state according to an embodiment of the disclosure.

In FIG. 13, DCI format 0_1 (1301) schedules a single PUSCH transmission occasion PUSCHᵢ₋₁ (1302), and DCI format 0_1 (1303) schedules four PUSCH transmission occasions PUSCHᵢ (1304), PUSCHᵢ₊₁ (1305), PUSCHᵢ₊₂ (1306), PUSCHᵢ₊₃ (1307). For the i^{th} PUSCH transmission occasion, i₀ may be obtained to determine Dᵢ. As T_3 being a time point preceding K_{PUSCH}(i) from T_4 being a start point of the first symbol of PUSCHᵢ is later in time than T_1 being a time point preceding K_{PUSCH} (i−1) from T_2 being a start point of the first symbol of PUSCHᵢ₊₁, that is, T_1<T_3, i₀ can be 1. Hence, the TPC command value included in Dᵢ may be the value included in DCI 0_1 (1303). As described above, K_{PUSCH}(i) can be determined through higher layer signaling, and in this drawing, it is assumed that one higher layer signaling is set and the corresponding value is applied equally to all PUSCH transmission occasions. That is, K_{PUSCH}(i) to K_{PUSCH}(i+3) corresponding respectively to PUSCHᵢ, PUSCHᵢ₊₁, PUSCHᵢ₊₂, PUSCHᵢ₊₃ may all have the same value as K_{PUSCH}(i), which is the number of symbols set by higher layer signaling. Hence, when i₀ is calculated to determine Dᵢ₊₁ for the i+1^{th} PUSCH transmission occasion, since T_3<T_5, i₀ can be 1, and there is no TPC command value included in Dᵢ₊₁; when i₀ is calculated to determine Dᵢ₊₂ for the i+2^{th} PUSCH transmission occasion, since T_5<T_7, i₀ can be 1, and the TPC command value included in Dᵢ₊₂ may be possible for DCI format 2_2 (1308) received between PUSCHᵢ₊₁ and PUSCHᵢ₊₂; and when i₀ is calculated to determine Dᵢ₊₃ for the i+3^{th} PUSCH transmission occasion, since T_7<T_9, i₀ can be 1, and the TPC command value included in Dᵢ₊₃ may be possible for DCI format 2_2 (1308) received between PUSCHᵢ₊₁ and PUSCHᵢ₊₂.

[Method 1-1-1-4] K_{PUSCH}(i) applicable to the i^{th} PUSCH transmission occasion may, if the i^{th} PUSCH transmission occasion is the first PUSCH transmission occasion scheduled by a PDCCH, refer to a symbol length from the end point of the last symbol at which the PDCCH is received to the start point of the i^{th} PUSCH transmission occasion, and may, if the i^{th} PUSCH transmission occasion is not the first PUSCH transmission occasion scheduled by the PDCCH, refer to a symbol length from the end point of the last symbol at which the i-th PUSCH transmission occasion is transmitted to the start point of the i^{th} PUSCH transmission occasion.
When the UE receives scheduling for one PUSCH transmission occasion through reception of one corresponding PDCCH, method 1-1-1-4 may derive the same K_{PUSCH}(i) value as method 1-1-1-1.
When the UE receives scheduling for i, i+1, . . . , i+N−1^{th} PUSCH transmission occasions through reception of one corresponding PDCCH, K_{PUSCH} (i) applicable to the i^{th} PUSCH transmission occasion may be calculated by using time points of the PDCCH having scheduled it and the i^{th} PUSCH transmission occasion, and when determining K_{PUSCH} (i+1), . . . , K_{PUSCH} (i+N−1) applicable to i+1, . . . , i+N−1 th PUSCH transmission occasions, each of i, . . . , i+N−2^{th} PUSCH transmission occasions may be treated similarly to the PDCCH used previously to calculate K_{PUSCH} (i) for the i^{th} PUSCH transmission occasion.

[Method 1-1-1-5] K_{PUSCH}(i) applicable to the i^{th} PUSCH transmission occasion may, if the i^{th} PUSCH transmission occasion is the first PUSCH transmission occasion scheduled by a PDCCH, refer to a symbol length from the end point of the last symbol at which the PDCCH is received to the start point of the i^{th} PUSCH transmission occasion, and may, if the i^{th} PUSCH transmission occasion is not the first PUSCH transmission occasion scheduled by the PDCCH, refer to a symbol length from the end point of the nearest downlink symbol or the nearest flexible symbol present before the i^{th} PUSCH transmission occasion to the start point of the i^{th} PUSCH transmission occasion.
When the UE receives scheduling for one PUSCH transmission occasion through reception of one corresponding PDCCH, method 1-1-1-5 may derive the same K_{PUSCH}(i) value as method 1-1-1-1.

[Method 1-1-1-6] The UE may define K_{PUSCH}(i) applicable to the i^{th} PUSCH transmission occasion through a combination of methods 1-1-1-1 to 1-1-1-5 described above. For instance, when the UE receives scheduling for N repetitive i, i+1, . . . i+N−1^{th} PUSCH transmission occasions through a PDCCH, it may utilize method 1-1-1-1 to define K_{PUSCH}(i) for the i^{th} PUSCH transmission occasion being the first one among them and utilize method 1-1-1-2 as to K_{PUSCH}(i+1), . . . , K_{PUSCH}(i+N−1) for remaining i+1, ⋅ ⋅ ⋅, i+N−1^{th} transmission occasions.

[Method 1-1-1-7] The UE may configure one of above-described methods 1-1-1-1 to 1-1-1-6 through higher layer signaling from the base station as a method for defining K_{PUSCH}(i). For example, the UE may receive a setting called tpcAccumulationTimeDetermination, which is higher layer signaling, from the base station, and the corresponding higher layer signaling may be set to one of scheme1 to scheme6, where scheme1 to scheme6 may refer respectively to methods 1-1-1-1 to 1-1-1-6 described above.

[Method 1-1-1-8] The UE may receive higher layer signaling indicating whether to use a method for defining K_{PUSCH}(i) (e.g. enableTPCAccumulationTimeDetermination) from the base station. Then, if the corresponding higher layer signaling is not set, this may indicate defining K_{PUSCH}(i) by using one of methods 1-1-1-1 to 1-1-1-6 described above (e.g. method 1-1-1-1); if the corresponding higher layer signaling is set (e.g., if the UE receives a setting value of ‘on’), this may indicate that a specific method for defining K_{PUSCH}(i) can be used. Here, the specific method for defining K_{PUSCH}(i) may be one of methods 1-1-1-1 to 1-1-1-6 described above (e.g., method 1-1-1-6) excluding the method used when the corresponding higher layer signaling is not set.

### [Condition 1-1-2]

In addition to condition 1-1 described above, when the UE cannot perform TPC command accumulation operation and operates through an absolute value (i.e., when tpc-Accumulation being higher layer signaling is configured)

[Method 1-1-2-1] δ_{PUSCH,b,f,c}(i, l) may be a TPC command field value included in the PDCCH that has scheduled the i^{th} PUSCH transmission occasion corresponding to closed-loop index l with bandwidth part b, carrier frequency f, and cell c.
In this method, when the UE receives scheduling for one PUSCH transmission occasion through reception of one PDCCH, or when the UE receives scheduling for plural PUSCH transmission occasions through reception of one PDCCH, the same absolute TPC command value can be applied to all PUSCH transmission occasions.
In this method, when the UE receives scheduling for plural PUSCH transmission occasions through reception of one corresponding PDCCH, since δ_{PUSCH,b,f,c}(i, l) follows only a TPC command field value included in the scheduling PDCCH, the value of a TPC command field included in DCI format 2_2, which is transmitted along a CRC scrambled with TPC-PUSCH-RNTI between two PUSCH transmission occasions, may be not applied.

[Method 1-1-2-2] δ_{PUSCH,b,f,c}(i, l) may be the most recently received TPC command value before transmission of the i^{th} PUSCH transmission occasion corresponding to closed-loop index l with bandwidth part b, carrier frequency f and cell c.
In this method, when the UE receives scheduling for one PUSCH transmission occasion through reception of one corresponding PDCCH, when the UE receives scheduling for multiple PUSCH transmission occasions through reception of one corresponding PDCCH, or when for every PUSCH transmission occasion, there is no DCI format 2_2, which is transmitted along a CRC scrambled with TPC-PUSCH-RNTI, transmitted more recently than the scheduling PDCCH, the absolute TPC command value included in the scheduling PDCCH may be applied equally to all PUSCH transmission occasions.
In this method, when the UE receives scheduling for multiple PUSCH transmission occasions through reception of one corresponding PDCCH, if DCI format 2_2 transmitted along a CRC scrambled with TPC-PUSCH-RNTI is received between transmissions of i^{th} and i+1^{th} PUSCH transmission occasions, and the most recently received TPC command value from the i^{th} PUSCH transmission occasion is the value indicated by the TPC command field included in the scheduling PDCCH, the absolute TPC command value applied to the i^{th} PUSCH transmission occasion may follow the value indicated by the scheduling PDCCH, and for the i+1^{th} PUSCH transmission occasion, it may follow the absolute TPC command value included in DCI format 2_2.

[Method 1-1-2-3] δ_{PUSCH,b,f,c}(i, l) may be the most recently received TPC command value from a time point preceding K_{PUSCH}(i) symbols before transmission of the i^{th} PUSCH transmission occasion corresponding to closed-loop index/with bandwidth part b, carrier frequency f, and cell c.
To define K_{PUSCH}(i), one of methods 1-1-1-1 to 1-1-1-8 described above can be applied.

### [Condition 1-2]

In a case where the UE is configured with two SRS-ResourceSets in which higher layer signaling usage is set to codebook or noncodebook, and the i^{th} PUSCH transmission is scheduled through DCI format
In a case where a field (or SRS resource set indicator field) for dynamic switching between single TRP-based PUSCH transmission and multiple TRP-based PUSCH transmission in the corresponding DCI format indicates multiple TRP-based PUSCH transmission (i.e., when value ‘10’ or ‘11’ is indicated through the corresponding dynamic switching field (or, SRS resource set indicator field))
The UE may receive scheduling for multiple repetitive PUSCH transmission occasions through PDCCH reception.
If the UE is configured with pusch-RepTypeA or pusch-RepTypeB for pusch-RepTypeIndicatorDCI-0-1-r16 or pusch-RepTypeIndicatorDCI-0-2-r16 being higher layer signaling, and the entry indicated by a TDRA field in DCI format 0_1 or 0_2 corresponds to higher layer signaling PUSCH-TimeDomainResourceAllocation-r16 that includes one PUSCH-Allocation-r16, being higher layer signaling, whose numberOfRepetitions-r16 value is set to a value greater than 1, the UE may receive scheduling for multiple PUSCH transmission occasions with a number of repetitive transmissions that can be dynamically indicated.
As a method for applying different transmission beams or spatial relation info to multiple repetitive PUSCH transmission occasions, the UE may be configured with cyclic mapping or sequential mapping through higher layer signaling.
If ‘10’ is indicated by the dynamic switching field (or SRS resource set indicator field), the first PUSCH transmission occasion can be connected to the first SRS resource set, and the remaining PUSCH transmission occasions can be handled according to the scheme of applying the transmission beam or spatial relation info. For example, in the case of cyclic mapping, odd-numbered (first, third, . . . ) PUSCH transmission occasions may be connected to the first SRS resource set, and even-numbered (second, fourth, . . . ) PUSCH transmission occasions may be connected to the second SRS resource set.
If ‘11’ is indicated by the dynamic switching field (or SRS resource set indicator field), the first PUSCH transmission occasion can be connected to the second SRS resource set, and the remaining PUSCH transmission occasions can be handled according to the scheme of applying the transmission beam or spatial relation info. For example, in the case of cyclic mapping, odd-numbered (first, third, . . . ) PUSCH transmission occasions may be connected to the second SRS resource set, and even-numbered (second, fourth, . . . ) PUSCH transmission occasions may be connected to the first SRS resource set.

### [Condition 1-2-1]

In addition to above-mentioned condition 1-2, in a case where the UE is capable of performing TPC command accumulation operation (i.e., if tpc-Accumulation being higher layer signaling is not configured)

[Method 1-2-1-1] K_{PUSCH}(i) applicable to the i^{th} PUSCH transmission occasion may refer to a symbol length from the end point of the last symbol at which the PDCCH having scheduled the i^{th} PUSCH transmission occasion is received to the start point of the i^{th} PUSCH transmission occasion.
If the UE receives scheduling for i, i+1, . . . , i+N−1^{th} PUSCH transmission occasions through reception of one corresponding PDCCH, the end point of the last symbol of the PDCCH, which determines K_{PUSCH} (i), K_{PUSCH}(i+1), K_{PUSCH} (i+N−1) applicable respectively to i, i+1, . . . , i+N−1^{th} PUSCH transmission occasions, may always be the same. Hence, since the end points for determining Dᵢ according to the above are all the same, TPC command accumulation values applied to individual PUSCH transmission occasions scheduled by the corresponding PDCCH may all be the same. In this case, there is an advantage of simplifying the operation of the UE without a complication by applying the power control value that can be determined at the time of PDCCH scheduling to all PUSCH transmission occasions corresponding to specific closed-loop index l through two TPC command field values corresponding to individual closed-loop indexes l (e.g., 0 or 1) present in the PDCCH that schedules multiple TRP-based PUSCH transmissions. However, it can be said to be an inflexible method in that dynamic power control through L1 signaling (e.g., DCI format 2_2) is not possible for PUSCH transmission occasions transmitted relatively later in time.

[Method 1-2-1-2] K_{PUSCH}(i) applicable to the i^{th} PUSCH transmission occasion may refer to a symbol length from the end point of the last symbol at which the PDCCH having scheduled the i^{th} PUSCH transmission occasion is received to the start point of a PUSCH transmission occasion that is transmitted first among all PUSCH transmission occasions to which the transmission beam or spatial relation info applied to the i^{th} PUSCH transmission occasion is equally applied.
If the UE receives scheduling for i, i+1, . . . , i+N−1^{th} PUSCH transmission occasions through reception of one corresponding PDCCH, and cyclic mapping is configured as a scheme of applying transmission beam or spatial relation info through higher layer signaling, values applicable to odd-numbered (i, i+2, i+4, . . . ) transmission occasions may all be the same as the K_{PUSCH}(i) value. In this case, if different closed-loop index l (e.g., 0 or 1) is used for TRPs, K_{PUSCH}(i) and K_{PUSCH}(i+1) can be used for each closed-loop index. However, since the value of K_{PUSCH}(i+1) becomes relatively larger compared to the value of K_{PUSCH} (i) corresponding to the transmission beam or spatial relation info that is applied early in time among the plural repetitive PUSCH transmission occasions scheduled by the PDCCH, there may be a disadvantage in that flexible power control may become impossible for PUSCH transmission occasions corresponding to the transmission beam or spatial relation info that is applied later in time.

[Method 1-2-1-3] K_{PUSCH}(i) applicable to the i^{th} PUSCH transmission occasion may refer to a symbol length from the end point of the last symbol at which the PDCCH having scheduled the i^{th} PUSCH transmission occasion is received to the start point of a PUSCH transmission occasion transmitted first among all PUSCH transmission occasions scheduled by the corresponding PDCCH.
When the UE receives scheduling for i, i+1, . . . , i+N−1^{th} PUSCH transmission occasions through reception of one corresponding PDCCH, K_{PUSCH}(i), K_{PUSCH}(i+1), . . . , K_{PUSCH}(i+N−1) applicable respectively to i, i+1, . . . , i+N−1^{th} PUSCH transmission occasions may have the same value as K_{PUSCH}(i) that is applicable to the i^{th} PUSCH transmission occasion transmitted first in time among all PUSCH transmission occasions scheduled by the corresponding PDCCH. Hence, since the end points for determining Dᵢ are different according to the above, the value for TPC command accumulation applied to all PUSCH transmission occasions scheduled by the corresponding PDCCH may vary for individual PUSCH transmission occasions. In this case, in addition to the power control value that can be determined at the time of PDCCH scheduling, dynamic power control through L1 signaling (e.g., DCI format 2_2) is also possible for PUSCH transmission occasions transmitted relatively later in time. Therefore, although UE operation may become relatively complicated, it can be said to be a flexible method from a power control perspective. Additionally, compared to method 1-2-1-2, since K_{PUSCH}(i) values corresponding to different transmission beams or spatial relation info are all the same, the flexibility of the power control applied to each transmission beam can be similarly achieved.

[Method 1-2-1-4] K_{PUSCH}(i) applicable to the i^{th} PUSCH transmission occasion may refer to a symbol length set through higher layer signaling.
When the UE receives scheduling for i, i+1, . . . , i+N−1^{th} PUSCH transmission occasions through reception of one corresponding PDCCH, K_{PUSCH}(i) K_{PUSCH}(i+1), . . . , K_{PUSCH}(i+N−1) applicable respectively to i, i+1, . . . , i+N−1^{th} PUSCH transmission occasions may all have the same value based on one higher layer signaling value, or may have separate values based on different higher layer signalings according to the number of different transmission beams or spatial relation info. Hence, since the end points for determining Dᵢ are different according to the above, the value for TPC command accumulation applied to all PUSCH transmission occasions scheduled by the corresponding PDCCH may vary for individual PUSCH transmission occasions. Additionally, if method 1-2-1-3 is used, since the symbol interval from a specific PDCCH to the first scheduled PUSCH transmission occasion may be not always the same as the symbol interval from another PDCCH to the first scheduled PUSCH transmission occasion, K_{PUSCH}(i) to be considered from a specific PUSCH transmission occasion may vary depending on different PDCCH scheduling. On the other hand, if the corresponding value is set through higher layer signaling as in method 1-2-1-3, there may be an advantage in that the UE operation can be controlled relatively simply and consistently.
Cases where there is one higher layer signaling described above
   For example, the corresponding signaling may have a value in units of symbols as independent higher layer signaling for TPC command accumulation.
   As another example, the corresponding signaling may be the number of symbols obtained by multiplying the smallest value of scheduling slot offset k2 or k2-16, which is higher layer signaling set in every TDRA entry, by 14.
   As another example, the corresponding signaling may be the number of symbols obtained by multiplying the smallest value of scheduling slot offset k2, which is higher layer signaling set in PUSCH-ConfigCommon, by 14.
   Cases where the higher layer signaling described above is the same as the number of different transmission beams or spatial relation info
   For example, the corresponding signaling may be plural independent higher layer signalings for TPC command accumulation having a value in units of symbols.
   As another example, the corresponding signaling may be the number of symbols obtained by considering two k2's or k2-16's from the smallest value among all scheduling slot offsets k2 or k2-16, which are higher layer signaling set in all TDRA entries, and multiplying this by 14.
   As another example, the corresponding signaling may be the number of symbols obtained by considering two k2's from the smallest value among all scheduling slot offsets k2 set in PUSCH-ConfigCommon, which is higher layer signaling, and multiplying this by 14.

### [Condition 1-2-2]

In addition to above-mentioned condition 1-2, in a case where the UE cannot perform TPC command accumulation operation and operates with absolute values (i.e., if tpc-Accumulation being higher layer signaling is configured)

[Method 1-2-2-1] δ_{PUSCH,b,f,c}(i, l) may be a TPC command field value included in the PDCCH that has scheduled the i^{th} PUSCH transmission occasion corresponding to closed-loop index l with bandwidth part b, carrier frequency f, and cell c.
In this method, when the UE receives scheduling for one PUSCH transmission occasion through reception of one corresponding PDCCH, or when the UE receives scheduling for plural PUSCH transmission occasions through reception of one corresponding PDCCH, the same absolute TPC command value can be applied to all PUSCH transmission occasions.
In this method, when the UE receives scheduling for plural PUSCH transmission occasions through reception of one corresponding PDCCH, since δ_{PUSCH,b,f,c}(i, l) follows only a TPC command field value included in the scheduling PDCCH, the value of a TPC command field included in DCI format 2_2, which is transmitted along a CRC scrambled with TPC-PUSCH-RNTI between two PUSCH transmission occasions, may be not applied.

[Method 1-2-2-2] δ_{PUSCH,b,f,c}(i, l) may be the most recently received TPC command value before transmission of the i^{th} PUSCH transmission occasion corresponding to closed-loop index l with bandwidth part b, carrier frequency f, and cell c.
In this method, when the UE receives scheduling for one PUSCH transmission occasion through reception of one corresponding PDCCH, when the UE receives scheduling for multiple PUSCH transmission occasions through reception of one corresponding PDCCH, or when for every PUSCH transmission occasion, there is no DCI format 2_2, which is transmitted along a CRC scrambled with TPC-PUSCH-RNTI, transmitted more recently than the scheduling PDCCH, the absolute TPC command value included in the scheduling PDCCH may be applied equally to all PUSCH transmission occasions.
In this method, when the UE receives scheduling for multiple PUSCH transmission occasions through reception of one corresponding PDCCH, if DCI format 2_2 transmitted along a CRC scrambled with TPC-PUSCH-RNTI is received between transmissions of i^{th} and i+1^{th} PUSCH transmission occasions, and the most recently received TPC command value from the i^{th} PUSCH transmission occasion is the value indicated by the TPC command field included in the scheduling PDCCH, the absolute TPC command value applied to the i^{th} PUSCH transmission occasion may follow the value indicated by the scheduling PDCCH, and for the i+1^{th} PUSCH transmission occasion, it may follow the absolute TPC command value included in DCI format 2_2.

[Method 1-2-2-3] δ_{PUSCH,b,f,c}(i, l) may be the most recently received TPC command value from a time point preceding K_{PUSCH}(i) symbols before transmission of the i^{th} PUSCH transmission occasion corresponding to closed-loop index/with bandwidth part b, carrier frequency f, and cell c.
To define K_{PUSCH}(i), one of methods 1-2-1-1 to 1-2-1-4 described above can be applied.

### Second Embodiment: PUCCH Power Control Method

As an embodiment of the disclosure, a description will be given of a method where when uplink control information is transmitted through an uplink control channel (physical uplink control channel, PUCCH) in response to a power control command received from the base station, the UE sets the transmit power of the uplink control channel to perform transmission. With a PUCCH power control adjustment state corresponding to i^{th} PUCCH transmission occasion and closed-loop index l, the uplink control channel transmit power of the UE can be determined as shown in Equation 6 below, expressed in dBm units. In Equation 6 below, when the UE supports multiple carrier frequencies in multiple cells, each parameter can be set for primary cell c, carrier frequency f, and bandwidth part b, and may be identified by indices b, f, and c.

$${P}_{PUCCH , b , f , c} ( i , {q}_{u} , {q}_{d} , l ) = min \qquad Equation 6$$

$$\{ \begin{matrix}{P}_{CMAX , f , c} ( i ) , \\ {P}_{0 \_PUCCH , b , f , c} ( {q}_{u} ) + 10 {log}_{10} ( {2}^{μ} * {M}_{RB , b , f , c}^{PUCCH} ( i ) ) + {PL}_{b , f , c} ( {q}_{d} ) + {Δ}_{F\_PUCCH} ( F ) + {Δ}_{TF , b , f , c} ( i ) {f}_{b , f , c} ( i , l )\end{matrix} \}$$

$$[ dBm$$

P_{CMAX,f,c}(i): it is the maximum transmit power available to the UE in the i^{th} transmission occasion and is determined by the power class of the UE, parameters activated by the base station, and various parameters embedded in the UE.
P_{0_PUCCH,b,f,c}(qᵤ): P_{0_PUCCH,b,f,c}(qᵤ) may be given by the sum of P_{0_NOMINAL_PUCCH} and P_{0_UE_PUCCH}(qᵤ). P_{0_NOMINAL_PUCCH} is a cell-specific value and is set through p0-nominal being cell-specific higher layer signaling, and if there is no corresponding setting, P_{0_NOMINAL_PUCCH} may be 0 dBm. P_{0_UE_PUCCH}(qᵤ) is a UE-specific value and is set through p0-PUCCH-Value in p0-PUCCH being higher layer signaling, with bandwidth part b, carrier frequency f, and primary cell c; qᵤ may be a value greater than or equal to 0 and less than Qᵤ, and Qᵤ may indicate the size of a set of P_{0_UE_PUCCH} values and may be set through maxNrofPUCCH-P0-PerSet being higher layer signaling. The set of P_{0_UE_PUCCH} values may be set through p0-Set being higher layer signaling, and if there is no corresponding setting, it can be regarded as P_{0_UE_PUCCH} (qᵤ)=0.
μ: subcarrier spacing configuration value
M_{RB,b,f,c}^{PUCCH}(i): it may mean the amount of resources used in the i^{th} PUCCH transmission occasion with bandwidth part b, carrier frequency f, and primary cell c (e.g., the number of resource blocks (RBs) used for PUCCH transmission in the frequency domain).
PL_{b,f,c}(q_{d}): it is pathloss representing the path loss between the base station and the UE, and the UE calculates pathloss from the difference between the transmit power of a reference signal (RS) resource q_{d} signaled by the base station and the UE received signal level of the reference signal.
Δ_{F_PUCCH}(F): for PUCCH format 0, if higher layer signaling deltaF-PUCCH-f0 is set, the corresponding value is used; for PUCCH format 1, if higher layer signaling deltaF-PUCCH-f1 is set, the corresponding value is used; for PUCCH format 2, if higher layer signaling deltaF-PUCCH-f2 is set, the corresponding value is used; for PUCCH format 3, if higher layer signaling deltaF-PUCCH-f3 is set, the corresponding value is used; for PUCCH format 4, if higher layer signaling deltaF-PUCCH-f4 is set, the corresponding value is used; for all PUCCH formats, if higher layer signaling is not set, 0 may be used.
Δ_{TF,b,f,c} (i): As a PUCCH transmission power adjustment factor with bandwidth part b, carrier frequency f, and primary cell c, different calculation schemes can be used depending on the PUCCH format.
g_{b,f,c}(i, l): it may indicate a PUCCH power control adjustment state value for the i^{th} PUCCH transmission occasion corresponding to closed-loop index 1 with bandwidth part b, carrier frequency f, and primary cell c. Here, closed-loop power adjustment for PUCCH transmission may use an accumulation scheme that accumulates the value indicated by a TPC command for application.

PUCCH power control adjustment state g_{b,f,c}(i, l) can be determined through bandwidth part b, carrier frequency f, primary cell c, i^{th} transmission occasion, and closed-loop index 1.
δ_{PUCCH,b,f,c}(i, l): it may be a value indicated by a TPC command field included in DCI format 10, 1_1, or 1_2 that schedules the i^{th} PUCCH transmission occasion corresponding to closed-loop index 1 and PDSCH reception with bandwidth part b, carrier frequency f, and primary cell c, or be a value indicated by a TPC command field included in DCI format 2_2 being transmitted along with a CRC scrambled with TPC-PUCCH-RNTI.
If the UE is configured with higher layer signaling twoPUCCH-PC-AdjustmentStates and PUCCH-SpatialRelationInfo, closed-loop index 1 may have a value of 0 or 1.
If the UE is not configured with higher layer signaling twoPUCCH-PC-AdjustmentStates or PUCCH-SpatialRelationInfo, closed-loop index 1 may have a value of 0.
If the UE obtains a TPC command value through the TPC command field included in DCI format 1_0, 1_1, or 1_2 that schedules PDSCH reception, and the UE is configured with PUCCH-SpatialRelationInfo being higher layer signaling, the UE may obtain a connection relationship between a pucch-SpatialRelationInfoId value and a closedLoopIndex value that sets a closed-loop index 1 value based on an index that can be set through p0-PUCCH-Id being higher layer signaling. If the UE receives a MAC-CE corresponding to pucch-SpatialRelationInfoId, the UE can determine the closedLoopIndex value that sets a closed-loop index 1 value based on the corresponding p0-PUCCH-Id index.
If the UE obtains one TPC command value from a TPC command field included in DCI format 2_2, which is transmitted along a CRC scrambled with TPC-PUCCH-RNTI, it may obtain the 1 value based on the closed-loop index field included in the corresponding DCI format 2_2.
PUCCH power control adjustment state g_{b,f,c}(i, l) for the i^{th} PUCCH transmission occasion corresponding to closed-loop index 1 with bandwidth part b, carrier frequency f, and primary cell c may be calculated as in Equation 7.

$${g}_{b , f , c} ( i , l ) = {g}_{b , f , c} ( i - {i}_{0} , l ) + {\sum }_{m = 0}^{c ( {C}_{i} ) - 1} {δ}_{PUCCH , b , f , c} ( m , l ) \qquad Equation 7$$

δ_{PUCCH,b,f,c}(m, l) may be a value indicated by a TPC command field included in DCI format 10, 1_1, or 1_2 that schedules the mth PUCCH transmission occasion corresponding to closed-loop index 1 and PDSCH reception with bandwidth part b, carrier frequency f, and primary cell c, or be a value indicated by a TPC command field included in DCI format 2_2 being transmitted along with a CRC scrambled with TPC-PUCCH-RNTI. If TPC command accumulation operation is possible, δ_{PUCCH,b,f,c} may have a value in dB corresponding to the value indicated by the TPC command field included in DCI format 1_0, 1_1, 1_2, or 2_2 as shown in Table 2_2 below. For example, if the value of the TPC command field is 0, δ_{PUCCH,b,f,c} may have a value of −1 dB.

TABLE 22

| TPC | Accumulated |
|---|---|
| Command | δ_{PUSCH,b,f,c} |
| field value | [dB] |
| 0 | −1 |
| 1 | 0 |
| 2 | 1 |
| 3 | 3 |

Σₘ₌₀^{c(C}^{ᵢ}⁾⁻¹δ_{PUCCH,b,f,c}(m, l) may mean the sum of above-mentioned TPC command value δ_{PUCCH,b,f,c} for all transmission occasions belonging to a specific set Cᵢ. Here, c(Cᵢ) may indicate the number of all elements belonging to set Cᵢ. Cᵢ may refer to a set of DCIs including all TPC command values on which TPC command accumulation operation is to be performed for the i^{th} PUCCH transmission occasion. To determine Cᵢ, a start point and an end point may be defined on the time dimension, and all DCIs received by the UE between the two points can be included as elements of Cᵢ.
The end point for determining Cᵢ may be a point preceding K_{PUCCH}(i) symbols before the start symbol of the i^{th} PUCCH transmission occasion.
The start point for determining Cᵢ may be a point preceding K_{PUCCH}(i−i₀)−1 symbols before the start symbol of the i−i₀^{th} PUCCH transmission occasion. Here, positive integer i₀ can be determined to be the smallest value that enables the time point preceding K_{PUCCH}(i−i₀) symbols before the start symbol of the i−i₀th PUCCH transmission occasion to be earlier in time than the end point for determining Cᵢ (a point preceding K_{PUCCH}(i) symbols before the start symbol of the i^{th} PUCCH transmission occasion).
For instance, when sym(i) refers to the end point for determining Cᵢ and sym(i−i₀) refers to the time point preceding K_{PUCCH}(i−i₀) symbols before the start symbol of the i−i₀th PUCCH transmission occasion, if sym(i)=sym(i−1)>sym(i−2)>sym(i−3) holds, i₀ may be determined to be 2.
It is possible to consider various methods for each condition as follows, as a scheme for determining the definition of K_{PUCCH}(i) applicable to the i^{th} PUCCH transmission occasion corresponding to closed-loop index/with bandwidth part b, carrier frequency f, and primary cell c.

### [Condition 2-1]

In a case where the number of pucch-spatialRelationInfo connected to a PUCCH-resource through a MAC-CE is 1 for all PUCCH-resources in the UE, or
In a case where the number of pucch-spatialRelationInfo connected to a PUCCH-resource through MAC-CE is 2 for at least one PUCCH-resource in the UE, when i^{th} PUCCH transmission is scheduled through DCI format, if a PUCCH resource indicator field in the corresponding DCI format indicates a PUCCH-resource to which one pucch-spatialRelationInfo is connected
Through PDCCH reception, the UE may receive scheduling for a single PUCCH transmission occasion, and scheduling for multiple repetitive PUCCH transmission occasions.
Cases in which multiple PUCCH transmission occasions can be obtained through PDCCH reception may be as follows.
If the UE is configured with nrofSlots in PUCCH-Config being higher layer signaling, the UE may receive scheduling for plural PUCCH transmission occasions with a semi-statically fixed number of repetitive transmissions equal to the nrofSlots value.
When the UE is configured with higher layer signaling for a number of repetitive transmissions greater than or equal to 1 in a PUCCH-resource being higher layer signaling, the UE may receive scheduling for multiple PUCCH transmission occasions with a number of repetitive transmissions that can be dynamically indicated according to the number of repetitive transmissions set in the PUCCH-resource indicated by a PUCCH resource indicator field in the PDCCH.

[Method 2-1-1] K_{PUCCH}(i) applicable to the i^{th} PUCCH transmission occasion may refer to a symbol length from the end point of the last symbol at which the PDCCH having scheduled the i^{th} PUCCH transmission occasion is received to the start point of the i^{th} PUCCH transmission occasion.
If the UE receives scheduling for i, i+1, . . . , i+N−1^{th} PUCCH transmission occasions through reception of one corresponding PDCCH, the end point of the last symbol of the PDCCH, which determines K_{PUCCH}(i), K_{PUCCH}(i+1), . . . , K_{PUCCH}(i+N−1) applicable respectively to i, i+1, . . . , i+N−1^{th} PUCCH transmission occasions, may always be the same. Hence, since the end points for determining Dᵢ according to the above are all the same, TPC command accumulation values applied to individual PUCCH transmission occasions scheduled by the corresponding PDCCH may all be the same. In this case, there is an advantage of simplifying the operation of the UE without a complication by applying a power control value that can be determined at the time of PDCCH scheduling to all PUCCH transmission occasions. However, it can be said to be an inflexible method in that dynamic power control through L1 signaling (e.g., DCI format 2_2) is not possible for PUCCH transmission occasions transmitted relatively later in time.

[Method 2-1-2] K_{PUCCH}(i) applicable to the i^{th} PUCCH transmission occasion may refer to a symbol length from the end point of the last symbol at which the PDCCH having scheduled the i^{th} PUCCH transmission occasion is received to the start point of a PUCCH transmission occasion transmitted first in time among all PUCCH transmission occasions scheduled by the corresponding PDCCH.
When the UE receives scheduling for one PUCCH transmission occasion through reception of one corresponding PDCCH, method 2-1-2 may derive the same K_{PUCCH}(i) value as method 2-1-1.
When the UE receives scheduling for i, i+1, . . . , i+N−1^{th} PUCCH transmission occasions through reception of one corresponding PDCCH, K_{PUCCH}(i), K_{PUCCH}(i+1), . . . , K_{PUCCH}(i+N−1) applicable respectively to i, i+1, . . . , i+N−1^{th} PUCCH transmission occasions may have the same value as K_{PUCCH}(i) that is applicable to the i^{th} PUCCH transmission occasion transmitted first in time among all PUCCH transmission occasions scheduled by the corresponding PDCCH. Hence, since the end points for determining Dᵢ are different according to the above, the value for TPC command accumulation applied to all PUCCH transmission occasions scheduled by the corresponding PDCCH may vary for individual PUCCH transmission occasions. In this case, in addition to the power control value that can be determined at the time of PDCCH scheduling, dynamic power control through L1 signaling (e.g., DCI format 2_2) is also possible for PUCCH transmission occasions transmitted relatively later in time. Therefore, although UE operation may become relatively complicated, it can be said to be a flexible method from a power control perspective.

[Method 2-1-3] K_{PUCCH}(i) applicable to the i^{th} PUCCH transmission occasion may refer to a symbol length set through higher layer signaling.
When the UE receives scheduling for one PUCCH transmission occasion through reception of one PDCCH, the UE may be configured with one symbol length through higher layer signaling.
When the UE receives scheduling for i, i+1, . . . , i+N−1^{th} PUCCH transmission occasions through reception of one corresponding PDCCH, K_{PUCCH} i, K_{PUCCH}(i+1), . . . , K_{PUCCH}(i+N−1) applicable respectively to i, i+1, . . . , i+N−1^{th} PUCCH transmission occasions may all have the same value based on one higher layer signaling value, or may have separate values based on N different higher layer signalings. Hence, since the end points for determining Dᵢ are different according to the above, the value for TPC command accumulation applied to all PUCCH transmission occasions scheduled by the corresponding PDCCH may vary for individual PUCCH transmission occasions. Additionally, if method 2-1-2 is used, since the symbol interval from a specific PDCCH to the first scheduled PUCCH transmission occasion may be not always the same as the symbol interval from another PDCCH to the first scheduled PUCCH transmission occasion, K_{PUCCH}(i) to be considered from a specific PUCCH transmission occasion may vary depending on different PDCCH scheduling. On the other hand, if the corresponding value is set through higher layer signaling as in method 2-1-3, there may be an advantage in that the UE operation can be controlled relatively simply and consistently.
Cases where there is one higher layer signaling described above
   For example, the corresponding signaling may have a value in units of symbols as independent higher layer signaling for TPC command accumulation, and this may be defined to be K_{PUCCH,min}.
   As another example, the corresponding signaling may be the number of symbols obtained by multiplying the smallest value among slot offsets set by d1-DataToUL-ACK, d1-DataToUL-ACK-r16 or d1-DataToUL-ACK-DCI-1-2-r16 in PUCCH config, which is higher layer signaling, by 14, and this may be defined to be K_{PUCCH,min}.
   As another example, the corresponding signaling may be the number of symbols obtained by multiplying the smallest value of scheduling slot offset k2 set in PUSCH-ConfigCommon, which is higher layer signaling, by 14, and this may be defined to be K_{PUCCH,min}.
Cases where there are multiple higher layer signalings described above
   For example, the corresponding signaling may be plural independent higher layer signalings for TPC command accumulation having a value in units of symbols, and if the number of repetitive transmissions is N, these may be defined respectively as K_{PUCCH,min,1}, . . . , K_{PUCCH,min,N}.
As another example, the corresponding signaling may be the number of symbols obtained by considering slot offsets as many as the number of PUCCH transmission occasions scheduled by the corresponding PDCCH from the smallest value among slot offsets set by d1-DataToUL-ACK, d1-DataToUL-ACK-r16 or d1-DataToUL-ACK-DCI-1-2-r16 in PUCCH config, which is higher layer signaling, and multiplying this by 14, and if the number of repetitive transmissions is N, these may be defined respectively as K_{PUCCH,min,1}, . . . , K_{PUCCH,min,N}.
As another example, the corresponding signaling may be the number of symbols obtained by considering k2's as many as the number of PUCCH transmission occasions scheduled by the corresponding PDCCH from the smallest value among all scheduling slot offsets k2 set in PUSCH-ConfigCommon, which is higher layer signaling, and multiplying this by 14, and if the number of repetitive transmissions is N, these may be defined respectively as K_{PUCCH,min,1}, . . . , K_{PUCCH,min,N}.

[Method 2-1-4] K_{PUCCH}(i) applicable to the i^{th} PUCCH transmission occasion may, if the i^{th} PUCCH transmission occasion is the first PUCCH transmission occasion scheduled by a PDCCH, refer to a symbol length from the end point of the last symbol at which the PDCCH is received to the start point of the i^{th} PUCCH transmission occasion, and may, if the i^{th} PUCCH transmission occasion is not the first PUCCH transmission occasion scheduled by the PDCCH, refer to a symbol length from the end point of the last symbol at which the i−1^{th} PUCCH transmission occasion is transmitted to the start point of the i^{th} PUCCH transmission occasion.
When the UE receives scheduling for one PUCCH transmission occasion through reception of one corresponding PDCCH, method 2-1-4 may derive the same K_{PUCCH}(i) value as method 2-1-1.
When the UE receives scheduling for i, i+1, . . . , i+N−1^{th} PUCCH transmission occasions through reception of one corresponding PDCCH, K_{PUCCH}(i) applicable to the i^{th} PUCCH transmission occasion may be calculated by using time points of the PDCCH having scheduled it and the i^{th} PUCCH transmission occasion, and when determining K_{PUCCH}(i+1), . . . , K_{PUCCH}(i+N−1) applicable to i+1, . . . , i+N−1^{th} PUCCH transmission occasions, each of i, . . . , i+N−2^{th} PUCCH transmission occasions may be treated similarly to the PDCCH used previously to calculate K_{PUCCH}(i) for the i^{th} PUCCH transmission occasion.

[Method 2-1-5] K_{PUCCH}(i) applicable to the i^{th} PUCCH transmission occasion may, if the i^{th} PUCCH transmission occasion is the first PUCCH transmission occasion scheduled by a PDCCH, refer to a symbol length from the end point of the last symbol at which the PDCCH is received to the start point of the i^{th} PUCCH transmission occasion, and may, if the i^{th} PUCCH transmission occasion is not the first PUCCH transmission occasion scheduled by the PDCCH, refer to a symbol length from the end point of the nearest downlink symbol or the nearest flexible symbol present before the i^{th} PUCCH transmission occasion to the start point of the i^{th} PUCCH transmission occasion.
When the UE receives scheduling for one PUCCH transmission occasion through reception of one corresponding PDCCH, method 2-1-5 may derive the same K_{PUCCH}(i) value as method 2-1-1.

[Method 2-1-6] The UE may define K_{PUCCH}(i) applicable to the i^{th} PUCCH transmission occasion through a combination of methods 2-1-1 to 2-1-5 described above. For instance, when the UE receives scheduling for N repetitive i, i+1, i+N−1^{th} PUCCH transmission occasions through a PDCCH, it may utilize method 2-1-1 to define K_{PUCCH}(i) for the i^{th} PUCCH transmission occasion being the first one among them and utilize method 2-1-2 as to K_{PUCCH}(i+1), . . . , K_{PUCCH}(i+N−1) for remaining i+1, . . . , i+N−1^{th} PUCCH transmission occasions.

[Method 2-1-7] The UE may configure one of above-described methods 2-1-1 to 2-1-6 through higher layer signaling from the base station as a method for defining K_{PUCCH}(i). For example, the UE may receive a setting called tpcAccumulationTimeDetermination, which is higher layer signaling, from the base station, and the corresponding higher layer signaling may be set to one of scheme1 to scheme6, where scheme1 to scheme6 may refer respectively to methods 2-1-1 to 2-1-6 described above.

[Method 2-1-8] The UE may receive higher layer signaling indicating whether to use a method for defining K_{PUCCH}(i) (e.g. enableTPCAccumulationTimeDetermination) from the base station. Then, if the corresponding higher layer signaling is not set, this may indicate defining K_{PUCCH}(i) by using one of methods 2-1-1 to 2-1-6 described above (e.g. method 2-1-1); if the corresponding higher layer signaling is set (e.g., if the UE receives a setting value of ‘on’), this may indicate that a specific method for defining K_{PUCCH}(i) can be used. Here, the specific method for defining K_{PUCCH}(i) may be one of methods 2-1-1 to 2-1-6 described above (e.g., method 2-1-6) excluding the method used when the corresponding higher layer signaling is not set.

### [Condition 2-2]

In a case where the number of pucch-spatialRelationInfo connected to a PUCCH-resource through MAC-CE is 2 for at least one PUCCH-resource in the UE, when i^{th} PUCCH transmission is scheduled through DCI format,
In a case where a PUCCH resource indicator field in the corresponding DCI format indicates a PUCCH-resource to which two pucch-spatialRelationInfo are connected
Through PDCCH reception, the UE may receive scheduling for multiple repetitive PUCCH transmission occasions.
If the UE is configured with nrofSlots in PUCCH-Config being higher layer signaling, the UE may receive scheduling for plural PUCCH transmission occasions with a semi-statically fixed number of repetitive transmissions equal to the nrofSlots value.
When the UE is configured with higher layer signaling for a number of repetitive transmissions greater than or equal to 1 in a PUCCH-resource being higher layer signaling, the UE may receive scheduling for multiple PUCCH transmission occasions with a number of repetitive transmissions that can be dynamically indicated according to the number of repetitive transmissions set in the PUCCH-resource indicated by a PUCCH resource indicator field in the PDCCH.
As a method for applying different transmission beams or spatial relation info to multiple repetitive PUCCH transmission occasions, the UE may be configured with cyclic mapping or sequential mapping through higher layer signaling. For example, in the case of cyclic mapping, odd-numbered (first, third, . . . ) PUCCH transmission occasions may be connected to the first transmission beam or spatial relation info, and even-numbered (second, fourth, . . . ) PUCCH transmission occasions may be connected to the second transmission beam or spatial relation info.

[Method 2-2-1] K_{PUCCH}(i) applicable to the i^{th} PUCCH transmission occasion may refer to a symbol length from the end point of the last symbol at which the PDCCH having scheduled the i^{th} PUCCH transmission occasion is received to the start point of the i^{th} PUCCH transmission occasion.
If the UE receives scheduling for i, i+1, . . . , i+N−1^{th} PUCCH transmission occasions through reception of one corresponding PDCCH, the end point of the last symbol of the PDCCH, which determines K_{PUCCH}(i), K_{PUCCH}(i+1), K_{PUCCH}(i+N−1) applicable respectively to i, i+1, . . . , i+N−1^{th} PUCCH transmission occasions, may always be the same. Hence, since the end points for determining Cᵢ according to the above are all the same, TPC command accumulation values applied to individual PUCCH transmission occasions scheduled by the corresponding PDCCH may all be the same. In this case, there is an advantage of simplifying the operation of the UE without a complication by applying, through two TPC command field values corresponding to individual closed-loop index l (e.g., 0 or 1) present in the PDCCH that schedules multiple TRP-based PUCCH transmission, a power control value that can be determined at the time of PDCCH scheduling to all PUCCH transmission occasions corresponding to specific closed-loop index l. However, it can be said to be an inflexible method in that dynamic power control through L1 signaling (e.g., DCI format 2_2) is not possible for PUCCH transmission occasions transmitted relatively later in time.

[Method 2-2-2] K_{PUCCH}(i) applicable to the i^{th} PUCCH transmission occasion may refer to a symbol length from the end point of the last symbol at which the PDCCH having scheduled the i^{th} PUCCH transmission occasion is received to the start point of a PUCCH transmission occasion transmitted first in time among all PUCCH transmission occasions to which the same transmission beam or spatial relation info applied to the i^{th} PUCCH transmission occasion is applied.
If the UE receives scheduling for i, i+1, . . . , i+N−1^{th} PUCCH transmission occasions through reception of one corresponding PDCCH, and cyclic mapping is configured as a scheme of applying transmission beam or spatial relation info through higher layer signaling, values applicable to odd-numbered (i, i+2, i+4, . . . ) transmission occasions may all be the same as the K_{PUCCH}(i) value. In this case, if different closed-loop index l (e.g., 0 or 1) is used for TRPs, K_{PUCCH}(i) and K_{PUCCH}(i+1) can be used for each closed-loop index. However, since the value of K_{PUCCH}(i+1) becomes relatively larger compared to the value of K_{PUCCH}(i) corresponding to the transmission beam or spatial relation info that is applied early in time among the plural repetitive PUCCH transmission occasions scheduled by the PDCCH, there may be a disadvantage in that flexible power control may become impossible for PUCCH transmission occasions corresponding to the transmission beam or spatial relation info that is applied later in time.

[Method 2-2-3] K_{PUCCH}(i) applicable to the i^{th} PUCCH transmission occasion may refer to a symbol length from the end point of the last symbol at which the PDCCH having scheduled the i^{th} PUCCH transmission occasion is received to the start point of a PUCCH transmission occasion transmitted first in time among all PUCCH transmission occasions scheduled by the corresponding PDCCH.
When the UE receives scheduling for i, i+1, . . . , i+N−1^{th} PUCCH transmission occasions through reception of one corresponding PDCCH,K_{PUCCH}(i),K_{PUCCH}(i+1), . . . , K_{PUCCH}(i+N−1) applicable respectively to i, i+1, . . . , i+N−1^{th} PUCCH transmission occasions may have the same value as K_{PUCCH}(i) that is applicable to the i^{th} PUCCH transmission occasion transmitted first in time among all PUCCH transmission occasions scheduled by the corresponding PDCCH. Hence, since the end points for determining Cᵢ are different according to the above, the value for TPC command accumulation applied to all PUCCH transmission occasions scheduled by the corresponding PDCCH may vary for individual PUCCH transmission occasions. In this case, in addition to the power control value that can be determined at the time of PDCCH scheduling, dynamic power control through L1 signaling (e.g., DCI format 2_2) is also possible for PUCCH transmission occasions transmitted relatively later in time. Therefore, although UE operation may become relatively complicated, it can be said to be a flexible method from a power control perspective. Further, compared to method 2-2-2, since K_{PUCCH}(i) values corresponding to different transmission beams or spatial relation info are all the same, the flexibility of power control applied to each transmission beam can be similarly achieved.

[Method 2-2-4] K_{PUCCH}(i) applicable to the i^{th} PUCCH transmission occasion may refer to a symbol length set through higher layer signaling.
When the UE receives scheduling for i, i+1, . . . , i+N−1^{th} PUCCH transmission occasions through reception of one corresponding PDCCH, K_{PUCCH}(i), K_{PUCCH}(i+1), . . . , K_{PUCCH}(i+N−1) applicable respectively to i, i+1, . . . , i+N−1^{th} PUCCH transmission occasions may all have the same value based on one higher layer signaling value, or may have separate values based on different higher layer signalings depending on the number of different transmission beams or spatial relation info. Hence, since the end points for determining Cᵢ are different according to the above, the value for TPC command accumulation applied to all PUCCH transmission occasions scheduled by the corresponding PDCCH may vary for individual PUCCH transmission occasions. Additionally, if method 2-2-3 is used, since the symbol interval from a specific PDCCH to the first scheduled PUCCH transmission occasion may be not always the same as the symbol interval from another PDCCH to the first scheduled PUCCH transmission occasion, K_{PUCCH}(i) to be considered from a specific PUCCH transmission occasion may vary depending on different PDCCH scheduling. On the other hand, if the corresponding value is set through higher layer signaling as in method 2-2-3, there may be an advantage in that the UE operation can be controlled relatively simply and consistently.
Cases where there is one higher layer signaling described above
For example, the corresponding signaling may have a value in units of symbols as independent higher layer signaling for TPC command accumulation, and this may be defined to be K_{PUCCH,min}.
As another example, the corresponding signaling may be the number of symbols obtained by multiplying the smallest value among slot offsets set by d1-DataToUL-ACK, d1-DataToUL-ACK-r16 or d1-DataToUL-ACK-DCI-1-2-r16 in PUCCH config, which is higher layer signaling, by 14, and this may be defined to be K_{PUCCH,min}.
As another example, the corresponding signaling may be the number of symbols obtained by multiplying the smallest value of scheduling slot offset k2 set in PUSCH-ConfigCommon, which is higher layer signaling, by 14, and this may be defined to be K_{PUCCH,min}.
Cases where the above-mentioned higher layer signaling is the same as the number of different transmission beams or spatial relation info
For example, the corresponding signaling may be plural independent higher layer signalings for TPC command accumulation having a value in units of symbols, and these may be defined respectively as K_{PUSCH,min,1}, K_{PUSCH,min,2}.
As another example, the corresponding signaling may be the number of symbols obtained by considering slot offsets as many as the number of PUCCH transmission occasions scheduled by the corresponding PDCCH from the smallest value among slot offsets set by d1-DataToUL-ACK, d1-DataToUL-ACK-r16 or d1-DataToUL-ACK-DCI-1-2-r16 in PUCCH config, which is higher layer signaling, and multiplying this by 14, and these may be defined respectively as K_{PUCCH,min,1}, K_{PUSCH,min,2}.
As another example, the corresponding signaling may be the number of symbols obtained by considering two k2's from the smallest value among all scheduling slot offsets k2 set in PUSCH-ConfigCommon, which is higher layer signaling, and multiplying this by 14, and these may be defined respectively as K_{PUSCH,min,1}, K_{PUSCH,min,2}.

### Third Embodiment: SRS Power Control Method

As an embodiment of the disclosure, a description will be given of a method where when an uplink reference signal (sounding reference signal, SRS) is transmitted in response to a power control command received from the base station, the UE sets the transmit power of the uplink reference signal for transmission. With an SRS power control adjustment state corresponding to i^{th} SRS transmission occasion and closed-loop index l, the uplink reference signal transmit power of the UE can be determined as shown in Equation 8 below, expressed in dBm units. In Equation 8 below, when the UE supports multiple carrier frequencies in multiple cells, each parameter can be set for cell c, carrier frequency f and bandwidth part b, and may be identified by indices b, f and c.

$${P}_{SRS , b , f , c} ( i , {q}_{s} , l ) = min \qquad Equation 8$$

$$\{ \begin{matrix}{P}_{CMAX , f , c} ( i ) , \\ {P}_{{0}_{-} SRS , b , f , c} ( {q}_{s} ) + 10 {log}_{10} ( {2}^{μ} * {M}_{SRS , b , f , c} ( i ) ) + {α}_{SRS , b , f , c} ( {q}_{s} ) \cdot {PL}_{b , f , c} ( {q}_{d} ) + {h}_{b , f , c} ( i , l )\end{matrix} \}$$

$$[ dBm ]$$

P_{CMAX,f,c}(i): it is the maximum transmit power available to the UE in the i^{th} transmission occasion and is determined by the power class of the UE, parameters activated by the base station, and various parameters embedded in the UE.
P_{0_SRS,b,f,c}(qₛ): it can be set by p0, which is higher layer signaling, with bandwidth part b, carrier frequency f, and cell c, and SRS resource set qₛ can be set through SRS-ResourceSet and SRS-ResourceSetId, which are higher layer signaling.
μ: subcarrier spacing configuration value
M_{SRS,b,f,c}(i): it may mean the amount of resources used in the i^{th} SRS transmission occasion (e.g., the number of resource blocks (RBs) used for SRS transmission in the frequency domain).
α_{SRS,b,f,c}(j): it can be set by alpha, which is higher layer signaling, with bandwidth part b, carrier frequency f, and cell c, and SRS resource set qₛ can be set through SRS-ResourceSet and SRS-ResourceSetId, which are higher layer signaling.
PL_{b,f,c}(q_{d}): it is pathloss representing the path loss between the base station and the UE, and the UE calculates pathloss from the difference between the transmit power of a reference signal (RS) resource q_{d} signaled by the base station and the UE received signal level of the reference signal.
h_{b,f,c}(i, l): it may indicate an SRS power control adjustment state value for the i^{th} SRS transmission occasion corresponding to closed-loop index 1 with bandwidth part b, carrier frequency f, and cell c.

The SRS power control adjustment state can be determined through bandwidth part b, carrier frequency f, cell c, and i^{th} transmission occasion.
If the UE is set to have the same power control adjustment state value between SRS transmission and PUSCH transmission through srs-PowerControlAdjustmentStates, which is higher layer signaling, the SRS power control adjustment state can be represented as in Equation 9 below, and in Equation 9, f_{b,f,c}(i,l) may mean the current PUSCH power control adjustment state. In this case, f_{b,f,c}(i,l) can be calculated through various methods of embodiment 1 described above, and the value may be substituted into h_{b,f,c}(i, l) for usage.

$${h}_{b , f , c} ( i , l ) = {f}_{b , f , c} ( i , l ) \qquad Equation 9$$

If the UE is not configured for PUSCH transmission with bandwidth part b, carrier frequency f, and cell c, or is set to have separate power control adjustment state values between SRS transmission and PUSCH transmission through srs-PowerControlAdjustmentStates, which is higher layer signaling, and higher layer signaling tpc-Accumulation is not set, the SRS power control adjustment state may be represented as in Equation 10 below regardless of closed-loop 1.

$${h}_{b , f , c} ( i ) = {h}_{b , f , c} ( i - {i}_{0} ) + {\sum }_{m = 0}^{c ( {S}_{i} ) - 1} {δ}_{SRS , b , f , c} ( m ) \qquad Equation 10$$

δ_{SRS,b,f,c}(m): it may be a value indicated by a TPC command field included in DCI format 2_3, and its value may follow Table 20 above.
Σₘ₌₀^{c(S}ᵢ)−1=δ_{SRS,b,f,c}(m) may mean the sum of above-mentioned TPC command value δ_{SRS,b,f,c} for all transmission occasions belonging to a specific set St. Here, c(Sᵢ) may indicate the number of all elements belonging to set Sᵢ. Sᵢ may refer to a set of DCIs including all TPC command values on which TPC command accumulation operation is to be performed for the i^{th} PUSCH transmission occasion. To determine Sᵢ, a start point and an end point may be defined on the time dimension, and all DCIs received by the UE between the two points can be included as elements of Sᵢ.
The end point for determining Sᵢ may be a point preceding K_{SRS}(i) symbols before the start symbol of the i^{th} SRS transmission occasion.
The start point for determining Sᵢ may be a point preceding K_{SRS}(i−i₀)−1 symbols before the start symbol of the i−i₀th SRS transmission occasion. Here, positive integer i₀ can be determined to be the smallest value that enables the time point preceding K_{SRS}(i−i₀) symbols before the start symbol of the i−i₀th SRS transmission occasion to be earlier in time than the end point for determining Sᵢ (a point preceding K_{SRS}(i) symbols before the start symbol of the i^{th} SRS transmission occasion).
For instance, when sym(i) refers to the end point for determining Sᵢ and sym(i−i₀) refers to the time point preceding K_{SRS}(i−i₀) symbols before the start symbol of the i−i₀th SRS transmission occasion, if sym(i)=sym(i−1)>sym(i−2)>sym(i−3) holds, i₀ may be determined to be 2.
If the UE is not configured for PUSCH transmission with bandwidth part b, carrier frequency f, and cell c, or is set to have separate power control adjustment state values between SRS transmission and PUSCH transmission through srs-PowerControlAdjustmentStates, which is higher layer signaling, and higher layer signaling tpc-Accumulation is set (i.e., TPC command accumulation operation cannot be performed and absolute TPC command values can be applied), the SRS power control adjustment state may be represented as in Equation 11 below regardless of closed-loop 1.

$${h}_{b , f , c} ( i ) = {δ}_{SRS , b , f , c} ( i ) \qquad Equation 11$$

δ_{SRS,b,f,c}(i) may be a value indicated by a TPC command field included in DCI format 2_3 with bandwidth part b, carrier frequency f, and cell c as described above, and its value may follow Table 21 above. For example, if the value of the TPC command field is 0, S_{SRS,b,f,c} may have a value of −4 dB.
As described above, in cases where the UE can perform TPC command accumulation operation (i.e., if tpc-Accumulation being higher layer signaling is not set), it is possible to consider various methods for determining the definition of K_{SRS}(i) applicable to the i^{th} SRS transmission occasion with bandwidth part b, carrier frequency f, and cell c; or, in cases where the UE cannot perform TPC command accumulation operation and can operate with an absolute value (i.e., if tpc-Accumulation being higher layer signaling is set), it is possible to consider various methods for determining the definition of δ_{SRS,b,f,c}(i) applicable to the i^{th} SRS transmission occasion with bandwidth part b, carrier frequency f, and cell c.

### [Condition 3-1]

In a case where the UE receives an indication for triggering aperiodic SRS transmission through DCI format from the base station

### [Condition 3-1-1]

In addition to above-mentioned condition 3-1, if the UE is capable of performing TPC command accumulation operation (i.e., if tpc-Accumulation being higher layer signaling is not set)

[Method 3-1-1-1] K_{SRS}(i) applicable to the i^{th} SRS transmission occasion may refer to a symbol length from the end point of the last symbol at which the PDCCH having triggered the i^{th} SRS transmission occasion is received to the start point of the i^{th} SRS transmission occasion.
If the UE receives triggering for i, i+1, . . . , i+N−1 th SRS transmission occasions through reception of one corresponding PDCCH, the end point of the last symbol of the PDCCH, which determines K_{SRS}(i), K_{SRS}(i+1), . . . , K_{SRS}(i+N−1) applicable respectively to i, i+1, . . . , i+N−1 th SRS transmission occasions, may always be the same. Hence, since the end points for determining Sᵢ according to the above are all the same, TPC command accumulation values applied to individual SRS transmission occasions scheduled by the corresponding PDCCH may all be the same. In this case, there is an advantage of simplifying the operation of the UE without a complication by applying a power control value that can be determined at the time of PDCCH triggering to all SRS transmission occasions. However, it can be said to be an inflexible method in that dynamic power control through L1 signaling (e.g., DCI format 2_3) is not possible for SRS transmission occasions transmitted relatively later in time.

[Method 3-1-1-2] K_{SRS}(i) applicable to the i^{th} SRS transmission occasion may refer to a symbol length from the end point of the last symbol at which the PDCCH having triggered the i^{th} SRS transmission occasion is received to the start point of an SRS transmission occasion transmitted first in time among all SRS transmission occasions triggered by the corresponding PDCCH.
When the UE receives triggering for one SRS transmission occasion through reception of one corresponding PDCCH, method 3-1-1-2 may derive the same K_{SRS}(i) value as method 3-1-1-1.
When the UE receives triggering for i, i+1, . . . , i+N−1 th SRS transmission occasions through reception of one corresponding PDCCH, K_{SRS}(i), K_{SRS}(i+1), . . . , K_{SRS}(i+N−1) applicable respectively to i, i+1, . . . , i+N−1 th SRS transmission occasions may have the same value as K_{SRS}(i) that is applicable to the i^{th} SRS transmission occasion transmitted first in time among all SRS transmission occasions triggered by the corresponding PDCCH. Hence, since the end points for determining Sᵢ are different according to the above, the value for TPC command accumulation applied to all SRS transmission occasions scheduled by the corresponding PDCCH may vary for individual SRS transmission occasions. In this case, in addition to the power control value that can be determined at the time of PDCCH triggering, dynamic power control through L1 signaling (e.g., DCI format 2_3) is also possible for SRS transmission occasions transmitted relatively later in time. Therefore, although UE operation may become relatively complicated, it can be said to be a flexible method from a power control perspective.

[Method 3-1-1-3] K_{SRS}(i) applicable to the i^{th} SRS transmission occasion may refer to a symbol length set through higher layer signaling.
When the UE receives triggering for one SRS transmission occasion through reception of one corresponding PDCCH, the UE may be configured with one symbol length through higher layer signaling.
When the UE receives triggering for i, i+1, . . . , i+N−1 th SRS transmission occasions through reception of one corresponding PDCCH, K_{SRS}(i), K_{SRS}(i+1), . . . , K_{SRS}(i+N−1) applicable respectively to i, i+1, . . . , i+N−1 th SRS transmission occasions may all have the same value based on one higher layer signaling value, or may have separate values based on N different higher layer signalings. Hence, since the end points for determining Sᵢ are different according to the above, the value for TPC command accumulation applied to all SRS transmission occasions scheduled by the corresponding PDCCH may vary for individual SRS transmission occasions. Additionally, if method 3-1-1-2 is used, since the symbol interval from a specific PDCCH to the first triggered SRS transmission occasion may be not always the same as the symbol interval from another PDCCH to the first triggered SRS transmission occasion, K_{SRS}(i) to be considered from a specific SRS transmission occasion may vary depending on different PDCCH triggering. On the other hand, if the corresponding value is set through higher layer signaling as in method 3-1-1-3, there may be an advantage in that the UE operation can be controlled relatively simply and consistently.
Cases where there is one higher layer signaling described above
   For example, the corresponding signaling may have a value in units of symbols as independent higher layer signaling for TPC command accumulation, and this may be defined to be K_{SRS,min}.
   As another example, the corresponding signaling may be the number of symbols obtained by multiplying the smallest value of scheduling slot offset k2 or k2-16, which is higher layer signaling set in every TDRA entry, by 14, and this may be defined to be K_{SRS,min}.
   As another example, the corresponding signaling may be the number of symbols obtained by multiplying the smallest value of all SRS triggering slot offset values set in SRS resource sets by 14, and this may be defined to be K_{SRS,min}.
   As another example, the corresponding signaling may be the number of symbols obtained by multiplying the smallest value of triggering slot offset k2 set in PUSCH-ConfigCommon, which is higher layer signaling, by 14, and this may be defined to be K_{SRS,min}.
Cases where there are multiple higher layer signalings described above
   For example, the corresponding signaling may be plural independent higher layer signalings for TPC command accumulation having a value in units of symbols, and if the number of repetitive transmissions is N, these may be defined respectively as K_{SRS,min,1}, . . . , K_{SRS,min,N}.
   As another example, the corresponding signaling may be the number of symbols obtained by considering k2's or k2-16's as many as the number of SRS transmission occasions triggered by the corresponding PDCCH from the smallest value among all triggering slot offsets k2 or k2-16, which are higher layer signaling set in all TDRA entries, and multiplying this by 14, and if the number of repetitive transmissions is N, these may be defined respectively as K_{SRS,min,1}, . . . , K_{SRS,min,N}.
As another example, the corresponding signaling may be the number of symbols obtained by considering slot offsets as many as the number of SRS transmission occasions triggered by the corresponding PDCCH from the smallest value among all SRS triggering slot offsets set in SRS resource sets, and multiplying this by 14, and if the number of repetitive transmissions is N, these may be defined respectively as K_{SRS,min,1}, . . . , K_{SRS,min,N}.
As another example, the corresponding signaling may be the number of symbols obtained by considering k2's as many as the number of SRS transmission occasions triggered by the corresponding PDCCH from the smallest value among all triggering slot offsets k2 set in PUSCH-ConfigCommon, which is higher layer signaling, and multiplying this by 14, and if the number of repetitive transmissions is N, these may be defined respectively as K_{SRS,min,1}, . . . , K_{SRS,min,N}.

[Method 3-1-1-4] K_{SRS}(i) applicable to the i^{th} SRS transmission occasion may, if the i^{th} SRS transmission occasion is the first SRS transmission occasion triggered by a PDCCH, refer to a symbol length from the end point of the last symbol at which the PDCCH is received to the start point of the i^{th} SRS transmission occasion, and may, if the i^{th} SRS transmission occasion is not the first SRS transmission occasion triggered by the PDCCH, refer to a symbol length from the end point of the last symbol at which the i−1 th SRS transmission occasion is transmitted to the start point of the i^{th} SRS transmission occasion.
When the UE receives triggering for one SRS transmission occasion through reception of one corresponding PDCCH, method 3-1-1-4 may derive the same K_{SRS}(i) value as method 3-1-1-1.
When the UE receives triggering for i, i+1, . . . , i+N−1 th SRS transmission occasions through reception of one corresponding PDCCH, K_{SRS} (applicable to the i^{th} SRS transmission occasion may be calculated by using time points of the PDCCH having scheduled it and the i^{th} SRS transmission occasion, and when determining K_{SRS}(i+1), . . . , K_{SRS}(i+N−1) applicable to i+1, . . . , i+N−1 th SRS transmission occasions, each of i, . . . , i+N−2th SRS transmission occasions may be treated similarly to the PDCCH used previously to calculate K_{SRS}(i) for the i^{th} SRS transmission occasion.

[Method 3-1-1-5] K_{SRS}(i) applicable to the i^{th} SRS transmission occasion may, if the i^{th} SRS transmission occasion is the first SRS transmission occasion triggered by a PDCCH, refer to a symbol length from the end point of the last symbol at which the PDCCH is received to the start point of the i^{th} SRS transmission occasion, and may, if the i^{th} SRS transmission occasion is not the first SRS transmission occasion triggered by the PDCCH, refer to a symbol length from the end point of the nearest downlink symbol present before the i^{th} SRS transmission occasion to the start point of the i^{th} SRS transmission occasion.
When the UE receives triggering for one SRS transmission occasion through reception of one corresponding PDCCH, method 3-1-1-5 may derive the same K_{SRS}(i) value as method 3-1-1-1.

[Method 3-1-1-6] The UE may define K_{SRS}(i) applicable to the i^{th} SRS transmission occasion through a combination of methods 3-1-1-1 to 3-1-1-5 described above. For instance, when the UE receives triggering for N repetitive i, i+1, . . . , i+N−1 th SRS transmission occasions through a PDCCH, it may utilize method 3-1-1-1 to define K_{SRS}(i) for the i^{th} SRS transmission occasion being the first one among them and utilize method 3-1-1-2 as to K_{SRS}(i+1), . . . , K_{SRS}(i+N−1) for remaining i+1, , i+N−1 th SRS transmission occasions.

[Method 3-1-1-7] The UE may configure one of above-described methods 3-1-1-1 to 3-1-1-6 through higher layer signaling from the base station as a method for defining K_{SRS}(i). For example, the UE may receive a setting called tpcAccumulationTimeDetermination, which is higher layer signaling, from the base station, and the corresponding higher layer signaling may be set to one of scheme1 to scheme6, where scheme1 to scheme6 may refer respectively to methods 3-1-1-1 to 3-1-1-6 described above.

[Method 3-1-1-8] The UE may receive higher layer signaling indicating whether to use a method for defining K_{SRS}(i) (e.g. enableTPCAccumulationTimeDetermination) from the base station. Then, if the corresponding higher layer signaling is not set, this may indicate defining K_{SRS}(i) by using one of methods 3-1-1-1 to 3-1-1-6 described above (e.g. method 3-1-1-1); if the corresponding higher layer signaling is set (e.g., if the UE receives a setting value of ‘on’), this may indicate that a specific method for defining K_{SRS}(i) can be used. Here, the specific method for defining K_{SRS}(i) may be one of methods 3-1-1-1 to 3-1-1-6 described above (e.g., method 3-1-1-6) excluding the method used when the corresponding higher layer signaling is not set.

### [Condition 3-1-2]

In addition to condition 3-1 described above, when the UE cannot perform TPC command accumulation operation and operates through an absolute value (i.e., when tpc-Accumulation being higher layer signaling is configured)

[Method 3-1-2-1] δ_{SRS,b,f,c}(i) may be a TPC command field value included in the PDCCH that has triggered the i^{th} SRS transmission occasion corresponding to closed-loop index 1 with bandwidth part b, carrier frequency f, and cell c.
In this method, when the UE receives triggering for one SRS transmission occasion through reception of one corresponding PDCCH, or when the UE receives triggering for plural SRS transmission occasions through reception of one corresponding PDCCH, the same absolute TPC command value can be applied to all SRS transmission occasions.
In this method, when the UE receives triggering for plural PUSCH transmission occasions through reception of one corresponding PDCCH, since δ_{SRS,b,f,c} (i) follows only a TPC command field value included in the triggering PDCCH, the value of a TPC command field included in DCI format 2_3 between two SRS transmission occasions may be not applied.

[Method 3-1-2-2] δ_{SRS,b,f,c}(i) may be the most recently received TPC command value before transmission of the i^{th} SRS transmission occasion corresponding to closed-loop index 1 with bandwidth part b, carrier frequency f, and cell c.
In this method, when the UE receives triggering for one SRS transmission occasion through reception of one corresponding PDCCH, when the UE receives triggering for multiple SRS transmission occasions through reception of one corresponding PDCCH, or when for every SRS transmission occasion, there is no DCI format 2_3 transmitted more recently than the triggering PDCCH, the absolute TPC command value included in the triggering PDCCH may be applied equally to all SRS transmission occasions.
In this method, when the UE receives triggering for multiple SRS transmission occasions through reception of one corresponding PDCCH, if DCI format 2_3 is received between transmissions of i^{th} and i+1th SRS transmission occasions, and the most recently received TPC command value from the i^{th} SRS transmission occasion is the value indicated by the TPC command field included in the triggering PDCCH, the absolute TPC command value applied to the i^{th} SRS transmission occasion may follow the value indicated by the triggering PDCCH, and for the i+1th SRS transmission occasion, it may follow the absolute TPC command value included in DCI format 2_3.

[Method 3-1-2-3] δ_{SRS,b,f,c}(i) may be the most recently received TPC command value from a time point preceding K_{SRS}(i) symbols before transmission of the i^{th} SRS transmission occasion corresponding to closed-loop index 1 with bandwidth part b, carrier frequency f, and cell c.
To define K_{SRS}(i), one of methods 3-1-1-1 to 3-1-1-8 described above can be applied.

### Fourth Embodiment: PRACH Power Control Method

As an embodiment of the disclosure, a description will be given of a method where when transmission is performed through an uplink random access channel (physical random access channel, PRACH) in response to a power control command received from the base station, the UE sets the transmit power of the uplink random access channel for transmission. With a PRACH power control adjustment state corresponding to i^{th} PRACH transmission occasion, and closed-loop index 1, the uplink reference signal transmit power of the UE can be determined as shown in Equation 12 below, expressed in dBm units. In Equation 12 below, when the UE supports multiple carrier frequencies in multiple cells, each parameter can be set for cell c, carrier frequency f, and bandwidth part b, and may be identified by indices b, f, and c.

$${P}_{PRACH , b , f , c} ( i , l ) = min \qquad Equation 12$$

$$\{ \begin{matrix}{P}_{CMAX , f , c} ( i ) , \\ {P}_{P R A C {H}_{-} target , f , c} + P {L}_{b , f , c} ( {q}_{d} ) + {r}_{b , f , c} ( i , l )\end{matrix} \}$$

$$[ dBm ]$$

P_{CMAx,f,c}(i): it is the maximum transmit power available to the UE in the i^{th} transmission occasion and is determined by the power class of the UE, parameters activated by the base station, and various parameters embedded in the UE.
P_{PRACH_target,f,c}: it may indicate the target received power of PRACH that may be set by PREAMBLE_RECEIVED_TARGET_POWER, which is higher layer signaling, for carrier frequency f and cell c.
PL_{b,f,c}(qa_{d}): it is pathloss representing the path loss between the base station and the UE, and the UE calculates pathloss from the difference between the transmit power of a reference signal (RS) resource q_{d} signaled by the base station and the UE received signal level of the reference signal.
r_{b,f,c}(i, l): it may indicate a PRACH power control adjustment state value for the i^{th} PRACH transmission occasion corresponding to closed-loop index 1 with bandwidth part b, carrier frequency f, and cell c. If higher layer signaling indicating whether to use a TPC command value is not set, it may be considered 0 dBm, and if higher layer signaling is set, it may have a value other than 0 dBm as follows.

The PRACH power control adjustment state can be determined based on bandwidth part b, carrier frequency f, cell c, and i^{th} transmission occasion.
If the UE is set to have the same power control adjustment state value between a specific uplink channel or signal (e.g., PUSCH, PUCCH, or SRS) and PRACH transmission through prach-PowerControlAdjustmentStates, which is higher layer signaling, the PRACH power control adjustment state may have the same value as that of the corresponding uplink channel with the same power control adjustment state value. In this case, the power control adjustment state of the corresponding uplink channel having the same power control adjustment state value can be calculated through various methods of embodiment 1 to 3 described above, and the value may be substituted into r_{b,f,c}(i, l) for usage.
If the UE is set to have separate power control adjustment state values between a specific uplink channel or signal (e.g., PUSCH, PUCCH, or SRS) and PRACH transmission through prach-PowerControlAdjustmentStates, which is higher layer signaling, with bandwidth part b, carrier frequency f, and cell c, and higher layer signaling tpc-Accumulation is not set, the PRACH power control adjustment state may be represented as in Equation 13 below regardless of closed-loop 1.

$${r}_{b , f , c} ( i ) = {r}_{b , f , c} ( i - {i}_{0} ) + {\sum }_{m = 0}^{c ( {R}_{i} ) - 1} {δ}_{P R A C H , b , f , c} ( m ) \qquad Equation 13$$

δ_{PRACH,b,f,c}(m). it may be a TPC command value indicated by DCI, and may be a value indicated by a TPC command field included possibly in DCI format 2_2 or 2_3 including a CRC scrambled with a new RNTI (e.g., TPC-PRACH-RNTI) other than existing RNTIs, new DCI format to be defined for PRACH, or DCI format 0_0, 0_1, 0_2, 1_0, 1_1, 1_2 that schedules PDSCH/PUSCH, and its value may follow Table 20 above.
δₘ₌₀^{c(R}^{ᵢ}⁾⁻¹δ_{PRACH,b,f,c}(m) may mean the sum of above-mentioned TPC command value δ_{PRACH,b,f,c} for all transmission occasions belonging to a specific set Rᵢ. Here, c(Rᵢ) may indicate the number of all elements belonging to set Rᵢ. Rᵢ may refer to a set of DCIs including all TPC command values on which TPC command accumulation operation is to be performed for the i^{th} PRACH transmission occasion. To determine Rᵢ, a start point and an end point may be defined on the time dimension, and all DCIs received by the UE between the two points can be included as elements of Rᵢ.
The end point for determining Rᵢ may be a point preceding K_{PRACH}(i) symbols before the start symbol of the i^{th} PRACH transmission occasion.
The start point for determining Rᵢ may be a point preceding K_{PRACH}(i−i₀)−1 symbols before the start symbol of the i−i₀ th PRACH transmission occasion. Here, positive integer i₀ can be determined to be the smallest value that enables the time point preceding K_{PRACH}(i−₀) symbols before the start symbol of the i−i₀th PRACH transmission occasion to be earlier in time than the end point for determining Rᵢ (a point preceding K_{PRACH}(i) symbols before the start symbol of the i^{th} PRACH transmission occasion).
For instance, when sym(i) refers to the end point for determining Rᵢ, and sym(i−i₀) refers to the time point preceding K_{PRACH}(i−i₀) symbols before the start symbol of the i−i₀th PRACH transmission occasion, if sym(i)=sym(i−1)>sym(i−2)>sym(i−3) holds, i0 may be determined to be 2.
If the UE is set to have separate power control adjustment state values between a specific uplink channel or signal (e.g., PUSCH, PUCCH, or SRS) and PRACH transmission through prach-PowerControlAdjustmentStates, which is higher layer signaling, with bandwidth part b, carrier frequency f, and cell c, and higher layer signaling tpc-Accumulation is set (i.e., TPC command accumulation operation cannot be performed and absolute TPC command values can be applied), the PRACH power control adjustment state may be represented as in Equation 14 below regardless of closed-loop 1.

$${r}_{b , f , c} ( i ) = {δ}_{P R A C H , b , f , c} ( i ) \qquad Equation 14$$

δ_{PRACH,b,f,c}(i) may be a TPC command value indicated by DCI with bandwidth part b, carrier frequency f, cell c as described above, and may be a value indicated by a TPC command field included possibly in DCI format 2_2 or 2_3 including a CRC scrambled with a new RNTI (e.g., TPC-PRACH-RNTI) other than existing RNTIs, new DCI format to be defined for PRACH, or DCI format 0_0, 0_1, 0_2, 1_0, 1_1, 1_2 that schedules PDSCH/PUSCH, and its value may follow Table 21 above. For example, if the value of the TPC command field is 0, δ_{PRACH,b,f,c} may have a value of −4 dB.
As described above, in cases where the UE can perform TPC command accumulation operation (i.e., if tpc-Accumulation being higher layer signaling is not set), it is possible to consider various methods for determining the definition of K_{PRACH}(i) applicable to the i^{th} SRS transmission occasion with bandwidth part b, carrier frequency f, and cell c; or, in cases where the UE cannot perform TPC command accumulation operation and can operate with an absolute value (i.e., if tpc-Accumulation being higher layer signaling is set), it is possible to consider various methods for determining the definition of δ_{PRACH,b,f,c}(i) applicable to the i^{th} PRACH transmission occasion with bandwidth part b, carrier frequency f, and cell c.

### [Condition 4-1]

When the UE receives an SSB from the base station and performs PRACH transmission in response, or when the UE receives a PDCCH order from the base station and performs PRACH transmission in response
If the UE has not received a configuration for repetitive PRACH transmission through higher layer signaling, the UE may perform transmission for a single PRACH transmission occasion.
If the UE has received a configuration for repetitive PRACH transmission through higher layer signaling, the UE may perform transmission for multiple repetitive PRACH transmission occasions, where the number of repetitive transmissions may be set through higher layer signaling.

### [Condition 4-1-1]

In addition to above-mentioned condition 4-1, if the UE is capable of performing TPC command accumulation operation (i.e., if tpc-Accumulation being higher layer signaling is not set)

[Method 4-1-1-1] K_{PRACH}(i) applicable to the i^{th} PRACH transmission occasion may refer to a symbol length from the end point of the last symbol at which the SSB or PDCCH having triggered the i^{th} PRACH transmission occasion is received to the start point of the i^{th} PRACH transmission occasion.
If the UE receives triggering for i, i+1, . . . , i+N−1^{th} PRACH transmission occasions through reception of a corresponding SSB or PDCCH, the end point of the last symbol of the SSB or PDCCH, which determines K_{PRACH}(i), K_{PRACH}(i+1), . . . , K_{PRACH}(i+N−1) applicable respectively to i, i+1, . . . , i+N−1^{th} PRACH transmission occasions, may always be the same. Hence, since the end points for determining Rᵢ according to the above are all the same, TPC command accumulation values applied to individual PRACH transmission occasions triggered by the corresponding SSB or PDCCH may all be the same. In this case, there is an advantage of simplifying the operation of the UE without a complication by applying a power control value that can be determined at the time of SSB or PDCCH based triggering to all PRACH transmission occasions. However, it can be said to be an inflexible method in that dynamic power control through L1 signaling (e.g., DCI format 2_3 or new format) is not possible for PRACH transmission occasions transmitted relatively later in time.

[Method 4-1-1-2] K_{PRACH}(i) applicable to the i^{th} PRACH transmission occasion may refer to a symbol length from the end point of the last symbol at which the SSB or PDCCH having triggered the i^{th} PRACH transmission occasion is received to the start point of a PRACH transmission occasion transmitted first in time among all PRACH transmission occasions triggered by the corresponding SSB or PDCCH.
When the UE receives triggering for one PRACH transmission occasion through reception of a corresponding SSB or PDCCH, method 4-1-1-2 may derive the same K_{PRACH}(i) value as method 4-1-1-1.
When the UE receives triggering for i, i+1, . . . , i+N−1^{th} PRACH transmission occasions through reception of a corresponding SSB or PDCCH, K_{PRACH}(i), K_{PRACH}(i+1), . . . , K_{PRACH}(i+N−1) applicable respectively to i, i+1, . . . , i+N−1^{th} PRACH transmission occasions may have the same value as K_{PRACH}(i) that is applicable to the i^{th} PRACH transmission occasion transmitted first in time among all PRACH transmission occasions triggered by the corresponding SSB or PDCCH. Hence, since the end points for determining Rᵢ are different according to the above, the value for TPC command accumulation applied to all PRACH transmission occasions triggered by the corresponding SSB or PDCCH may vary for individual PRACH transmission occasions. In this case, in addition to the power control value that can be determined at the time of SSB or PDCCH triggering, dynamic power control through L1 signaling (e.g., DCI format 2_3 or new format) is also possible for PRACH transmission occasions transmitted relatively later in time. Therefore, although UE operation may become relatively complicated, it can be said to be a flexible method from a power control perspective.

[Method 4-1-1-3] K_{PRACH}(i) applicable to the i^{th} PRACH transmission occasion may refer to a symbol length set through higher layer signaling.
Method 4-1-1-3 may also be applied to PRACH transmission corresponding to candidateBeamRSList, which is higher layer signaling, in beam failure recovery operation in the PCell or PSCell.
When the UE receives triggering for one PRACH transmission occasion through reception of a corresponding SSB or PDCCH, the UE may be configured with one symbol length through higher layer signaling.
When the UE receives triggering for i, i+1, . . . , i+N−1^{th} PRACH transmission occasions through reception of a corresponding SSB or PDCCH, K_{PRACH}(i), K_{PRACH}(i+1), . . . , K_{PRACH}(i+N−1) applicable respectively to i, i+1, . . . , i+N−1^{th} PRACH transmission occasions may all have the same value based on one higher layer signaling value, or may have separate values based on N different higher layer signalings. Hence, since the end points for determining Rᵢ are different according to the above, the value for TPC command accumulation applied to all PRACH transmission occasions triggered by the corresponding SSB or PDCCH may vary for individual PRACH transmission occasions. Additionally, if method 4-1-1-2 is used, since the symbol interval from a specific SSB or PDCCH to the first triggered PRACH transmission occasion may be not always the same as the symbol interval from another SSB or PDCCH to the first triggered PRACH transmission occasion, K_{PRACH}(i) to be considered from a specific PRACH transmission occasion may vary depending on different SSB or PDCCH triggering. On the other hand, if the corresponding value is set through higher layer signaling as in method 4-1-1-3, there may be an advantage in that the UE operation can be controlled relatively simply and consistently.
Cases where there is one higher layer signaling described above
   For example, the corresponding signaling may have a value in units of symbols as independent higher layer signaling for TPC command accumulation, and this may be defined to be K_{PRACH,min}.
   As another example, the corresponding signaling may be the number of symbols obtained by multiplying the smallest value of triggering slot offset k2 or k2-16, which is higher layer signaling set in every TDRA entry, by 14, and this may be defined to be K_{PRACH,min}.
   As another example, the corresponding signaling may be the number of symbols obtained by multiplying the smallest value of all SRS triggering slot offset values set in SRS resource sets by 14, and this may be defined to be K_{PRACH,min}.
   As another example, the corresponding signaling may be the number of symbols obtained by multiplying the smallest value of triggering slot offset k2 set in PUSCH-ConfigCommon, which is higher layer signaling, by 14, and this may be defined to be K_{PRACH,min}.
Cases where there are multiple higher layer signalings described above
   For example, the corresponding signaling may be plural independent higher layer signalings for TPC command accumulation having a value in units of symbols, and if the number of repetitive transmissions is N, these may be defined respectively as K_{PRACH,min,1}, . . . , K_{PRACH,min,N}.
   As another example, the corresponding signaling may be the number of symbols obtained by considering k2's or k2-16's as many as the number of PRACH transmission occasions triggered by the corresponding SSB or PDCCH from the smallest value among all triggering slot offsets k2 or k2-16, which are higher layer signaling set in all TDRA entries, and multiplying this by 14, and if the number of repetitive transmissions is N, these may be defined respectively as K_{PRACH,min,1}, K_{PRACH,min,N}.
   As another example, the corresponding signaling may be the number of symbols obtained by considering slot offsets as many as the number of PRACH transmission occasions triggered by the corresponding SSB or PDCCH from the smallest value among all SRS triggering slot offsets set in SRS resource sets, and multiplying this by 14, and if the number of repetitive transmissions is N, these may be defined respectively as K_{PRACH,min,1}, . . . , K_{PRACH,min,N}.
   As another example, the corresponding signaling may be the number of symbols obtained by considering k2's as many as the number of PRACH transmission occasions triggered by the corresponding SSB or PDCCH from the smallest value among all triggering slot offsets k2 set in PUSCH-ConfigCommon, which is higher layer signaling, and multiplying this by 14, and if the number of repetitive transmissions is N, these may be defined respectively as K_{PRACH,min,1}, . . . , K_{PRACH,min,N}.

[Method 4-1-1-4] K_{PRACH}(i) applicable to the i^{th} PRACH transmission occasion may, if the i^{th} PRACH transmission occasion is the first PRACH transmission occasion triggered by an SSB or PDCCH, refer to a symbol length from the end point of the last symbol at which the SSB or PDCCH is received to the start point of the i^{th} PRACH transmission occasion, and may, if the i^{th} PRACH transmission occasion is not the first PRACH transmission occasion triggered by the SSB or PDCCH, refer to a symbol length from the end point of the last symbol at which the i−1^{th} PRACH transmission occasion is transmitted to the start point of the i^{th} PRACH transmission occasion.
When the UE receives triggering for one PRACH transmission occasion through reception of a corresponding SSB or PDCCH, method 4-1-1-4 may derive the same K_{PRACH}(i) value as method 4-1-1-1.
When the UE receives triggering for i, i+1, . . . , i+N−1^{th} PRACH transmission occasions through reception of a corresponding SSB or PDCCH, K_{PRACH}(i) applicable to the i^{th} PRACH transmission occasion may be calculated by using time points of the SSB or PDCCH having triggered it and the i^{th} PRACH transmission occasion, and when determining K_{PRACH}(i+1), . . . , K_{PRACH}(i+N −1) applicable to i+1, . . . , i+N−1^{th} PRACH transmission occasions, each of i, . . . , i+N−2^{th} PRACH transmission occasions may be treated similarly to the SSB or PDCCH used previously to calculate K_{PRACH}(i) for the i^{th} PRACH transmission occasion.

[Method 4-1-1-5] K_{PRACH}(i) applicable to the i^{th} PRACH transmission occasion may, if the i^{th} PRACH transmission occasion is the first PRACH transmission occasion triggered by an SSB or PDCCH, refer to a symbol length from the end point of the last symbol at which the SSB or PDCCH is received to the start point of the i^{th} PRACH transmission occasion, and may, if the i^{th} PRACH transmission occasion is not the first PRACH transmission occasion triggered by the SSB or PDCCH, refer to a symbol length from the end point of the nearest downlink symbol present before the i^{th} PRACH transmission occasion to the start point of the i^{th} transmission occasion.
When the UE receives triggering for one PRACH transmission occasion through reception of a corresponding SSB or PDCCH, method 4-1-1-5 may derive the same K_{PRACH}(i) value as method 4-1-1-1.

[Method 4-1-1-6] The UE may define K_{PRACH}(i) applicable to the i^{th} PRACH transmission occasion through a combination of methods 4-1-1-1 to 4-1-1-5 described above. For instance, when the UE receives triggering for N repetitive i, i+1, i+N−1^{th} PRACH transmission occasions through an SSB or PDCCH, it may utilize method 4-1-1-1 to define K_{PRACH}(i) for the i^{th} PRACH transmission occasion being the first one among them and utilize method 4-1-1-2 as to K_{PRACH}(U+1) K_{PRACH}(i+N−1) for remaining i+1, ⋅ ⋅ ⋅, i+N−1^{th} PRACH transmission occasions.

[Method 4-1-1-7] The UE may configure one of above-described methods 4-1-1-1 to 4-1-1-6 through higher layer signaling from the base station as a method for defining K_{PRACH}(i). For example, the UE may receive a setting called tpcAccumulationTimeDetermination, which is higher layer signaling, from the base station, and the corresponding higher layer signaling may be set to one of scheme1 to scheme6, where scheme1 to scheme6 may refer respectively to methods 4-1-1-1 to 4-1-1-6 described above.

[Method 4-1-1-8] The UE may receive higher layer signaling indicating whether to use a method for defining K_{PRACH}(i) (e.g., enableTPCAccumulationTimeDetermination) from the base station. Then, if the corresponding higher layer signaling is not set, this may indicate defining K_{PRACH}(i) by using one of methods 4-1-1-1 to 4-1-1-6 described above (e.g., method 4-1-1-1); if the corresponding higher layer signaling is set (e.g., if the UE receives a setting value of ‘on’), this may indicate that a specific method for defining K_{PRACH}(i) can be used. Here, the specific method for defining K_{PRACH}(i) may be one of methods 4-1-1-1 to 4-1-1-6 described above (e.g., method 4-1-1-6) excluding the method used when the corresponding higher layer signaling is not set.

### [Condition 4-1-2]

In addition to condition 4-1 described above, when the UE cannot perform TPC command accumulation operation and operates through an absolute value (i.e., when tpc-Accumulation being higher layer signaling is set)

[Method 4-1-2-1] δ_{PRACH,b,f,c}(i) may be a TPC command field value included in the PDCCH that has triggered the i^{th} PRACH transmission occasion corresponding to closed-loop index l with bandwidth part b, carrier frequency f, and cell c.
In this method, when the UE receives triggering for one PRACH transmission occasion through reception of one corresponding PDCCH, or when the UE receives triggering for plural PRACH transmission occasions through reception of one corresponding PDCCH, the same absolute TPC command value can be applied to all PRACH transmission occasions.
In this method, when the UE receives triggering for plural PRACH transmission occasions through reception of one corresponding PDCCH, since δ_{PRACH,b,f,c}(i) follows only a TPC command field value included in the triggering PDCCH, the value of a TPC command field included in, for example, DCI format 2_3, for example, between two PRACH transmission occasions may be not applied.

[Method 3-1-2-2] δ_{PRACH,b,f,c}(i) may be the most recently received TPC command value before transmission of the i^{th} PRACH transmission occasion corresponding to closed-loop index l with bandwidth part b, carrier frequency f and cell c.
In this method, when the UE receives triggering for one PRACH transmission occasion through reception of one corresponding PDCCH, when the UE receives triggering for multiple PRACH transmission occasions through reception of one corresponding PDCCH, or when for every PRACH transmission occasion, there is no DCI format 2_3 transmitted more recently than the triggering PDCCH for example, the absolute TPC command value included in the triggering PDCCH may be applied equally to all PRACH transmission occasions.
In this method, when the UE receives triggering for multiple PRACH transmission occasions through reception of one corresponding PDCCH, if DCI format 2_3 is received between transmissions of i^{t}h and i+1^{th} PRACH transmission occasions, and the most recently received TPC command value from the i^{th} PRACH transmission occasion is the value indicated by the TPC command field included in the triggering PDCCH, the absolute TPC command value applied to the i^{th} PRACH transmission occasion may follow the value indicated by the triggering PDCCH, and for the i+1^{th} PRACH transmission occasion, it may follow the absolute TPC command value included in DCI format 2_3 for example.

[Method 4-1-2-3] δ_{PRACH,b,f,c}(i) may be the most recently received TPC command value from a time point preceding K_{PRACH}(i) symbols before transmission of the i^{th} PRACH transmission occasion corresponding to closed-loop index/with bandwidth part b, carrier frequency f, and cell c.
To define K_{PRACH}(i), one of methods 4-1-1-1 to 4-1-1-8 described above can be applied.

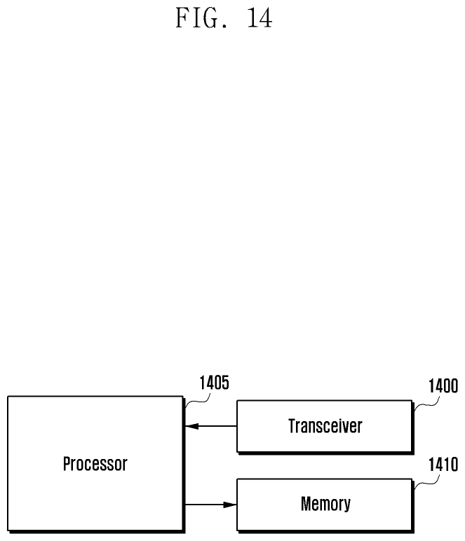

FIG. 14 is a block diagram showing the internal structure of a UE according to an embodiment of the disclosure.

Referring to FIG. A, the UE may include a transceiver 1401, a memory 1402, and a processor 1403. However, the components of the UE are not limited to those described above. For example, the UE may include more or fewer components than the above-described components. Further, at least some or all of the transceiver 1401, the memory 1402, and the processor 1403 may be implemented in the form of a single chip.

In an embodiment, the transceiver 1401 may transmit and receive signals to and from a base station. The signals may include control information, and data. To this end, the transceiver A01 may be composed of an RF transmitter that up-converts the frequency of a signal to be transmitted and amplifies the signal, and an RF receiver that low-noise amplifies a received signal and down-converts the frequency thereof. Additionally, the transceiver 1401 may receive a signal through a radio channel and output it to the processor 1403, and transmit a signal output from the processor 1403 through a radio channel.

In an embodiment, the memory 1402 may store programs and data necessary for the operation of the UE. Additionally, the memory 1402 may store control information or data included in signals transmitted and received by the UE. The memory 1402 may be composed of a storage medium such as ROM, RAM, hard disk, CD-ROM, and DVD, or a combination of storage media. Additionally, the memory 1402 may be composed of a plurality of memories. According to an embodiment, the memory 1402 may store a program for executing a power saving operation of the UE.

In an embodiment, the processor 1403 may control a series of processes so that the UE can operate according to the above-described embodiments of the disclosure. In an embodiment, the processor 1403 may execute programs stored in the memory 1402 to thereby receive information such as CA configuration, bandwidth part configuration, SRS configuration, and PDCCH configuration from the base station, and control idle cell mode operations based on the configuration information.

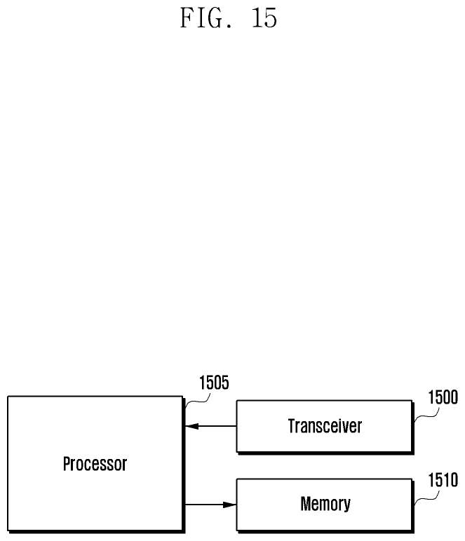

FIG. 15 is a block diagram showing the structure of a base station according to an embodiment of the disclosure.

With reference to FIG. 15, the base station may include a transceiver 1501, a memory 1502, and a processor 1503. However, the components of the base station are not limited to those described above. For example, the UE may include more or fewer components than the above-described components. Further, at least some or all of the transceiver 1501, the memory 1502, and the processor 1503 may be implemented in the form of a single chip.

In an embodiment, the transceiver 1501 may transmit and receive signals to and from a UE. The signals may include control information, and data. To this end, the transceiver 1501 may be composed of an RF transmitter that up-converts the frequency of a signal to be transmitted and amplifies the signal, and an RF receiver that low-noise amplifies a received signal and down-converts the frequency thereof. Additionally, the transceiver 1501 may receive a signal through a radio channel and output it to the processor 1503, and transmit a signal output from the processor 1503 through a radio channel.

In an embodiment, the memory 1502 may store programs and data necessary for the operation of the UE. Additionally, the memory 1502 may store control information or data included in signals transmitted and received by the UE. The memory 1502 may be composed of a storage medium such as ROM, RAM, hard disk, CD-ROM, and DVD, or a combination of storage media. Additionally, the memory 1502 may be composed of a plurality of memories. According to an embodiment, the memory 1502 may store a program for executing a power saving operation of the UE.

In an embodiment, the processor 1503 may control a series of processes so that which the base station can operate according to the above-described embodiments of the disclosure. In an embodiment, the processor 1503 may execute programs stored in the memory 1502 to thereby transmit information such as CA configuration, bandwidth part configuration, SRS configuration, and PDCCH configuration to the UE, and control idle cell mode operations of the UE based on the configuration information.

The methods according to the embodiments described in the claims or specification of the disclosure may be implemented in the form of hardware, software, or a combination thereof.

When implemented in software, a computer-readable storage medium storing one or more programs (software modules) may be provided. The one or more programs stored in the computer-readable storage medium may be configured to be executable by one or more processors of an electronic device. The one or more programs may include instructions that cause the electronic device to execute the methods according to the embodiments described in the claims or specification of the disclosure.

Such a program (software module, software) may be stored in a random access memory, a nonvolatile memory such as a flash memory, a read only memory (ROM), an electrically erasable programmable read only memory (EEPROM), a magnetic disc storage device, a compact disc ROM (CD-ROM), a digital versatile disc (DVD), other types of optical storage devices, or a magnetic cassette. Or, such a program may be stored in a memory composed of a combination of some or all of them. In addition, a plurality of component memories may be included.

In addition, such a program may be stored in an attachable storage device that can be accessed through a communication network such as the Internet, an intranet, a local area network (LAN), a wide LAN (WLAN), or a storage area network (SAN), or through a communication network composed of a combination thereof. Such a storage device may access the device that carries out an embodiment of the disclosure through an external port. In addition, a separate storage device on a communication network may access the device that carries out an embodiment of the disclosure.

In the embodiments of the disclosure described above, the elements included in the disclosure are expressed in a singular or plural form according to the presented specific embodiment. However, the singular or plural expression is appropriately selected for ease of description according to the presented situation, and the disclosure is not limited by a single element or plural elements. Those elements described in a plural form may be configured as a single element, and those elements described in a singular form may be configured as plural elements.

Meanwhile, the embodiments of the disclosure disclosed in the present specification and drawings are only provided as specific examples to easily explain the technical details of the disclosure and to aid understanding of the disclosure, and are not intended to limit the scope of the disclosure. That is, it will be apparent to those of ordinary skill in the art that other modifications based on the technical idea of the disclosure can be carried out. In addition, the individual embodiments may be combined with each other if necessary for operation. For example, some of the different embodiments of the disclosure may be combined with each other and applied to a base station and a terminal. Further, the embodiments of the disclosure can be applied to other communication systems, and other modifications based on the technical idea of the embodiments may also be carried out. For example, the embodiments can also be applied to LTE systems, or 5G or NR systems.

What is claimed is:

1. A method of a terminal in a wireless communication system, the method comprising:
receiving scheduling information for repetitive transmission of a physical uplink shared channel (PUSCH) through a first signal from a base station;
setting a time period in which a signal for controlling transmit power control (TPC) can be received and applied for each of at least one PUSCH scheduled by the first signal; and
performing power control for PUSCH transmission corresponding to the set time period based on a second signal received within the set time period from the base station.

2. The method of claim 1,
wherein setting a time period comprises setting a start point and an end point of the time period for a first PUSCH,
wherein the end point is determined to be a point that precedes in time a first number of symbols from a start symbol of the first PUSCH transmission, and
wherein the start point is determined to be a point that precedes in time a second number of symbols from a start symbol of a second PUSCH transmission scheduled ahead of the first PUSCH.

3. The method of claim 2,
wherein the second number of symbols is determined based on a number of symbols ranging from a start symbol of a PUSCH earliest in time among at least one PUSCH set to be repeatedly transmitted together with the second PUSCH to a last symbol at which a signal including scheduling information for repetitive PUSCH transmission related to the second PUSCH is received, and
wherein the second PUSCH is determined to be a PUSCH closest in time to the first PUSCH among plural PUSCHs preceding in time the first PUSCH.

4. The method of claim 2, wherein the first number of symbols is determined based on a number of symbols present between a start symbol of a PUSCH earliest in time among at least one PUSCH set to be repeatedly transmitted together with the first PUSCH and a last symbol at which a signal including scheduling information for repetitive PUSCH transmission related to the first PUSCH is received.

5. The method of claim 2, wherein the first number of symbols is set through higher layer signaling.

6. The method of claim 2,
wherein, in case that the first PUSCH is a PUSCH earliest in time among at least one PUSCH set to be repeatedly transmitted together with the first PUSCH, the first number of symbols is determined based on a number of symbols present between a start symbol of the first PUSCH transmission and a last symbol at which a signal including scheduling information for repetitive PUSCH transmission related to the first PUSCH is received,
wherein, in case that the first PUSCH is not a PUSCH earliest in time among at least one PUSCH set to be repeatedly transmitted together with the first PUSCH, the first number of symbols is determined based on a number of symbols present between a start symbol of the first PUSCH transmission and a last symbol of the second PUSCH transmission, and
wherein the second PUSCH is determined to be a PUSCH closest in time to the first PUSCH among plural PUSCHs preceding in time the first PUSCH.

7. The method of claim 2,
wherein, in case that the first PUSCH is a PUSCH earliest in time among at least one PUSCH set to be repeatedly transmitted together with the first PUSCH, the first number of symbols is determined based on a number of symbols present between a start symbol of the first PUSCH transmission and a last symbol at which a signal including scheduling information for repetitive PUSCH transmission related to the first PUSCH is received; and
wherein, in case that the first PUSCH is not a PUSCH earliest in time among at least one PUSCH set to be repeatedly transmitted together with the first PUSCH, the first number of symbols is determined based on a number of symbols present between a start symbol of the first PUSCH transmission and a downlink or flexible symbol preceding and closest in time to the first PUSCH.

8. The method of claim 1, further comprising receiving an indication for prohibiting TPC accumulation operation from the base station through higher layer signaling, wherein the power control is performed with an absolute TPC scheme.

9. A terminal in a wireless communication system, the terminal comprising:
a transceiver; and
a controller operating in combination with the transceiver,
wherein the controller is configured to:
receive scheduling information for repetitive transmission of a physical uplink shared channel (PUSCH) through a first signal from a base station,
set a time period in which a signal for controlling transmit power control (TPC) can be received and applied for each of at least one PUSCH scheduled by the first signal, and
perform power control for PUSCH transmission corresponding to the set time period based on a second signal received within the set time period from the base station.

10. The terminal of claim 9,
wherein, for setting the time period, the controller is configured to set a start point and an end point of the time period for a first PUSCH,
wherein the end point is determined to be a point that precedes in time a first number of symbols from a start symbol of the first PUSCH transmission, and
wherein the start point is determined to be a point that precedes in time a second number of symbols from a start symbol of a second PUSCH transmission scheduled ahead of the first PUSCH.

11. The terminal of claim 10,
wherein the second number of symbols is determined based on a number of symbols ranging from a start symbol of a PUSCH earliest in time among at least one PUSCH set to be repeatedly transmitted together with the second PUSCH to a last symbol at which a signal including scheduling information for repetitive PUSCH transmission related to the second PUSCH is received, and
wherein the second PUSCH is determined to be a PUSCH closest in time to the first PUSCH among plural PUSCHs preceding in time the first PUSCH.

12. The terminal of claim 10, wherein the first number of symbols is determined based on a number of symbols present between a start symbol of a PUSCH earliest in time among at least one PUSCH set to be repeatedly transmitted together with the first PUSCH and a last symbol at which a signal including scheduling information for repetitive PUSCH transmission related to the first PUSCH is received.

13. The terminal of claim 10, wherein the first number of symbols is set through higher layer signaling.

14. The terminal of claim 10,
wherein, in case that the first PUSCH is a PUSCH earliest in time among at least one PUSCH set to be repeatedly transmitted together with the first PUSCH, the first number of symbols is determined based on a number of symbols present between a start symbol of the first PUSCH transmission and a last symbol at which a signal including scheduling information for repetitive PUSCH transmission related to the first PUSCH is received,
wherein, in case that the first PUSCH is not a PUSCH earliest in time among at least one PUSCH set to be repeatedly transmitted together with the first PUSCH, the first number of symbols is determined based on a number of symbols present between a start symbol of the first PUSCH transmission and a last symbol of the second PUSCH transmission, and
wherein the second PUSCH is determined to be a PUSCH closest in time to the first PUSCH among plural PUSCHs preceding in time the first PUSCH.

15. The terminal of claim 10,
wherein the controller is configured to receive an indication for prohibiting TPC accumulation operation from the base station through higher layer signaling, and
wherein the power control is performed with an absolute TPC scheme.
